(19) United States
(12) Patent Application Publication
(10) Pub. No.: US 2026/0249498 A1
(43) Pub. Date: Aug. 27, 2026

(54) PERSONAL CARE DEVICES AND COSMETIC COMPOSITIONS

(71) Applicant: Pathak Holdings LLC, Phoenix, AZ (US)

(72) Inventors: Chandrashekhar P. Pathak, Phoenix, AZ (US); Milind Madhukar Thigle, Kalyan West (IN); Akshay Santosh Achalkar, Thakurli East (IN)

(21) Appl. No.: 18/993,955

(22) PCT Filed: Jul. 14, 2023
(86) PCT No.: PCT/US2023/027795

§ 371 Date: Jan. 13, 2025

Related U.S. Application Data
(60) Provisional application No. 63/389,332, filed on Jul. 14, 2022.
(60) Provisional application No. 63/439,209, filed on Jan. 16, 2023.

(51) Int. Cl. B26B 21/44; B26B 21/06; B26B 21/22; B26B 21/52

(52) U.S. Cl. CPC B26B 21/446; B26B 21/222; B26B 21/522; B26B 21/06

(57) ABSTRACT

Novel disposable wet shaving razor designs with two or more cartridges with 3 or more blades are disclosed wherein the two cartridges are parallel to each other, are not connected with each other and distance between the cartridges is 0.1 mm to 5 cm. Also disclosed are wet shaving razor designs wherein the razor has two or more cartridges and ability to dispense cosmetic compositions stored in the razor handle. The invention also discloses cosmetic compositions based on organogels.

### CROSS-REFERENCE TO RELATED APPLICATIONS

This application claims priority to U.S. Patent Application No. 63/439,209 filed on Jan. 16, 2023 and U.S. Patent Application No. 63/389,332 filed on Jul. 14, 2022, which provisional applications are incorporated herein by specific reference in their entirety.

### FIELD OF THE INVENTION

The present invention generally relates to personal care devices.

### BACKGROUND OF THE INVENTION

Shaving razors with removable and non-removable cartridges have been commercialized in the US for several years. Razor cartridges with 2 to 7 blades are available in the US and other markets. In a normal wet shaving process, a shaving cream/gel/foam is applied which is leathered on the facial surface. A shaving razor is then used to remove the shaving gel/foam and facial hair. During this operation, the razor is typically washed with running water, in many cases multiple times to remove the foam/hair debris attached to the razor blade/cartridge. The washing process is necessary to expose fresh cutting blade surface which helps better shaving experience. Millions of people shave every day. Reduced usage of water during shaving may result in substantial saving of valuable water resources. Improvements in the shaving methods, razor designs and shaving gel compositions that require no washing or minimum washing are highly desired.

During the shaving process using multiple blades, it is observed that the first cutting blade from the bottom contacts the hair first and performs the most cutting function. The second and third and other blades do minor cutting operations. Since first cutting blades provide maximum cutting function, it gets blunt at a rapid rate than the other blades in the cartridges. If blunt blade usage is continued, it may irritate the facial skin which makes the shaving experience unpleasant. This usually results in discarding the entire cartridge even though other blades in the cartridge may be relatively sharp and useful.

In the current shaving cartridge design, the facial hair is cut by a single cutting edge of the blade.

It is observed that shaving cartridges use around 35 mm blades in 2-6 blade cartridges. The total cutting length is limited to 35 multiplied by 2 to 6 which is 70 to 210 mm. Current shaving cartridges do not increase the cutting length of the cartridge without significantly affecting the cartridge dimensions.

Microfluidic devices are increasingly being used in medicine, chemistry and chemical engineering. Microfluidic devices have several microchannels etched or molded into the materials that enable control over the number of fluids and the direction of fluids flowing through the channels.

3D manufacturing methods such as stereolithography are changing the manufacturing landscape in different industries. It will be a valuable contribution to the art if compositions and methods that use 3D printing (stereolithography, metal powder fusion-based methods and the like) to make complex-shaped personal care devices.

Shaving cream/gel and after shaving lotion are the two most common fluids used during and after wet shaving. Current technologies do not provide a hair cutting device, preferably a wet shaving razor with two or more chambers razor for storing and dispensing two or more hair removal assistant compositions such as shaving cream and aftershave lotion especially during traveling.

Water is the most common and abundant ingredient in many shaving gel/cream/lotion compositions. After applying shaving gel, water in the shaving gel has a high tendency to evaporate due to the small thickness of the shaving foam layer, high surface area and relatively low boiling point of water. If water is partially or substantially evaporated during wet shaving, it may reduce the lubrication efficiency of the foam/gel. In such circumstances, the gel or foam is generally rehydrated and used.

Hydrogel microparticles/microspheres have a long history of use in medicine, cosmetics and other applications. However recent advances in hydrogel microspheres may be used to make new and improved cosmetic compositions.

Organic Solvent gels (OSG) or organogels are known in the art and have various applications in medicine, chemical reactions and other industrial applications. The use of OSG has been explored for drug delivery and other applications. Drug delivery applications of organogels have been reviewed by A. Vintiloiu et. al. (Journal of Controlled Release Volume 125 Page 179, 2008), cited herein for reference only. New cosmetic compositions comprising organogels have been disclosed.

The present invention addresses the foregoing need for better personal care devices and cosmetic compositions. Accordingly, there is a need for such compositions, methods and devices as summarized herein in some detail.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a multi-cartridge wet shaving razor comprising: a) a handle and at least two cartridges attached to the handle wherein each cartridge has one to seven cutting blades. Further, at least two cartridges may be interconnected. Further, in an embodiment, the at least two cartridges may not be interconnected. Further, the at least two cartridges may be removable and not-removable. Further, the at least two cartridges may conform to the contours of the skin. Further, the at least three or more cartridges may be arranged in a manner such that they will not obstruct or interfere with wet shaving operation. Further, the at least three or more cartridges may be arranged in a triangular, rectangular, pentagonal or hexagonal shape. Further, the space between two or more cartridges may have the ability to store and/or dispense cosmetic compositions or extra cartridges. Further, one of the cartridges may have the ability to fold to form a compact configuration of razor and/or to reduce non-interference/obstruction during shaving operation.

Disclosed also herein two cartridges wet shaving razor with a razor handle and two shaving cartridges at either end of the handle comprising: a) two shaving cartridges comprising at least two cutting blades; b) the two cartridges are arranged substantially parallel to each other and to the longer axis of the razor handle; c) distance between the two cartridges is greater than 10 mm; d) the angle between cartridges blade plane surface and the longer axis of the razor handle is greater than 20 degrees; e) the combined length of first cutting blades in two cartridges is greater than 60 mm. Further, the two cartridges may be interconnected or may not be interconnected. Further, two cartridges may be removable and not-removable. Further, the two cartridges may conform to the contours of the skin. Further, each cartridge has a lubricant strip. Further, the two cartridges may conform to the contours of the skin. Further, the space located at one end of the handle and between cartridges has ability to store and/or dispense cosmetic compositions or extra/spare cartridges. Further, one of the cartridges may have the ability to fold to form a compact configuration of razor and/or to reduce non-interference/obstruction during shaving operation. Further, the handle of the razor is hollow with volume greater than 1.1 milliliters. Further, the handle of the razor has two or more independent compartments capable of storing cosmetic compositions. Further, the razor handle may have the ability to store and/or dispense cosmetic compositions or extra cartridges. Further, the razor handle has at least one dispensing and/or storage port for cosmetic compositions and the dispensing port is fluidically connected to the storage compartment.

Further, the handle has the ability to dispense cosmetic compositions upon hand squeezing preferably without significant/substantial plastic deformation of the handle.

Further, in some embodiments, disclosed herein is a wet shaving razor comprising a metal blade with one sharp cutting edge and at least 3 microblades arranged in an array format, wherein the distance between microblade is 50 microns to 5 mm.

Further, in some embodiments, at least one of the cartridge surface/body, parts of the cartridge or blade surface may be partially or completely covered with or embedded with microfluidic channels.

Further, in some embodiments, the multi-cartridge wet shaving razor may include a handle and at least two shaving cartridges on the proximal end and a detachable brush attached at the distal end. Further, the multi cartridge wet shaving razor may include at least one independent chamber for storage and dispensing of fluids, liquids or gels and at least one dispensing port that is fluidically connected with the storage chamber.

Further disclosed herein is a cosmetic composition comprising 1 to 99 percent (relative to total weight) crosslinked hydrogel microparticles. The crosslinked hydrogel microparticles preferably are microspheres or microcylinders. The crosslinked hydrogel microparticles are biodegradable or biostable. Further, the microparticles may include polyethylene glycol. The weight percent of polyethylene glycol is 1 percent to 98 percent. Further, the microparticles may be made by the addition polymerization of monomers or macromonomers or by condensation polymerization of precursors. Further, the microparticles may be infused with compounds selected from the group comprising: hydrophilic water soluble polymers; oils, fragrances, dyes, pigments, perfumes, colorants, organic solvent or combination thereof in any proportion.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE SEVERAL VIEWS OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

The above-mentioned and other features and advantages of this present disclosure, and the manner of attaining them, will become more apparent and the present disclosure will be better understood by reference to the following description of embodiments of the present disclosure taken in conjunction with the accompanying drawings, wherein:

FIGS. 1A-1C show a partial schematic representation of 3 blade wet shaving disposable cartridge wherein main parts of the cartridge are identified.

FIGS. 2A-2D show a partial schematic representation of a shaving razor wherein the cartridge of the razor is assembled by the user prior to use.

FIGS. 3A-3D show a partial schematic representation of a wet shaving razor wherein the razor has two or more total cartridges.

FIGS. 4A-4C show a partial schematic representation of a wet shaving razor wherein the razor has two or more cartridges that are connected with each other via a solid body that provides a desirable angle and flexibility during shaving.

FIGS. 5A-5E show a partial schematic representation of a wet shaving razor wherein the razor has at least three cartridges on either end of the razor handle.

FIGS. 6A-6D show a partial schematic representation of a wet shaving razor wherein the razor has one or three shaving cartridges and the capability to store and dispense liquids/gels in the handle.

FIGS. 7A-7D show a partial schematic representation of a wet shaving razor with multiple cartridges and the capability to store and dispense at least two liquids/gels in the handle.

FIGS. 8A-8D is a variation of FIG. 7A. FIG. 8A-8D show a partial schematic representation of a wet shaving razor wherein the razor has multiple shaving cartridges and with the capability to store and dispense two liquids/gels in the handle.

FIGS. 9A-9B show a partial schematic representation of a wet shaving razor wherein the razor has multiple shaving cartridges on one end and a shaving brush at the other end; optionally the razor also has a capacity to hold and dispense liquid stored in the handle.

FIGS. 10A-10E show a partial schematic representation of a wet shaving razor wherein the razor has four shaving cartridges arranged in a rectangular shape.

FIGS. 11A-11E show a partial schematic representation of a wet shaving razor wherein the razor has multiple shaving cartridges and with a shaving aid dispenser in the handle.

FIGS. 12A-12C show a partial schematic representation of a wet shaving razor wherein the razor has two or more shaving cartridges on one end and with the capability to store and dispense liquids/gels in the handle.

FIGS. 13A-13C show a partial schematic representation of a wet shaving razor wherein the blades of the razor comprise an array of mini blades or micro blades.

FIGS. 14A-14G show a partial schematic representation of the shaving razor cutting blade shapes designed to increase the overall cutting length of the shaving blade.

FIGS. 15A-15D show a partial schematic representation of one of the methods for making shaving cartridges using a microblade cutting elements array.

FIG. 16A1, FIG. 16A2 and FIG. 16B show a partial schematic representation of a razor cutting blade with microfluidic channels for fluid/lubricant distribution during/before/after shaving.

FIGS. 17A-17B show a partial schematic representation of a wet shaving razor wherein the razor and blades are assembled by the user prior to use. FIG. 17C shows a method to make razor blade with microblade array.

FIGS. 18A-18Ee show a partial schematic representation of a wet shaving razor with a microblade array assembled just above the cutting edge of the razor blade and a razor head made using such blades.

FIGS. 19A-19E show a partial schematic representation of a wet shaving razor cartridge made using a single block of a metal piece made via mechanical carving, electrochemical deposition, casting/3D printing methods or a combination thereof. It also shows a razor assembled using blades as shown in FIGS. 19A-19C.

FIG. 20 show a partial schematic representation of a process to make porous hydrogel microspheres.

FIGS. 21A-21B show two illustrative multi-cartridge razors wherein at least one cartridge interferes or obstructs with other cartridges while shaving.

FIGS. 22A-22B show one illustrative multi-cartridge razor wherein at least one cartridge may fold or collapse during storage or use.

FIGS. 23A-23B show a partial schematic representation of a wet shaving razor wherein the razor has multiple shaving cartridges and a protective cap for the blades/cartridges. FIG. 23C-23D illustration of cartridge angle with respect to razor handle axis.

FIGS. 24A-24D and FIG. 29B show a partial schematic representation of a wet shaving razor wherein the razor has capability to store one or more shaving cartridges in the handle or space between the cartridges.

FIGS. 25A, FIG. 25A1 and FIG. 25B show a partial schematic representation of a wet shaving razor wherein the razor has capability to store and dispense two or more fluids/liquid compositions stored in the handle and space between the cartridges.

FIG. 26A and FIG. 26A1 show a partial schematic representation of a wet shaving razor wherein the razor has capability to dispense shaving lubricant during wet shaving.

FIG. 27A, FIG. 27B, FIG. 27B1 and FIG. 27B2 show a partial schematic representation of a wet shaving razor wherein the razor has capability to dispense lubricant at the bottom portion of cartridge during wet shaving.

FIGS. 28A-28B shows a wet shaving razor kit wherein a multi-cartridge razor and two or more cartridges are assembled and packaged together as a kit.

FIG. 29A show an illustrative image of organogel based water soluble shaving cream in a Petry dish as described in this invention.

FIG. 29B shows a partial schematic representation of a wet shaving razor

The figures are not necessarily drawn to scale unless specifically indicated.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of such term herein. To the extent that the meaning of a term used herein as understood by the ordinary artisan based on the contextual use of such term differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in the context of personal care devices and cosmetic compositions, embodiments of the present disclosure are not limited to use only in this context.

It is to be understood that the present disclosure is not limited in its application to the details of construction and the arrangement of components outlined in the following description or illustrated in the drawings. The present disclosure is capable of other embodiments and of being practiced or of being carried out in various ways. Also, it is to be understood that the phraseology and terminology used herein is for the purpose of description and should not be regarded as limiting. Exemplary embodiments of the present invention are directed towards compositions, methods and devices for personal care use.

It is advantageous to define several terms, phrases and acronyms before describing the invention in detail. It should be appreciated that the following terms are used throughout this application. Where the definition of terms departs from the commonly used meaning of the term, the applicant intends to utilize the definitions provided below, unless specifically indicated. The following definitions are provided to illustrate the terminology used in the present invention. Unless defined otherwise, all technical and scientific terms used herein have the same meaning as is commonly understood by one who is skilled in the art. All scientific literature and patent citations in this invention are incorporated herein for reference use only.

“Crosslinked material” is meant to denote the formation of intermolecular or intramolecular covalent bonds in the macromolecule or polymer. The crosslinked material may be in a highly hydrated state.

A “crosslinking agent” is defined as a compound capable of forming crosslinked material. For example, glutaraldehyde is generally known in the art as a crosslinking agent for the tissue or with albumin or with collagen. “In situ” is meant to denote a local site, especially within or in contact with living organisms, tissue, skin, organs, or the body.

“Bioactive” refers to one or all of the activities of a compound that show pharmacological or biological activity in the human or animal body. Such biological activity is preferred to have a therapeutic effect.

The terms “Biodegradable” “Compostable” and “Bioabsorbable” have the same meaning as commonly understood in the art. “Biostable” is meant to denote high chemical stability of a compound/polymer in an environment such as a natural environment.

The term “biodegradable polymers” may include polymers or macromolecules which degrade/dissolve safely in the biological environment. The hydrophobic biodegradable polymers include, but are not limited to, polymers, dendrimers, copolymers or oligomers of glycolide, dl-lactide, d-lactide, l-lactide, caprolactone, dioxanone and trimethylene carbonate; degradable polyurethanes; degradable polyurethanes made by block copolymers of degradable polylactone such as polycaprolactone and polycarbonate such as poly(hexamethylene carbonate); polyamides; polyesters; polypeptides; polyhydroxyacids; polylactic acid; polyglycolic acid; polyanhydrides; and polylactones. Biodegradable polymers also include polyhydroxyalkanoates, which are polyesters produced by microorganisms including and not limited to poly(3-hydroxybutyrate), 3-hydroxyvalerate, 4-hydroxybutyrate, 3-hydroxyhexanoate, 3-hydroxyoctanoate.

The term “biostable polymers” include but are not limited to aliphatic and aromatic polyurethanes; polycarbonate polyurethane; polyether polyurethane; silicone polyurethane block copolymers; silicone rubbers; polydimethylsiloxane copolymers; polytetrafluoroethylene and other fluorinated polymers; expanded polytetrafluoroethylene; polyethylene; polyesters, polyethylene terephthalate, polyimides, polypropylene; polyamide; polyamide block copolymers and the like.

The term “hydrogel” as used herein, refers to a semisolid composition constituting a substantial amount of water, and in which polymers, macromolecules or non-polymeric materials or mixtures thereof are dissolved or dispersed. The polymers may be physically or chemically crosslinked or not crosslinked.

“Organogel” or “Organic Solvent Gel (OSG)” refers to a semisolid composition constituting a substantial amount of organic solvent, and in which polymers, macromolecules or non-polymeric materials or mixtures thereof are dissolved or dispersed. The compounds, polymers may be physically or chemically crosslinked or not crosslinked.

Polyethylene glycol (PEG) or polyethylene oxide (PEO) refers to the same polymer, which is made by the polymerization of ethylene oxide. Polypropylene glycol (PPG) or polypropylene oxide (PPO) refers to the same polymer, which is made by the polymerization of propylene oxide. Polymeric nomenclature used in this patent application such as poly (ethylene glycol) or polyethylene glycol or polyethyleneglycol refers to the same polymer unless otherwise stated clearly. This is also true for all other polymers referred in this patent application.

The term “micron” means a length of 1/1000000 of a meter.

The term “macromonomer” or “macromer” refers to oligomeric or polymeric materials capable of undergoing free radical polymerization.

The term “hydrophobic” is defined as a property of materials or polymers or macromolecules having a low degree of water absorption or attraction.

The terms “coloring compositions” include any coloring composition or chemical that is suitable for use in personal care products such as cosmetics. The compounds include but are not limited to: Methylene blue; Eosin Y; Fluorescein sodium; Chromium-cobalt-aluminum oxide; Ferric ammonium citrate; Pyrogallol; Logwood extract; 1,4-Bis[(2-hydroxy-ethyl)amino]-9,10-anthracenedione bis(2-propenoic)ester copolymers(3; 1,4-Bis [(2-methylphenyl)amino]-9,10-anthracenedione; 1,4-Bis[4-(2-methacryloxyethyl) phenylamino]anthraquinone copolymers; Carbazole violet; Chlorophyllin-copper complex, oil soluble; Chromium oxide greens; C.I. Vat Orange 1; 2-[[2,5-Diethoxy-4-[(4-methylphenyl)thiol]phenyl]azo]-1,3,5-benzenetriol; 16,23-Dihydrodinaphtho [2,3-a:2′,3′-i]naphth [2′,3′:6,7]indolo [2,3-c]carbazole-5,10,15,17,22,24-hexone; N,N′-(9,10-Dihydro-9,10-dioxo-1,5-anthracenediyl) bis benzamide; 7,16-Dichloro-6,15-dihydro-5,9,14,18-anthrazinetetrone; 16,17-Dimethoxydinaphtho (1,2,3-cd:3′,2′,1′-Im) perylene-5,10-dione; Poly(hydroxyethyl methacrylate)-dye copolymers: one or more of Reactive Black 5; Reactive Blue 21; Reactive Orange 78; Reactive Yellow 15; Reactive Blue No. 19; Reactive Blue No. 4; C.I. Reactive Red 11; C.I. Reactive Yellow 86; C.I. Reactive Blue 163; C.I. Reactive Red 180; 4-[(2,4-dimethylphenyl)azo]-2,4-dihydro-5-methyl-2-phenyl-3H-pyrazol-3-one; 6-Ethoxy-2-(6-ethoxy-3-oxobenzo[b]thien-2(3H)-ylidene) benzo[b]thiophen-3(2H)-one; Phthalocyanine green; Iron oxides; Titanium dioxide; Vinyl alcohol/methyl methacrylate-dye reaction products; one or more of: (1) C.I. Reactive Black 5; C.I. Reactive Orange 78; C.I. Reactive Blue 21; Mica-based pearlescent pigments; Disodium1-amino-4-[[4-[(2-bromo-1-oxoallyl)amino]-2-sulphonatophenyl]amino]-9,10-dihydro-9,10-dioxoanthracene-2-sulphonate (Reactive Blue 69); D&C Blue No. 9; D&C Green No. 5; [Phthalocyaninato(2-)]copper; FD&C Blue No. 2; D&C Blue No. 6; D&C Green No. 6; D&C Red No. 17; D&C Violet No. 2; D&C Yellow No. 10; and the like.

The term “hydrophilic” is defined as a property of materials or polymers or macromolecules having a strong affinity for water.

The term “exposing” refers to soaking the substrate in a fluid comprising the treatment agent for a period sufficient to treat the substrate. The soaking may be performed by, but is not limited to, incubation, swirling, immersion, mixing, or vortexing.

The term “polymerizable” denotes the characteristic of molecules that have the capacity to form additional covalent bonds resulting in monomer and/or monomers interlinking to oligomer or polymer formation, for example, molecules containing carbon-carbon double bonds of acrylate-type molecules. Such polymerization is characteristically initiated by free-radical formation, for example, resulting from photon absorption of certain dyes and chemical compounds to ultimately produce free radicals.

The term polymerizable is also applicable to compounds, which may undergo condensation polymerization and form a linear or crosslinked polymer.

The term “water soluble” generally refers to the solubility of a compound in water wherein the compound has a solubility of greater than 5 g/100 g, preferably greater than 1 g/100 g in water or aqueous/buffered water solutions.

The term “water insoluble” generally refers to the solubility of a compound in water wherein the compound has a solubility of less than 5 g/100 g, preferably less than 1 g/100 g in water or aqueous/buffered water solutions.

The term “Porosity” is defined as the presence of pores, voids, cavities, grooves, pockets and indentations within a material.

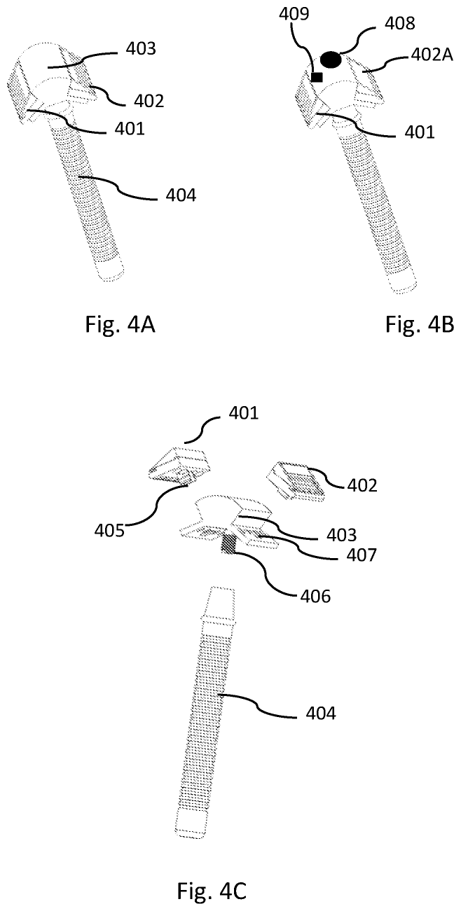

The part 404 in FIG. 4 is generally referred to as the razor handle and the top portion of the razor (part other than 404 in FIG. 4) is referred as the head portion of the razor.

### Overview:

The present disclosure describes personal care devices and cosmetic compositions.

Further, the disclosed personal care device may include a razor. Further, the razor may include a greater number of first blade cutting surfaces. Further, the disclosed razor may also provide other means to increase the total cutting area of the razor blade. Further, the disclosed razor may include several microblades used to make a cartridge. Further, in the disclosed razor, microfluidic channels may be created on the razor blade surface/material or other parts of the razor or cartridges or components of the razor and the channels may be used to distribute shaving aids or washing fluids. Further, the razor (or shaving razor) may include two compartments for storage and dispensing of liquids/gels are disclosed. Further, the shaving razor may include two cartridges that may be used in a single shaving operation and that has the capacity to store and dispense liquids in the handle.

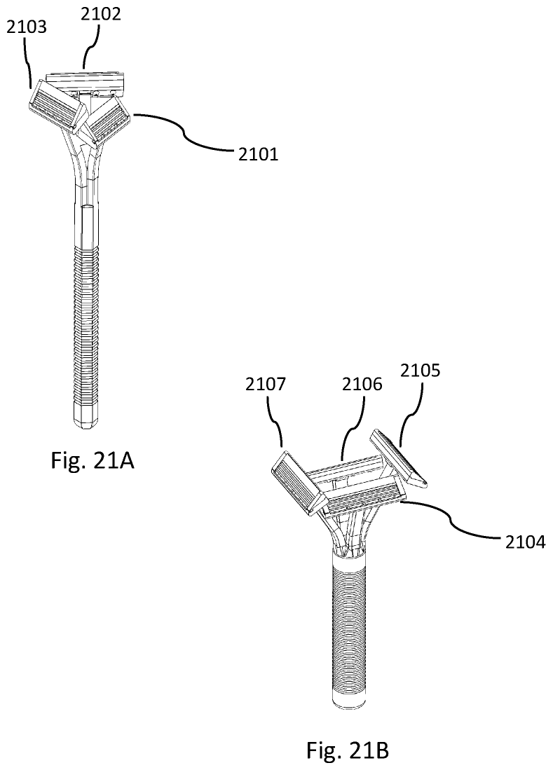

In further embodiments, the disclosed personal care device may include a wet shaving razor comprising an elongated body (handle) and head (with shaving blade). Further, the wet shaving razor may include cutting blades housed in a disposable shaving cartridge. Further, the wet shaving razor may include cartridges placed such that the cartridges do not interfere with each other during wet shaving((FIG. 21). Further, the cartridges have 2-7 cutting blades per cartridge. Further, the cartridges may be separated by a solid body or empty space. Further, a head of the wet shaving razor may be separated and/or replaced as a single part. Further, the cartridges may be removable either as a single cartridge or as a set or two or more cartridges. Further, there may be distance between the cartridges. Further, the size and shape may be further limited. Further, a solid part between the cartridges of the head section may be hollow with volume >0.2 ml. Further, the solid hollow part may be used to store shaving aids or extra cartridges. Further, a fluid aid may be released at the rate of >0.1 ml per hour. The fluid flow is controlled by a valve. Further, the solid part may include at least one port for dispensing and/or filling shaving aids. Further, the handle may be solid or hollow. Further, the handle may have shape, size, and volume limitations. Further, a handle volume associated with the handle may be used to store shaving aids and/or additional cartridges.

Further, the present disclosure describes a shaving gel composition that uses organic solvent-based composition/s. Preferably the organic solvent has a boiling point greater than 100 degree C. Further, the present disclosure describes the use of porous hydrogel microparticles/microspheres, methods of preparation and use to encapsulate cosmetic ingredients.

Further, the present disclosure describes a multi-cartridge wet shaving razor comprising: a) a handle and at least three cartridges attached to the handle wherein each cartridge has one to seven cutting blades.

Further, the present disclosure describes a multi-cartridge wet shaving razor comprising: a) a handle and at least three cartridges attached to the handle wherein the total number of cartridges range from 3 to 8.

Further, the present disclosure describes a multi-cartridge wet shaving razor comprising: a) a handle and at least three cartridges attached to the handle wherein at least two cartridges are either interconnected or not interconnected.

Further, the present disclosure describes a multi-cartridge wet shaving razor comprising: a) a handle and at least three cartridges attached to the handle wherein the cartridges are either removable or not-removable

Further, the present disclosure describes a multi-cartridge wet shaving razor comprising: a) a handle and at least three cartridges attached to the handle wherein the cartridges conform to the contours of the skin.

Further, the present disclosure describes a multi-cartridge wet shaving razor comprising: a) a handle and at least three cartridges attached to the handle wherein the proximal end of the razor has one cartridge at the distal end of the razor has two cartridges and cartridges at both ends are parallel or perpendicular to each other.

Further, the present disclosure describes a multi-cartridge wet shaving razor comprising: a) a handle and at least three cartridges attached to the handle wherein the cartridges are configured on the razor handles such that the cartridges do not interfere or obstruct in contacting facial skin during normal usage.

Further, the present disclosure describes a multi-cartridge wet shaving razor comprising: a) a handle and at least three cartridges attached to the handle wherein the proximal end and distal end has two cartridges. The cartridges on either end are parallel to each other. The cartridges at both ends are parallel or perpendicular to each other.

Further, the present disclosure describes a multi-cartridge wet shaving razor comprising: a) a handle and at least three cartridges attached to the handle wherein each cartridge has the same number of blades. The number of blades in each cartridge may be odd or even or combination thereof.

Further, the present disclosure describes a multi-cartridge wet shaving razor comprising: a) a handle and at least three cartridges attached to the handle wherein at least one cartridge has an odd number of blades.

Further, the present disclosure describes a multi-cartridge wet shaving razor comprising: a) a handle and at least three cartridges attached to the handle wherein at least one cartridge has an even number of blades.

Further, the present disclosure describes a multi-cartridge wet shaving razor comprising: a) a handle and at least three cartridges attached to the handle wherein the proximal end has at least three cartridges and the distal end has no cartridges.

Further, the present disclosure describes a multi-cartridge wet shaving razor comprising: a) a handle and at least three or more cartridges attached to the handle wherein the cartridges are arranged in a triangular, rectangular, pentagonal or hexagonal shape.

Further, the present disclosure describes a multi-cartridge wet shaving razor comprising: a) a handle and at least three cartridges attached to the handle wherein the proximal end has three cartridges and the distal end has 2 or more cartridges.

Further, the present disclosure describes a multi-cartridge wet shaving razor comprising: a) a handle and at least three cartridges attached to the handle wherein the total length of the first cutting blades is greater than 70 mm.

Further, the present disclosure describes a multi-cartridge wet shaving razor comprising: a) a handle and at least three cartridges attached to the handle wherein the total length of the first cutting blades is greater than 80 mm and less than 280 mm.

Further, the present disclosure describes a multi-cartridge wet shaving razor comprising: a) a handle and at least three cartridges attached to the handle wherein the total length of cutting blades is greater than 140 mm.

Further, the present disclosure describes a multi-cartridge wet shaving razor comprising: a) a handle and at least three cartridges attached to the handle wherein the total length of cutting blades is greater than 140 mm and less than 1960 mm.

Further, the present disclosure describes a wet shaving razor comprising a metal blade with one sharp cutting edge and at least 3 microblades arranged in an array format.

Further, the present disclosure describes a wet shaving razor comprising a metal blade with one sharp cutting edge and at least 3 microblades arranged in an array format wherein the distance between microblade is 50 microns to 5 mm.

Further, the present disclosure describes a wet shaving razor comprising a metal blade that may cut facial hair with two cutting edges at the same time.

Further, the present disclosure describes a wet shaving razor comprising a blade whose cutting edge is serrated.

Further, the present disclosure describes a wet shaving razor comprising two or more cartridges and at least one cartridge that has a hinge or joint between the razor handle and cartridge.

Further, the present disclosure describes a wet shaving razor wherein the cartridge or part of the cartridge is made using 3D printed metal parts.

Further, the present disclosure describes a wet shaving razor comprising one or more cutting blades that are produced using photolithography as one of the processes used in blade manufacturing.

Further, the present disclosure describes a wet shaving razor wherein the cartridge surface/body, parts of the cartridge or blade surface are partially or completely covered with or embedded with microfluidic channels.

Further, the present disclosure describes a multi-cartridge wet shaving razor comprising: a) a handle and at least two shaving cartridges on the proximal end and a detachable brush attached at the distal end.

Further, the present disclosure describes a multi-cartridge wet shaving razor comprising: a) a handle and at least two shaving cartridges on the proximal end and a handle that has at least one independent chamber for storage and dispensing of fluids or gels and at least one dispensing port that is fluidically connected with storage chamber.

Further, the present disclosure describes a multi-cartridge wet shaving razor comprising: a) a handle and at least two shaving cartridges on the proximal end and a handle that has at least one independent chamber for storage and dispensing of fluids or gels and at least one dispensing port that is fluidically connected with storage chamber and the viscosity of the fluid stored in the chamber ranges from 2 to 90000 centipoise.

Further, the present disclosure describes a multi-cartridge wet shaving razor comprising: a) a handle and at least two shaving cartridges and the handle has at least two independent chambers for storage and dispensing of fluids or gels and at least two dispensing ports that are fluidically connected to each storage chamber.

Another object of the present invention is to provide a cosmetic composition comprising 1 to 99 percent (relative to total weight) crosslinked hydrogel microparticles. The crosslinked hydrogel microparticles preferably are microspheres or microcylinders. The crosslinked hydrogel microparticles are biodegradable or biostable. The crosslinked microparticles may be hydrogel or organogel.

Another object of the present invention is to provide a cosmetic composition comprising 1 to 99 percent crosslinked hydrogel microparticles wherein the microparticles comprise polyethylene glycol. The weight percent of polyethylene glycol is 1 percent to 98 percent

Another object of the present invention is to provide a cosmetic composition comprising 1 to 99 percent crosslinked hydrogel microparticles wherein the microparticles are made by the addition polymerization of macromonomers or by condensation polymerization of precursors. At least one of the precursors comprises polyethylene glycol.

Another object of the present invention is to provide a cosmetic composition comprising 1 to 99 percent crosslinked hydrogel microparticles wherein the microparticles are infused with compounds selected from the group comprising: hydrophilic water soluble polymers; oils, fragrances, dyes, pigments, perfumes, colorants, organic solvent or combination thereof in any proportion.

Another object of the present invention is to provide a cosmetic composition comprising 1 to 99 percent crosslinked hydrogel microparticles wherein the composition is selected from the group comprising: shaving gel, shaving cream, shaving soap, and aftershave lotion.

Another object of the present invention is to provide a cosmetic composition comprising water soluble organic solvent wherein the weight percentage of organic solvent is greater than 30 percent.

Another object of the present invention is to provide a cosmetic composition comprising 1 to 99 percent organogel wherein the organogel solvent in the organogel has water solubility greater than 1 g/100 g of solvent.

Another object of the present invention is to provide a cosmetic composition comprising 1 to 99 percent organogel wherein the solvent in the organogel has boiling point greater than 60 degree C.

The present invention is now described with reference to the drawings.

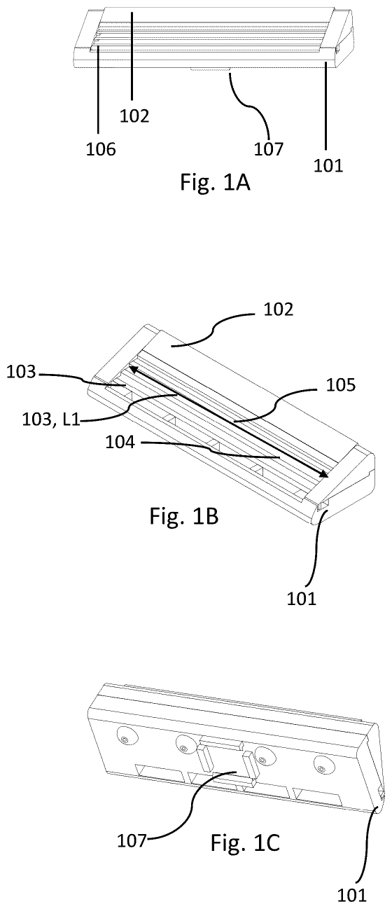

FIG. 1 shows a partial schematic representation of 3 blade wet shaving disposable cartridge wherein main parts of the cartridge are identified. FIG. 1A, FIG. 1B and FIG. 1C show front view, side view and back view respectively 101 shows the cartridge body to which the lubricating strip (102) and three cutting blades (103, 104 and 105) are attached. The blades 103, 104 and 105 have length L1, L2 and L3 respectively and the length of all blades are equal. Blade 103 at the bottom of the cartridge is referred to as the first blade with length L1. 106 shows the gap between blades. 107 shows the attachment site on 101 body wherein a removable razor handle is attached to the cartridge.

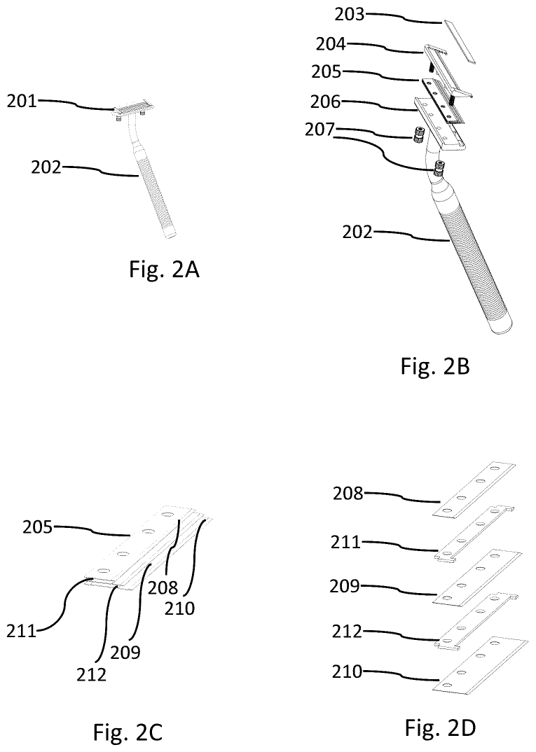

FIG. 2 shows a partial schematic representation of a shaving razor wherein the cartridge of the razor is assembled by the user prior to use. The blades may be removed, cleaned and optionally sharpened, reassembled in a cartridge and reused. FIG. 2A shows razor with a removable cartridge (201) and handle (202). FIG. 2B shows an exploded view of the razor FIG. 2A wherein each component of the razor is identified and labeled. Lubricant strip (203), top blade seat (204), three blade assembly (205), handle/cartridge body (206) and knurled nut (207) are used to assemble cartridges which are then attached to the handle. The blades 208, 209 and 210 and blade seat 211 and 212 are assembled (FIG. 2D) together to make a blade assembly (FIG. 2C, 205).

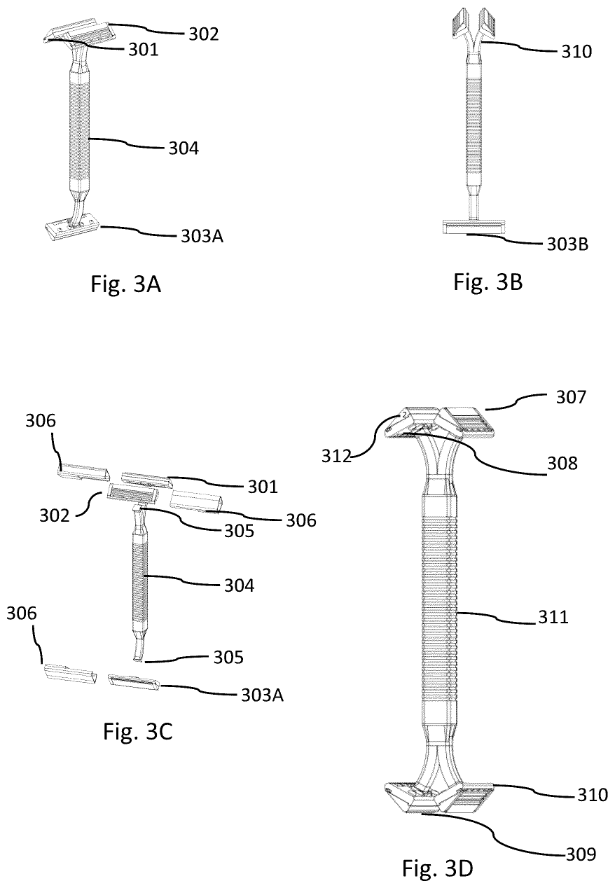

FIG. 3 shows a partial schematic representation of a wet shaving razor wherein the razor has two or more total cartridges. FIG. 3A shows a shaving razor with 3 cartridges (301, 302 and 303) wherein one cartridge (303) is on the distal end and the other two cartridges (301, 302) are on the proximal end of the razor handle (304). The cartridges 301 and 302 have no direct connection/contact except at the base of the handle where they are joined. The alignment of cartridges on the proximal end (301 and 302) is preferably parallel or substantially parallel. The alignment of cartridges between the proximal end (301,302) and the distal end (303A) is preferably parallel or substantially parallel (razor A). The same alignment could also be perpendicular or substantially perpendicular such as shown in FIG. 3B. FIG. 3C shows exploded view of razor A wherein removable cartridges are firmly attached to the razor handle (304) via attachment point (305) and with optional blade/cartridge protecting cover (306). FIG. 3D shows a 4 cartridges razor configuration wherein the cartridges 307 and 308 are attached on the proximal end of the razor handle (311) and are parallel to each other. Cartridges 309 and 310 are attached on the distal end of the razor and are also parallel to each other. Top cartridges (307, 308) and bottom cartridges (309, 310) may be parallel or perpendicular to each other. Cartridge casings are shown as yellow (308), blue (307), red (309) and green (310) respectively and 312 shows printed letter 2 on cartridge 308.

FIG. 4 shows a partial schematic representation of a wet shaving razor wherein the razor has two or more cartridges that are connected via a solid body that provides a desirable angle and flexibility during shaving. FIG. 4A shows a razor with 2 cartridges (401, 402). The cartridges 401 and 402 are connected via curved razor body 403. The razor handle 404 is attached to the razor body via a screw (406). 403 may be solid or hollow with the ability to store and dispense fluids or spare cartridges. 408 shows a refill port and 409 shows a flow control knob. Preferably 401 and 402 are parallel or substantially parallel to each other. FIG. 4B is similar to FIG. 4A except the cartridges 401 and 402A attached to the razor body 403 have a different number of blades (3 blades in 401 and 1 blade in 402A). FIG. 4 razor C shows an exploded view of the razor shown in FIG. 4A wherein cartridges 401 and 402 are attached to the razor body via attachment point (407) on the razor body and 405 on the cartridge.

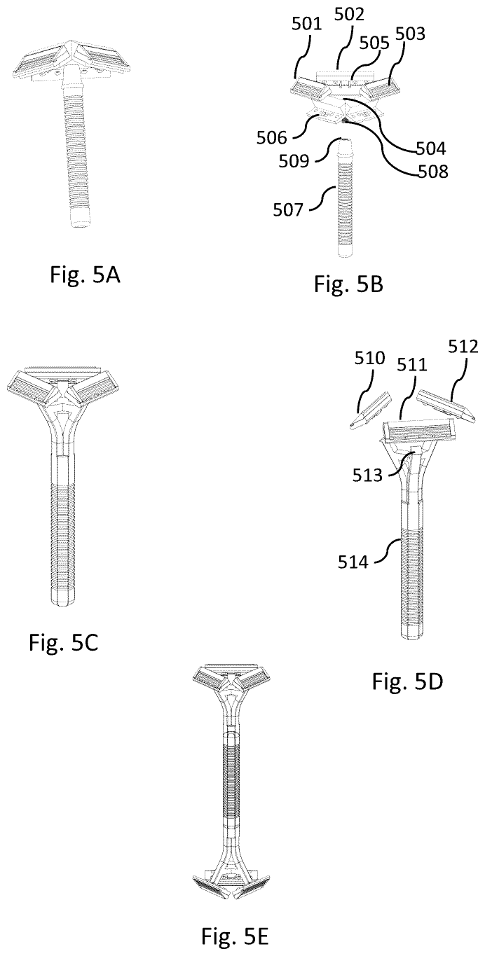

FIG. 5 shows a partial schematic representation of a wet shaving razor wherein the razor has at least three cartridges on one end of the razor. FIG. 5A shows a schematic of razor with 3 cartridges. FIG. 5A shows three connected cartridges via a solid body that provide a desired angle and flexibility during shaving. FIG. 5C shows a razor with 3 cartridges that are not directly connected or are independent of each other except at the attachment point on the handle. In both FIG. 5A and FIG. 5C, a triangular or substantially triangular arrangement of cartridges is preferred. FIG. 5B shows an exploded view of A wherein 3 cartridges (501, 502, 503) are connected to the razor body 504 via attachment site on the cartridge (505) and the razor body (506). The 504 razor body may be solid or hollow with an internal chamber to store shaving aids that may be fluidically connected to the cartridge. The handle (507) is connected to the razor body 504 via nut (508) and bolt (509) arrangement. FIG. 5C shows three razor configurations wherein all the cartridges are not connected and are in a triangular arrangement. FIG. 5D shows an exploded view of FIG. 5C wherein cartridges (510, 511 and 512) are attached to the razor handle 514 via attachment point 513. FIG. 5 razor E shows six cartridge razor similar to those shown in FIG. 5C wherein three cartridges are present on both ends of the razor handle.

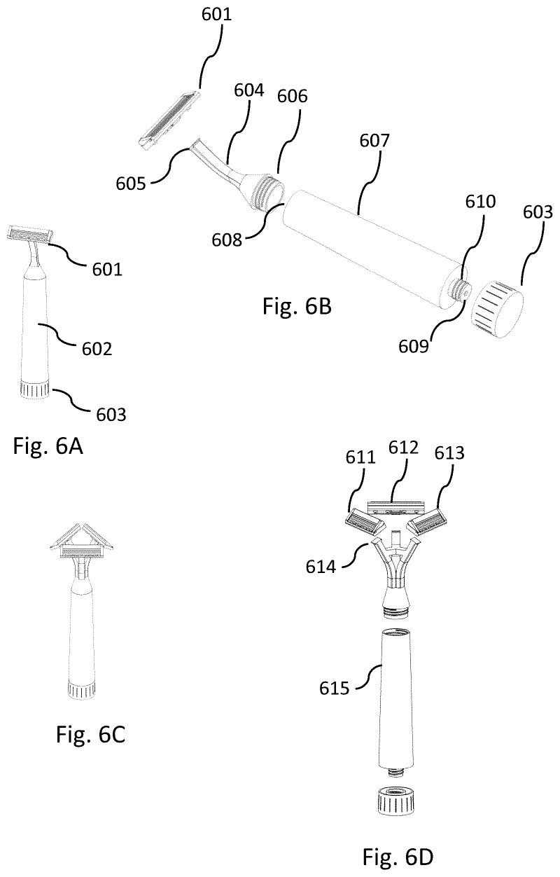

FIG. 6 shows a partial schematic representation of a wet shaving razor wherein the razor has one or three shaving cartridges and the capability to store and dispense liquids/gels in the handle. FIG. 6A shows a schematic of a razor with a shaving cartridge (601), a handle with a chamber/cavity (602) inside the body of the handle and a removable cap (603). FIG. 6B shows an exploded view of the FIG. 6A wherein different parts of the razor are identified and labeled. 601 shows a removable shaving cartridge with one or more cutting blades. 607 shows the main handle body that is hollow with outer wall thickness (T607). The cavity (602) inside the 607 is used for the fluid storage with a dispensing port on the distal end (609) and a refill port on the proximal end (608).

The distal end of the 607 body may be capped using a cap (603) and threads (610) on the distal end. The proximal end opening (608) is used to refill the stored liquid in the 607 body. 604 connects the cartridge and 607 body via threads (606) on the distal end of 604. The proximal end of 604 is connected to the cartridge via the 605 attachment point/area. FIG. 6C shows a razor that is similar to A but with three cartridges on the distal end. FIG. 6D shows an exploded view of FIG. 6C wherein three cartridges (611, 612 and 613) are connected to the main body 615 via three attachment points (614). 615 is used for fluid storage and dispensing similar to described in FIG. 6B.

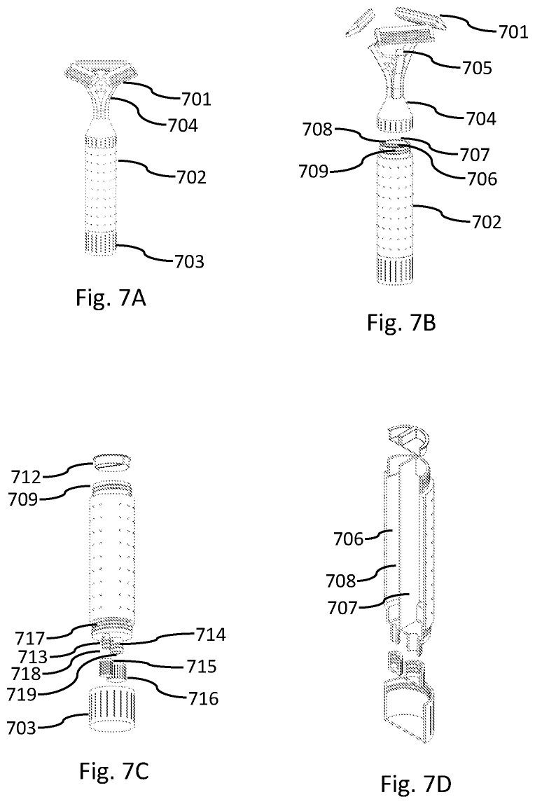

FIG. 7 shows a partial schematic representation of a wet shaving razor with multiple cartridges and the capability to store and dispense at least two shaving compositions such as shaving liquids/gels in the handle. FIG. 7A shows a sketch of a razor with three shaving cartridges (701), the handle with a dual chamber/cavity (702), a removable cap (703) and a body connecting three cartridges to the main body (704). FIGS. 7B, C D show an exploded and sectional view of FIG. 7A wherein different parts of the razor are identified and labeled. 701 shows removable three shaving cartridges. 702 shows the main handle body that is hollow with outer wall thickness (T702) and with two independent chambers 706 and 707 with a separating wall (708) between the chambers. Wall 708 is parallel to the long axis of handle 702. Wall 708 prevents fluidic communication between liquids stored in 706 and 707 chambers. The 704 body connects to the main handle body (702) via threads (709) and to the three cartridges via attachment point/port 705. FIG. 7C shows the exploded view of the handle 702 and D shows a sectional view of FIG. 7C. The two chambers/cavities (706 and 707) inside the 702 body are used for the storage of two separate fluids with openings on the distal end (718 and 719) that are used for dispensing the stored fluids. Both fluid dispensing nozzles may be capped by two caps 715 and 716 using threads (713 and 714) on fluid dispensing parts. The proximal end of the 702 body is closed using a cap (712) that fits both the chambers. The proximal end opening on the 702 handle is used to refill the stored liquid in 706 and 707 chambers. The 703 cap is used to enclose dispensing ports via 717 threads.

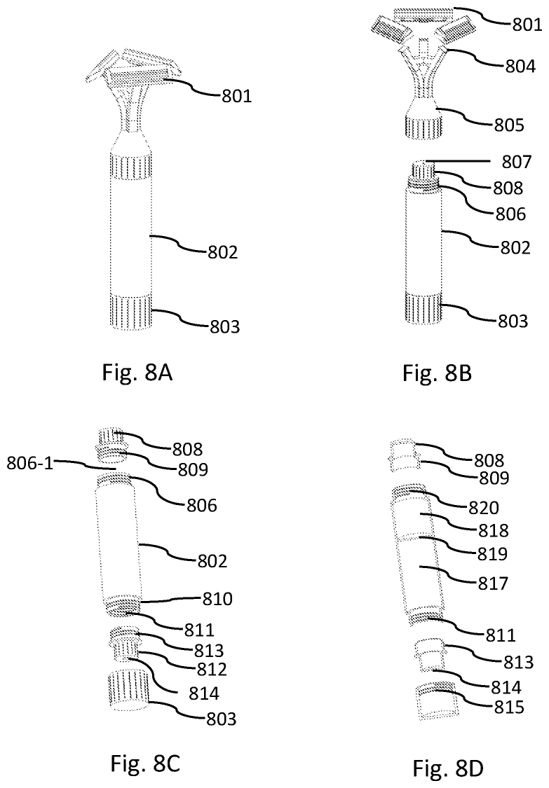

FIG. 8 shows a partial schematic representation of a wet shaving razor wherein the razor has one or more cartridges and with the capability to store and dispense two liquids/gels in the handle. This razor is similar to described in FIG. 7 except the arrangement of chambers in the handle is different. FIG. 8A shows a sketch of a razor with three shaving cartridges (801) and its handle with a dual chamber space (802). FIG. 8B shows an exploded view of the FIG. 8A wherein different parts of the razor are identified and labeled. FIG. 8B shows removable three shaving cartridges of the head section (801). 805 shows the section of the razor that connects handle (802) and cartridges (801) via cartridge attachment sites (804) on the proximal end and 806 threads on the handle. 805 is also used as a cap for 802 body/handle which may be attached using threads 806. The 802 body shows a fluid dispensing hole (807) for the top chamber (818).

FIG. 8C shows the exploded view of the handle body 802 and FIG. 8D shows the vertical sectional view of the FIG. 8C. 817 and 818 show the two chambers in the razor handle that are separated by the wall (819) which prevents fluidic communication between the two chambers. 806-1 on proximal end and 811 on the distal end show ports on the storage chambers that may be used for filling the chambers with fluids/liquids/gels. 810 and 806 show threads on the distal end and proximal end of 802 where each chamber which may be capped using 812 and 808 caps respectively. The caps 812 and 808 have threads (813 and 809) that are used for attachment to the handle body and they also have dispensing ports 807 and 814 for dispensing liquids from top and bottom chambers respectively. The head section (805) and cap 803 are removed to expose dispensing ports 807 and 814. The handle (802) is squeezed or gravity is used to dispense liquids stored in chambers 818 and 817. The dispensing ports may also be removed by unscrewing dispensing port caps to expose refill ports which then may be used to refill the storage chambers.

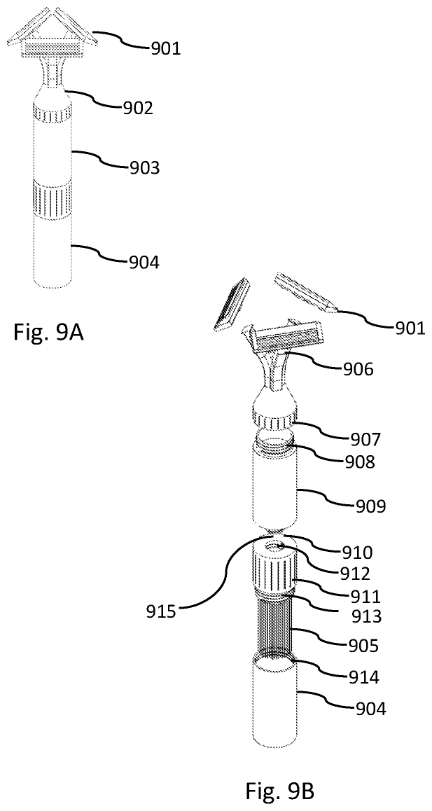

FIG. 9 shows a partial schematic representation of a wet shaving razor wherein the razor has one or multiple shaving cartridges on one end and a shaving brush at the other end; optionally the razor also has a capacity to hold and dispense liquid stored in the handle. FIG. 9A shows a sketch of a razor with three shaving cartridges (901), a removable body 902 that connects the razor handle (903) with cartridges and a shaving brush with a cap (904 cap and 905 brush) at the distal end. FIG. 9B shows an exploded view of the A wherein different parts of the razor are identified and labeled. FIG. 9B shows removable three shaving cartridges (901). 902 shows the section of the razor that connects the handle (903) and cartridges (901) via attachment port (906). 902 connects with the 903 body using threads (908). The 903 body has several parts wherein 909 is a storage chamber with terminal openings which is connected to 902 body on the proximal end and shaving brush (905) on the distal end via threads on both ends (908 and 910). The 909 is a hollow body that may be used for the storage of fluids/liquid/gels. The stored liquid may be dispensed via the dispensing port on the distal end of the 903 part (915 on 910 body) that is fluidically connected with the 909 internal chamber. The brush body (911) is connected at the distal end of 903 body using 910 threads. The terminal end of the razor is fitted with the shaving brush with bristles 905 and a protective cap (904). The 904 cap is preferably transparent. Optionally the fluid from the 909 chamber may be dispensed at the bottom of the brush via a fluidic connection between the 909 body cavity and brush bottom surface. The brush is removed from the device by manually rotating and unscrewing the 911 cap and removing the 904 cap that is attached via 913 threads and then used for shaving. Removal of brush exposes the fluid dispensing port (915) that may dispense fluid or gel such as shaving cream from the stored liquid in the internal chamber of 903 (909).

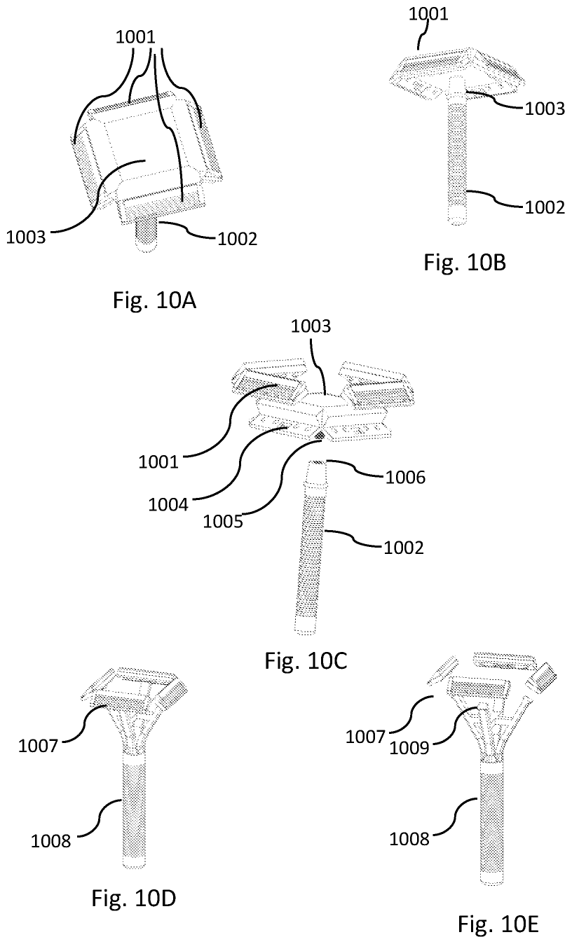

FIG. 10 shows a partial schematic representation of a wet shaving razor wherein the razor has four shaving cartridges in a razor head section that are arranged in a rectangular (preferably square) shape. FIG. 10A shows sketch of a razor with four shaving cartridges (1001), a removable razor handle (1002). FIG. 10B shows another view of the razor shown in A wherein the handle 1002 is connected to the cartridge holding body (1003). FIG. 10C shows an exploded view of the razor shown in FIG. 10B wherein four cartridges (1001) are attached to the cartridge holding body (1003) via attachment area 1004. The cartridges are attached to the razor handle by using a nut (1005). The 1003 body may be solid or hollow with a chamber that may store and dispense shaving aids. Eight cartridges (four on the distal and four on the proximal end of the handle) may be attached in this configuration. FIG. 10D shows another 4 cartridge configuration wherein 4 cartridges are arranged in rectangular configuration however the cartridges are not directly connected except at the area that connects all the cartridges to the handle. FIG. 10E shows an exploded view of the FIG. 10D wherein 4 cartridges (1007) are attached to the razor handle 1008 via attachment area 1009.

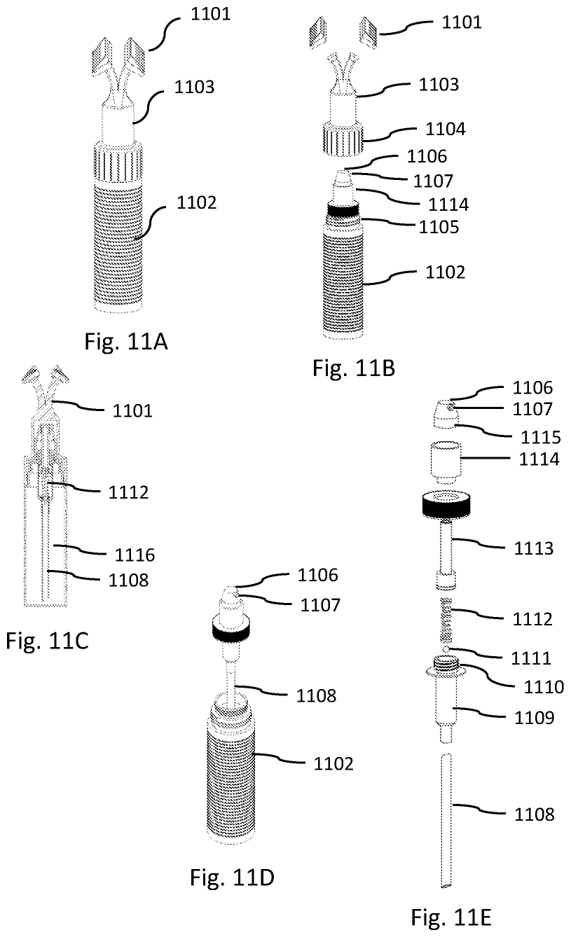

FIG. 11 shows a partial schematic representation of a wet shaving razor wherein the razor has one or multiple shaving cartridges and with the capability to store and dispense liquid stored in the handle. FIG. 11A shows sketch of a razor with two shaving cartridges (1101) and its handle with a chamber (1102) for fluid/gel storage and bridging part (1103) connecting 1101 and 1102. FIG. 11B shows an exploded view of the FIG. 11A wherein different parts of the razor are identified and labeled. FIG. 11B shows removable two shaving cartridges (1101) with 1 or more cutting blades. Cap (1104) on 1103 bridging part connects 1103 to handle 1102 via 1105 threads. 1106 is a part of dispensing mechanism on razor body (1102) which upon pressing one or more times, dispenses liquid stored in the 1102 hollow chamber (1116) via port 1107. FIG. 11C shows a sectional view of the FIG. 11A wherein the chamber (1116) is used for storing of fluid to be dispensed. FIG. 11D shows the dispenser used for dispensing fluids stored in the 1116 chamber. FIG. 11E shows an exploded view of the fluid dispensing part of the device (1102 body). Tube 1108 is immersed in a liquid stored in chamber 1116. The tube 1108 is connected to the housing (1109) which houses part of 1108 tubing and bearing (1111) and spring (1112). 1113, 1114 and 1115 are part of the dispensing mechanism attached to the spring and tube via threads (1110). The surface of 1115 (1106) is pressed which compresses the spring which in turn pushes the liquid via tube and dispensed via port (1107). In using this device, the user will unscrew and remove the cap (1104) which will show/expose the dispensing part of the device. The user will manually push the 1106 surface one or more times to dispense shaving aid composition stored in the 1102 body/bottle. Upon dispensing the composition, the user will reattach the cap and its cartridges and perform shaving using the two cartridges attached.

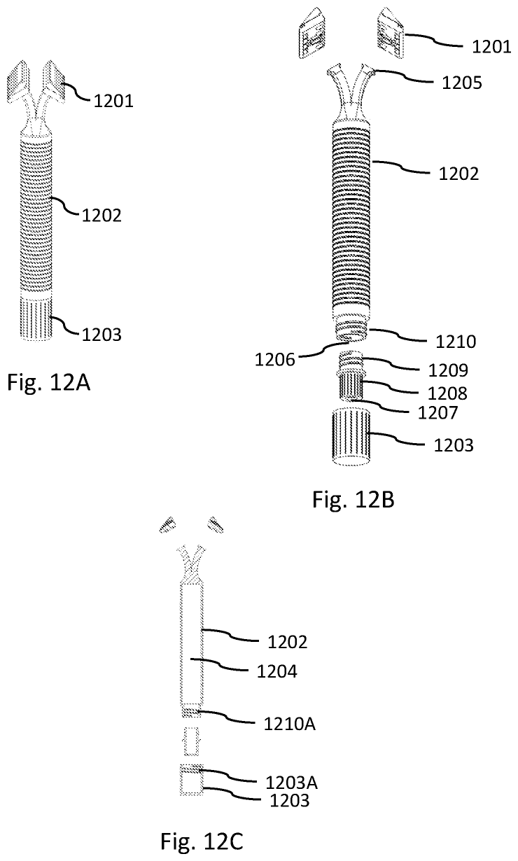

FIG. 12 shows a partial schematic representation of a wet shaving razor wherein the razor has one, two or more shaving cartridges on one end and with the capability to store and dispense liquids/gels in the handle. FIG. 12A shows a sketch of a razor with two shaving cartridges (1201), the handle (1202) with a compartment in the body of the handle for fluid storage and a removable cap (1203). FIG. 12B shows an exploded view of the FIG. 12A wherein different parts of the razor are identified and labeled. FIG. 12C shows a sectional view of FIG. 12B wherein the storage cavity (1204) inside the handle and other parts are shown. 1201 shows a removable shaving cartridge with 1 or more cutting blades. 1205 shows the slot/site where the cartridge is attached to the razor. The attachment is such that it provides a firm connection with the razor body during shaving without dislodging but also may be easily removed if desired. 1202 is the main handle body that is hollow with outer wall thickness (T1202). The proximal end of 1202 has one or two or more shaving cartridges and the distal end has one dispensing port (1207) and one refill port (1206) and both ports may be closed using 1208 and 1203 caps. 1203 cap has internal thread 1203A and distal end has internal threads 1210A which may be used in attaching caps via external threads (1209 and 1210). Port 1207 is fluidically connected to the 1204 storage chamber. The handle has two caps at the distal end of the handle (1208 and 1203). Removing the outer cap (1203) exposes the shaving aid dispensing port (1207) from which the shaving aid is dispensed. The dispensing port may also be removed (unscrewed) to open up the refill port (1206) which may be used to refill the shaving aid. The shaving aid is dispensed via 1207 port using gravity, manual shaking or squeezing the handle body 1202. The materials property of 1202 body is such that dispensing is done without substantial plastic deformation or no plastic deformation of the 1202 body.

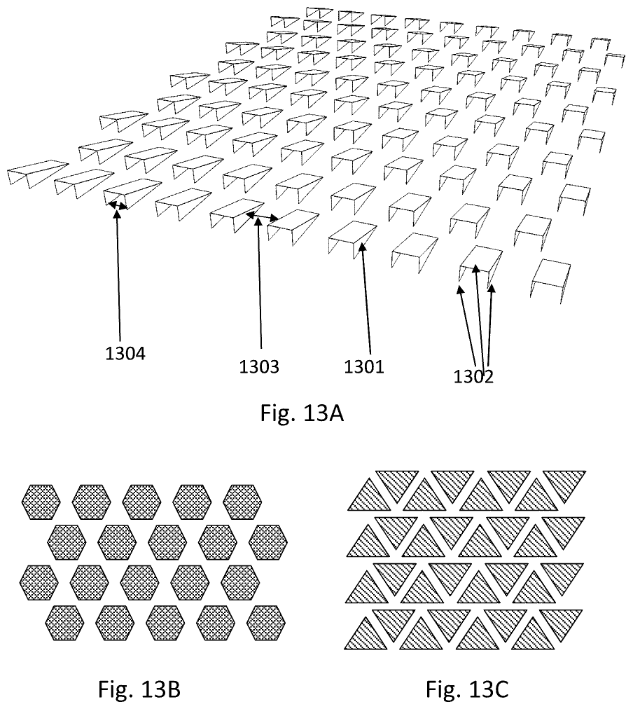

FIG. 13 shows a partial schematic representation of a wet shaving razor wherein the several mini or micro cutting elements also referred as microblades or micro-blades are arranged to make an array of shaving blades. The use of microblades results in increased cutting length of the razor blade. FIG. 13A shows a basic cutting element or microblade (1301) that is repeated several times on the cutting surface of the razor blade. In this specific non-limiting example, cutting elements have three cutting lengths (1302) which are used in cutting skin hair. By design, cutting elements 1301 are arranged in an array format so that several cutting blades (1302) may cut the facial hair simultaneously. The gap between cutting elements (1303) and within the cutting elements (1304) helps to carry the cut hair and shaving foam debris to the edges of the razor blade. FIG. 13B shows a hexagonal cutting blade array where each side of the hexagon has cutting edges. FIG. 13C shows a triangular-shaped cutting blade wherein each side of the triangular cutting blade has a cutting edge and space between the triangular cutting element is designed to move cut hair and wet shaving gel/cream away from the blade surface. Microblade cutting surfaces without pointed edges are most preferred.

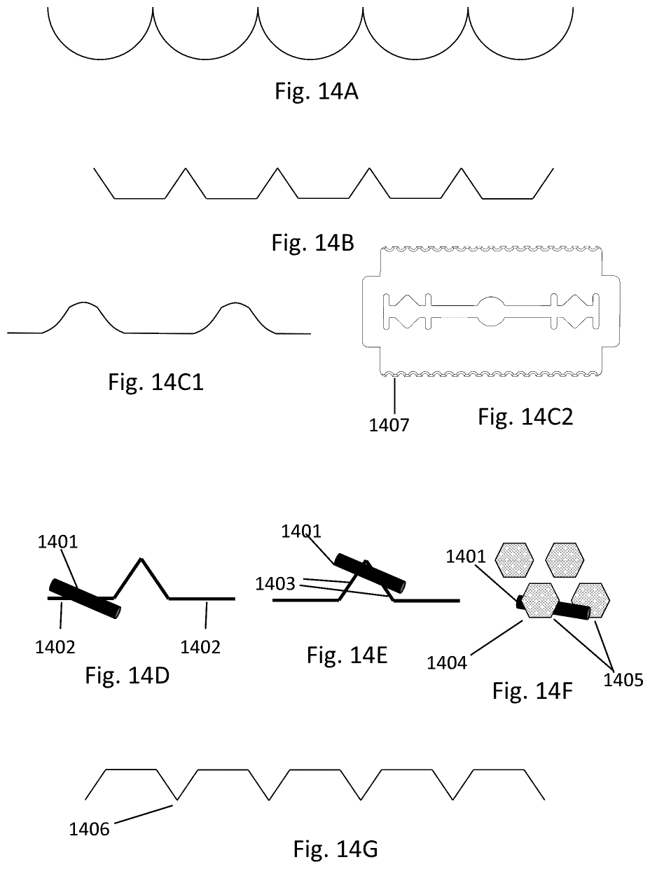

FIG. 14 shows a partial schematic representation of the shaving razor cutting blade shape designed to increase the overall cutting length of the shaving blade. FIG. 14A shows a semicircular pattern of cutting edge blade. B shows a combination of triangular and straight edge cutting surface. FIG. 14C and FIG. 14G show a combination of non-straight edge and straight edge cutting blade patterns. FIG. 14C1 shows a combination of straight edge and semicircular pattern without any sharp corners. FIG. 14C2 shows the FIG. 14C1 like pattern (1407) created in a shaving blade. FIG. 14D shows cutting action of hair (1401) using straight cutting edge (1402). FIG. 14E shows two cutting edges (1403) performing cutting action on the 1401 hair. FIG. 14F shows the hair (1401) being cut by hexagonal micro-cutting blades (1404) at the same time as the hair passes through between two micro-cutting elements (1405). FIG. 14G shows a cutting edge pattern with the pointed edge or sharp corner (1406) which is least preferred.

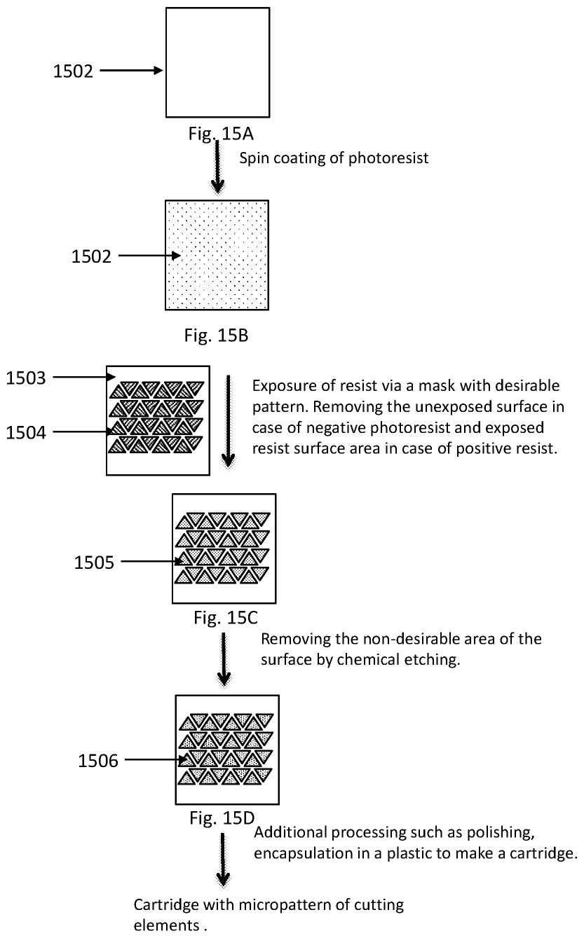

FIG. 15 shows a partial schematic representation of one of the methods for making an array of microblades. 1502 shows a surface of a metal surface wherein the metal is generally used for conventional shaving blade manufacturing. 1502 shows the planar surface is coated with a photoresist preferably using spin coating method. The surface is then covered with a photomask (1503) which has the desired pattern of microblades wherein the light may only pass through in areas where cutting elements are not present. The photoresist is exposed to UV light to duplicate the pattern in the 1502 surface. The unexposed area of the resist is removed by using a developer solution provided by the photoresist manufacturer. The exposed metal surface produced by the removal of photoresist is removed by a controlled chemical etching process which affects only the area of the exposed metal surface. After the etching process, the photomask material is removed using a separate solution provided by the photoresist manufacturer. These steps are repeated one, two, three or more times to produce more complex microblade patterns. The microarray of cutting elements thus produced (1506) is further polished with additional etching/polishing processes. Finally, the products and other blades are encapsulated in a plastic enclosure with a desired arrangement that converts them to a razor cartridge.

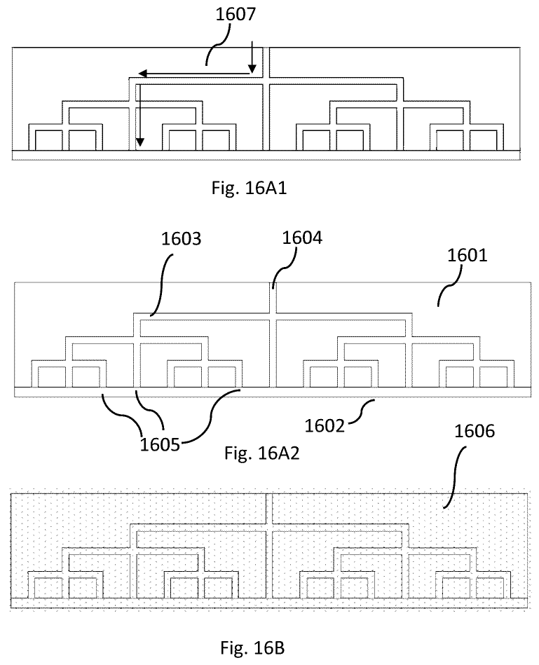

FIG. 16 shows a partial schematic representation of a razor cutting blade with microfluidic channels for fluid/lubricant distribution during/after shaving. FIG. 16A1 shows a sketch of the shaving blade surface with microchannels carved into the blade surface or body. The 1601 shows the blade surface/body and 1602 shows the cutting edge of the blade. 1603 shows microfluidic channels carved into the 1601 surface/body. 1604 shows the inlet of the fluid channel and 1605 shows several multiple outlets which deliver the fluid just above the cutting surface. The direction of fluid flow is from inlet to outlet and is shown in 1607. Black arrows show some of the fluid paths starting from inlet to outlet. The razor in FIG. 16B is the same as FIG. 16A except the surface with the microfluidic channels is coated with a coating (1606) to embed the channels between the metal and the coating. Metal blade in FIG. 16A is used for illustration only. Lubricant strip (203) or spacer between the blades (211 and 212) may also be used for microfluidic channel creation and use.

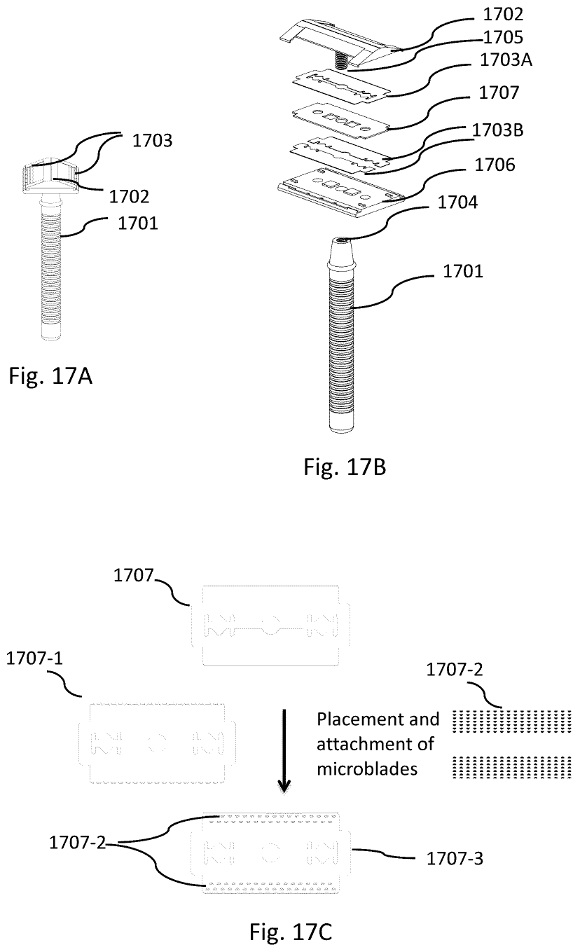

FIG. 17 shows a partial schematic representation of a wet shaving razor wherein the razor and blades are assembled by the user prior to use. FIG. 17A shows the sketch of the razor with two cutting blades on both sides of the razor. Razor shown in FIG. 17A has a razor handle (1701) and shaving cartridge (1702) with 2 cutting blades (1703) on each side. FIG. 17B shows an exploded view of FIG. 17A showing different parts of the razor. 1701 is a razor handle with a hole (1704) on one end that is used to secure the blade assembly via a screw 1705. 1706 is a base plate on which a standard shaving blade (broken into two equal parts, 1703B) is placed. 1707 is a spacer plate between two blades that helps to maintain a desired gap and angle between the blades and may have microfluidic channels. 1703A is the second blade that is added on top of the spacer plate without breaking. Finally, the top plate 1702 with screw 1705 is applied on the 1703A blade. The top plate 1702 could be hollow with the ability to store and dispense liquids such as lubricant solution. The stored fluid may be delivered via spacer plate (1707) with microchannels that are fluidically connected with the storage chamber. The screw passes through all the layers in the assembly and is lastly inserted in the 1704 hole and tightened. The reverse of this operation is used to dismantle the razor and blades. FIG. 17 panel C shows a process by which a regular blade (1701) is converted to a blade with a microblade array (1707-3). Regular blade (1707) is used to stamp out about 1 mm semicircular sections (1707-2). The semicircular blade sections (1707-2) are then adhesively bonded on a new 1707 blade as an array to make a razor blade with a microblade array (1707-3). The new blade (1707-3) is used to make a razor as shown in FIG. 17B.

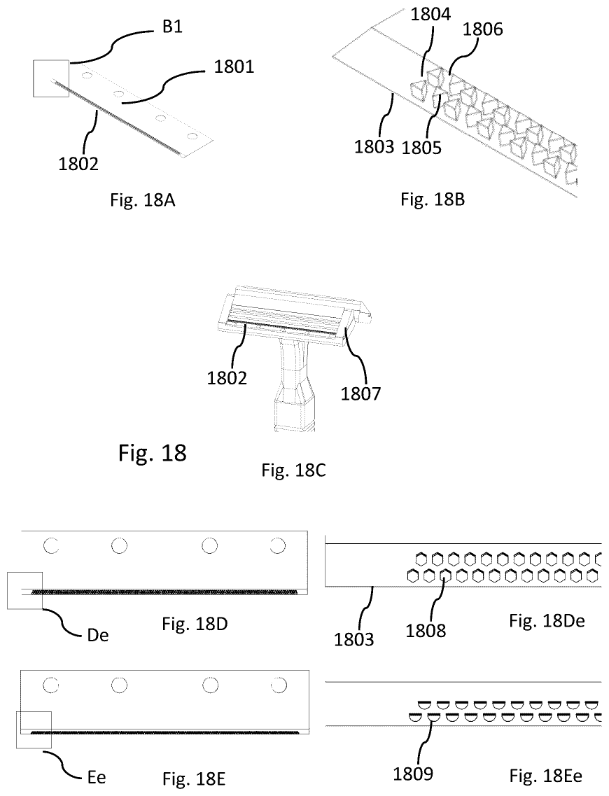

FIG. 18 shows a partial schematic representation of a wet shaving razor with micro cutting elements made just above the cutting edge of the razor blade. FIG. 18A shows sketch of a razor blade with 1801 as its top surface/body. 1802 shows the cutting edge of the blade with microblade array just above the standard cutting edge of the razor blade. FIG. 18B shows an amplified view of some portion of the 1801 surface (B1). 1803 shows the normal cutting edge of the razor. B also shows an array of equilateral triangle-shaped microblades that are arranged in a symmetrical pattern with a well-defined gap. 1804 is a triangular cutting blade with height (1805) and a gap between the cutting element (1806). The edges of the triangular cutting elements are sufficiently sharp and have the capability to cut the hair during normal shaving operation. FIG. 18C shows a razor with cartridge made using cutting blade as shown in FIG. 18A with cartridge holding body 1807. At least one of the blades, preferably the first blade in the cartridge has a microblade array (1802). FIG. 18D shows a razor blade with a hexagonal shaped microblade (1808) array. FIG. 18De shows an expanded view of one area of the blade FIG. 18D. FIG. 18E shows a semicircular cutting blade (1809) array and FIG. 18Ee shows an expanded view of one area of the blade FIG. 18E.

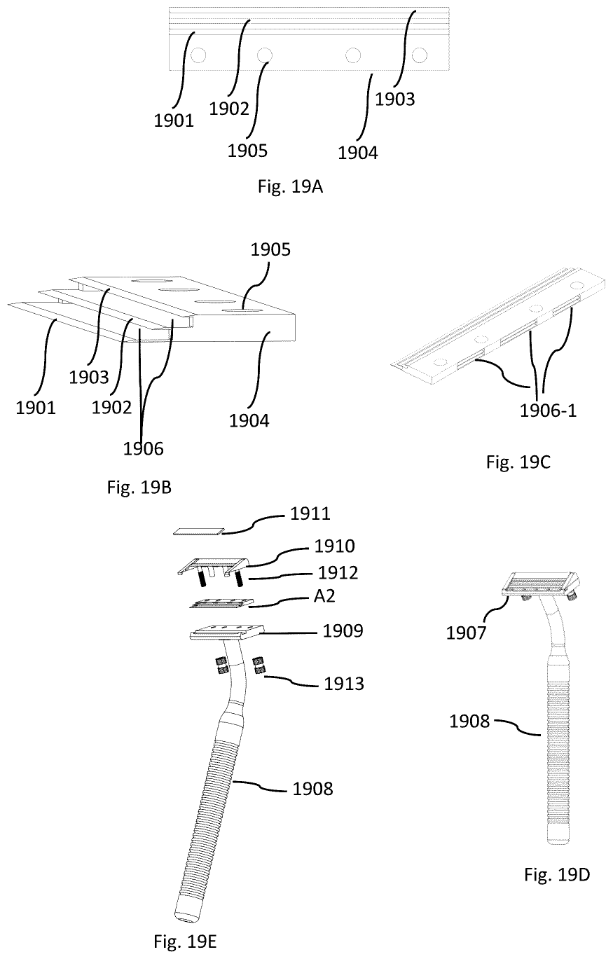

FIG. 19 shows a partial schematic representation of a wet shaving razor made using a single block of the metal piece made via mechanical carving, electrochemical deposition, photolithography and etching, casting/3D printing methods used for metal fabrication or combination thereof. FIG. 19A shows sketch of a razor blade with a 1904 body and its top surface. FIG. 19A shows a front view of the single unibody metal blade with three cutting blades (1901, 1902 and 1903) attached to a metal body (1904). Holes in the 1904 body (1905) are used for cartridge assembly. One side of the 1904 body has window/s or inlets that are fluidically connected with the gaps between blades which is used to flow water and clean the trapped debris generated during wet shaving operation. FIG. 19B shows the side view of A wherein blades (1901, 1902 and 1903) are separated by a gap (1906) which is fluidically connected with the back window (1906-1) of the 1904 body. FIG. 19C shows the backside of A wherein window/s or inlets (1906-1) are visible. D shows the shaving razor made using the cartridge (1907) and handle (1908). FIG. 19E shows the exploded view of the razor made with cartridge as shown in FIG. 19A with identification and labeling parts of the razor. The handle has a base plate (1909) on which the three-blade assembly (FIG. 19A) is kept. The assembly and base plate are connected with the top plate (1910) and lubricant strip (1911). Upon arranging all parts, the top plate (1910) and its screws (1912) are inserted through the assembly via holes on the FIG. 19A (1905) and 1909 body. The screws (1912) and nuts (1913) are joined together to form a razor.

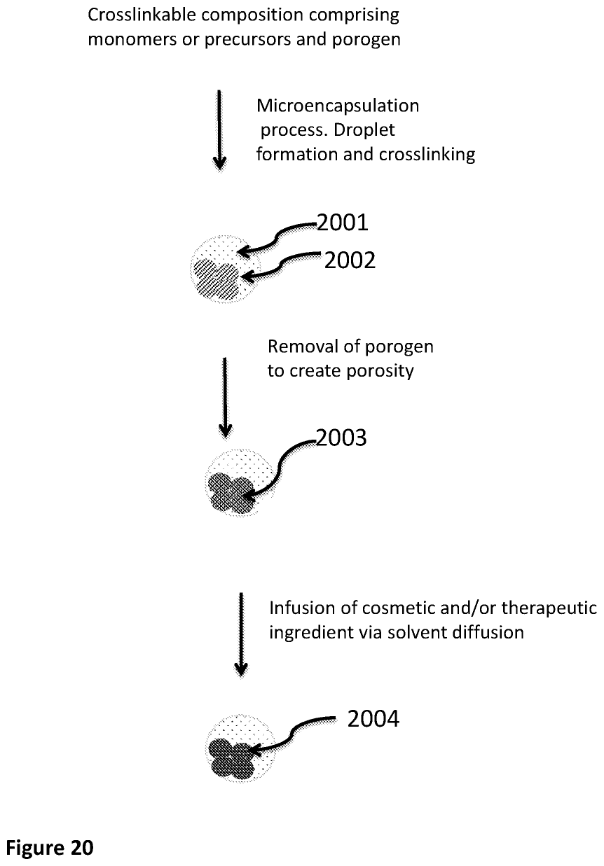

FIG. 20 shows a partial schematic representation of a process to make porous hydrogel microspheres. A crosslinkable composition comprising precursor/s such as macromonomer with photoinitiator and porogen is subjected to droplet formation and crosslinking process (microencapsulation process) wherein hydrogel microspheres (2001) with entrapped porogen (2002) are formed. The porogen is removed by dissolution, evaporation, sublimation and other processes to create a space (porosity, 2003) in the microsphere body/surface. The porosity thus created is then partially or completely filled with the desired amount of cosmetic ingredient/s or composition/s (2004) such as oil, fragrance and the like.

FIG. 21 shows two illustrative multi-cartridge razor wherein at least one cartridge interferes or obstructs with other cartridges while shaving. FIG. 21A shows sketch of a 3 cartridges (2101, 2102, 2103) razor where one cartridge interferes with other cartridges. Cartridge 2101 when used for shaving, is obstructed by the corners of 2102 or 2103 blades and thus prevents full contact of razor 2101 blades with the facial tissue surface. FIG. 21B shows 4 cartridge configurations (2104, 2105, 2106 and 2107) wherein 2104 and 2106 blades cannot be used efficiently as corners of 2107 and 2105 interfere with full facial contact.

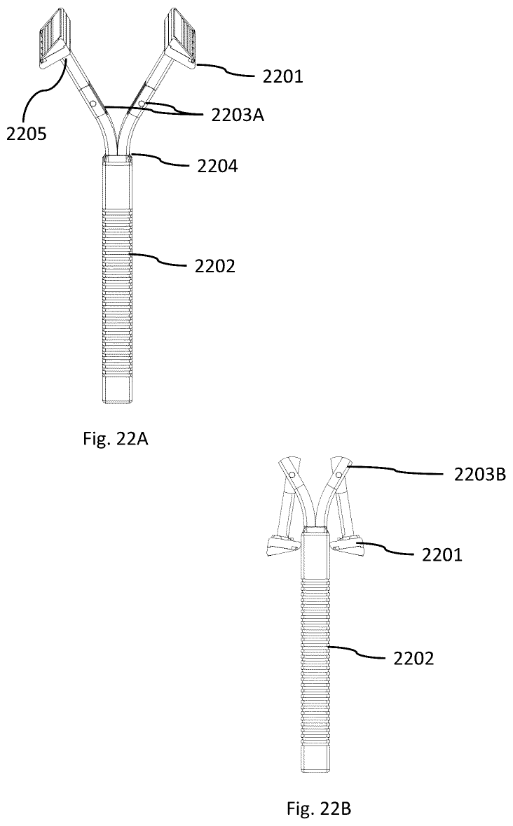

FIG. 22 shows one illustrative multi-cartridge razor wherein at least one cartridge is able to fold or collapse during storage or use if needed. FIG. 22A shows an illustrative 2 cartridge razor with 2201 as a cartridge, 2202 as the handle and 2203 as a hinge between an arm connecting handle and cartridge. FIG. 22A shows the non-collapsed form/configuration of the razor. FIG. 22B shows collapsed form/configuration of a razor shown in FIG. 22A wherein the hinge (2203) is used to bend the front half portion of the cartridge arm to fold and collapse on the 2202 handle. 2204 and 2205 show additional preferred areas that may be used to attach a hinge. One or more hinges per arm at various locations and types of hinge used will provide more control over collapsed and expanded configurations.

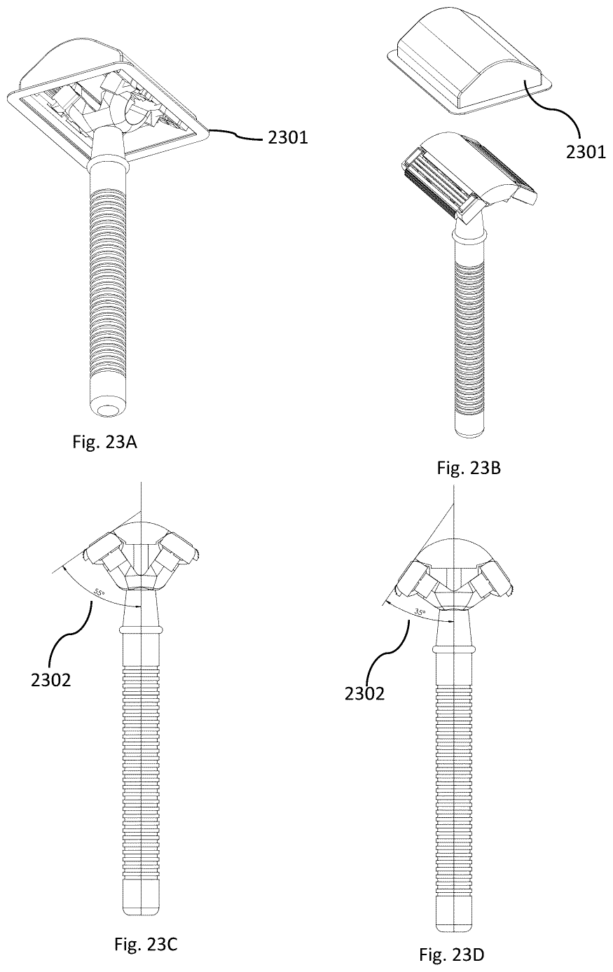

FIG. 23 shows a partial schematic representation of a wet shaving razor wherein the razor has multiple shaving cartridges and a combined or individual protective cap. FIG. 23A shows a schematic of a razor with two three blade cartridges with a removable protective cap (2301). The cap covers both the cartridges. Sketch of razor shown in FIG. 23B is the same as FIG. 23A except its cap (2301) is removed. FIGS. 23C and D shows the angle (2302) of cartridge blade/s plane with respect to razor handle axis. FIG. 23C shows a relatively wide angle around 55 degree and FIG. 23D shows a relatively narrow angle around 35 degree.

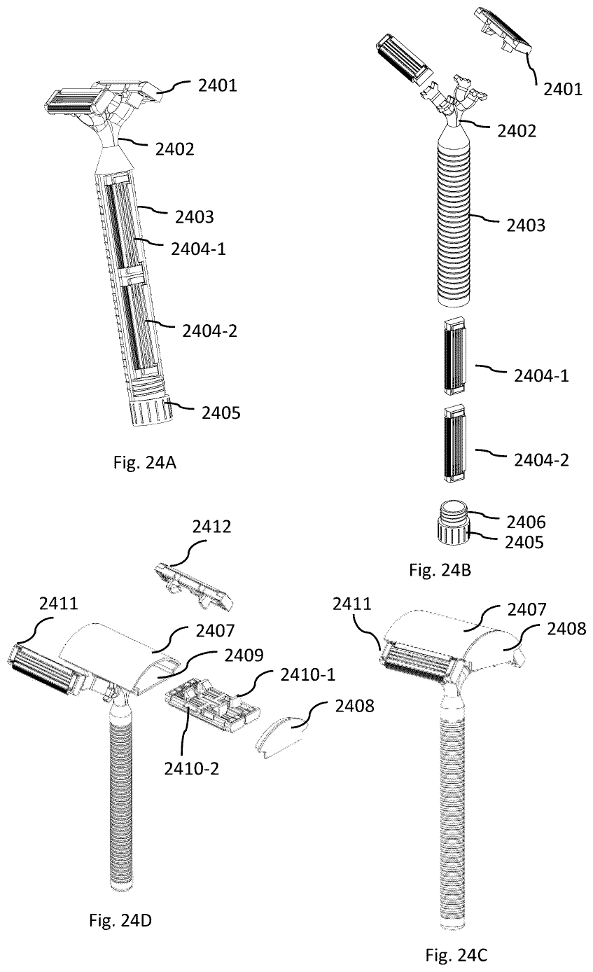

FIG. 24 shows a partial schematic representation of a wet shaving razor wherein the razor has capability to store one or more shaving cartridges in the handle or in the head space. FIG. 24A shows sketch of a razor with two shaving cartridges (2401) that are used for shaving, a removable body 2402 that connects with the razor handle (2403) with additional shaving cartridges 2401. The 2403 is preferably transparent or semi-transparent with volume and shape that may accommodate one or more shaving cartridges such as 2401. 2404-1 and 2404-2 show two storage cartridges that are fitted inside the 2403 body cavity (FIG. 24A). 2405 is a removable cap that may be attached to the 2403 body via threads (2406). FIG. 24B shows an exploded view of FIG. 24A showing removable shaving cartridges 2401, handle 2403, two storage cartridges (2404-1 and 2404-2) that may be used in place of 2401 and may be stored inside 2403 body cavity. The stored cartridges may be locked inside the razor using the removable cap 2405. The stored cartridges may be removed by unscrewing the cap and removing the stored cartridge/s and then using them in place of 2401 cartridge. FIG. 24C shows a shaving razor with cartridge storage space in the head section of the razor (between the two shaving cartridges of the razor 2411 and 2412). FIG. 24D is an exploded view of FIG. 24C. 2407 is a hollow storage body between the razor blades 2411 and 2412. 2408 is a removable cap on the 2407 body. The 2407 body is hollow with desired wall thickness and has a storage space (2409) that is sufficient for storage of one or two shaving cartridges (2410-1 and 2410-2).

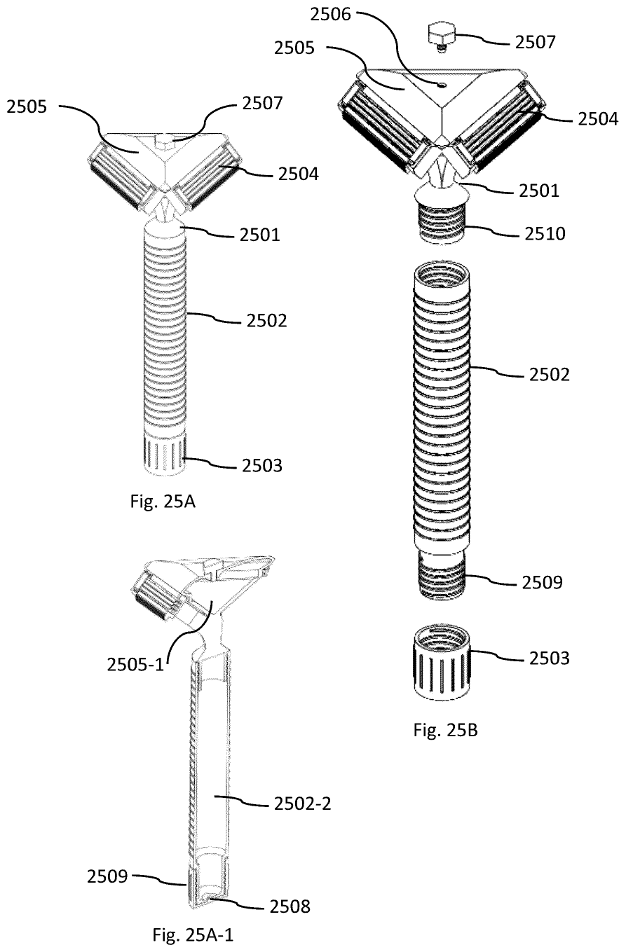

FIG. 25 shows a partial schematic representation of a wet shaving razor wherein the razor has capability to store and dispense two or more fluids/liquid compositions. FIG. 25A shows a sketch of a razor with three shaving cartridges and has capability to store and/or dispense two or more cosmetic compositions. FIG. 25A-1 shows a sectional view of A which shows storage space in razor head (2505-1) and handle (2502-2). FIG. 25B shows an exploded view of FIG. 25A wherein major parts of FIG. 25A are depicted. FIG. 25B has three main sections. The top portion comprises three cartridge head (2501) that may be attached to the handle (2502) and cap (2503). The head portion is connected to 2502 body via threads 2510. 2503 is a removable cap that may be attached to handle (2502) via threads (2509). The head portion 2501 has three cartridges (2504) and the space in between the cartridge is occupied by a hollow chamber (2505-1) with space/volume for storage of cosmetic composition. The 2505-1 is fluidically connected to a dispensing port 2506 and a removable cap 2507. The handle 2502 is also a hollow body with space 2502-2 that may be occupied by a cosmetic composition. The 2505-2 is fluidically connected to a dispensing port 2508 and a removable cap 2503.

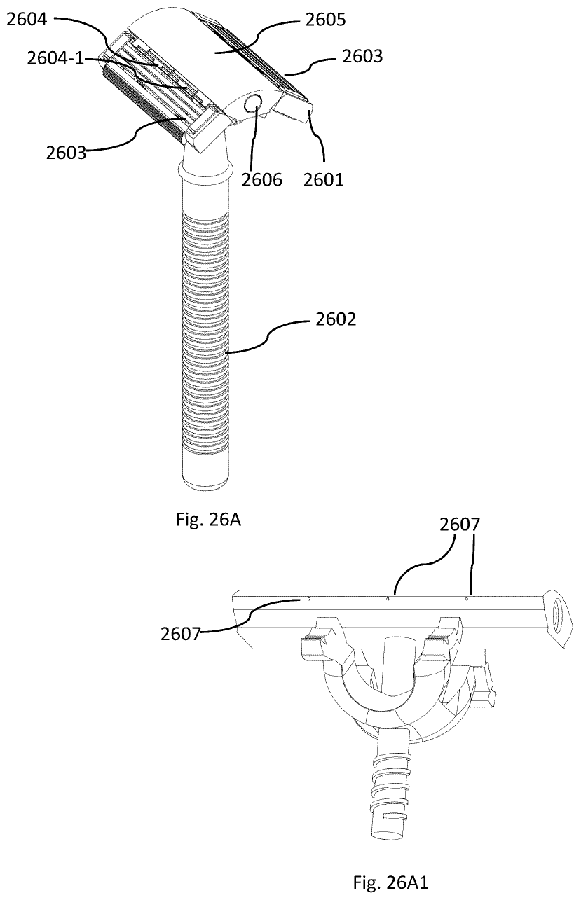

FIG. 26 shows a partial schematic representation of a wet shaving razor wherein the razor has capability to dispense lubricant during wet shaving. FIG. 26A shows a sketch of a razor with two shaving cartridges and space between the cartridges is used to store a shaving lubricant that is delivered to the lubricant strip on the cartridges via gravitational force. The razor shown in FIG. 26A has two main parts comprising the head portion (2601) that comprises two cartridges and the handle portion (2602). The head portion comprises two cartridges (2603) with lubricant strip (2604). The lubricant strip preferably has microfluidic channels (2604-1) that assist in distribution of lubricant. The space between the cartridges is occupied by a hollow body (2605) that may store and dispense liquids such as shaving lubricant. The hollow body (2605) also has a port with a removable cap (2606) that may be used for refilling the liquid or lubricant if desired. FIG. 26A shows a sectional view of head part (2601) that shows three holes (2607) that are fluidically connected to the lubricant storage container and deliver the lubricant to the lubricant strip (2604) preferably via gravity assisted mechanism.

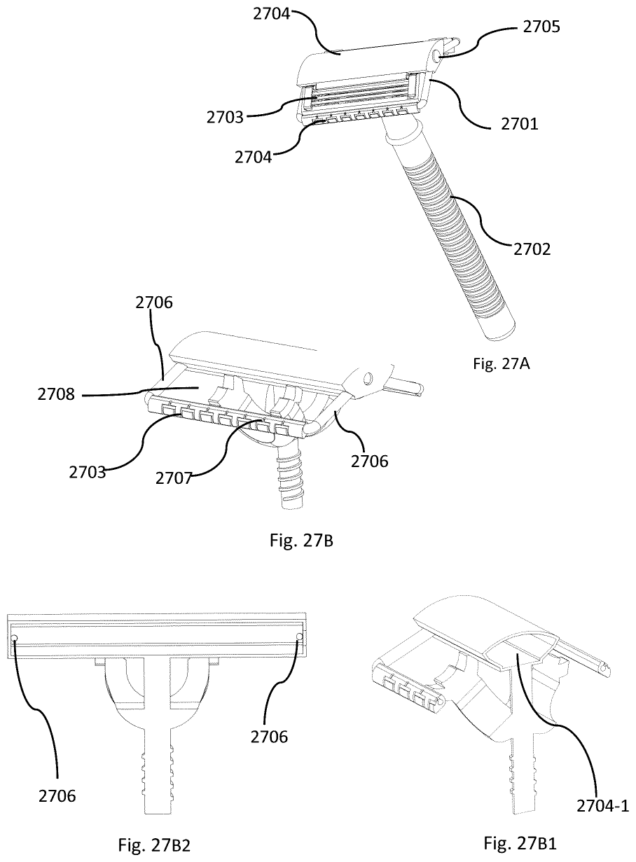

FIG. 27 shows a partial schematic representation of a wet shaving razor wherein the razor has capability to dispense lubricant at the bottom portion of cartridge during wet shaving. FIG. 27A shows a sketch of a razor with two shaving cartridges and space between the cartridges that is used to store a shaving lubricant. The stored lubricant is delivered to the lubricant strip at the bottom of cartridges via gravitational force and through the fluidically connected tubes. The razor shown in FIG. 27A has two main parts comprising the head portion (2701 and the handle portion (2702). The head portion comprises one or two cartridges (2703). The space between the cartridges is occupied by a hollow body (2704) that may store and dispense liquids such as lubricant. The hollow body (2704) also has a port with a removable cap (2705) that may be used for refilling the liquid or lubricant if desired. FIG. 27B shows sketch of the head portion without removable cartridges. The space surrounding the cartridge is occupied by a tube (2706) that carries the lubricant from the lubricant storage part to the bottom portion of the tube (2709). The bottom portion of the tube is perforated so that the lubricant may come out of the perforated holes and deliver to the lubricant strip (2707). Preferably the lubricant strip has microfluidic channels which help to distribute the lubricant to the skin surface. FIG. 27B1 shows a sectional view of part FIG. 27B wherein the section is taken parallel to the handle. The 2704-1 shows the storage space for the lubricant inside 2704. FIG. 27B2 shows another sectional view of part FIG. 27B parallel to the handle. It shows the 2706 tubes on both sides. The lubricant may be delivered at the top and/or bottom lubricant strips via 2706.

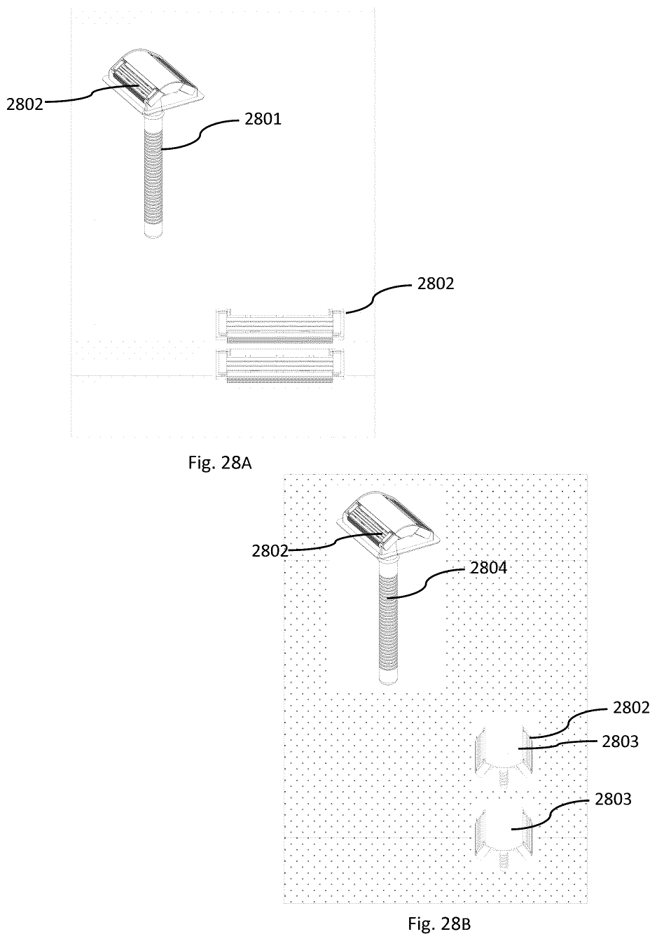

FIG. 28 shows a wet shaving kit wherein a multi-cartridge razor and two or more spare cartridges are assembled and packaged together as a kit. FIG. 28A shows a kit comprising a wet shaving razor (2801) with two removable cartridges (2802) packaged with two spare cartridges (2802). FIG. 28B shows a kit comprising a wet shaving razor (2804) with two removable cartridges and two spare cartridges. The head portion with two cartridges (2802) is packaged as kit instead of one single cartridge as shown in FIG. 28A. The head portion of the razor (2803) is removeable from the handle and is then replaced with spare head section as shown in FIG. 28B.

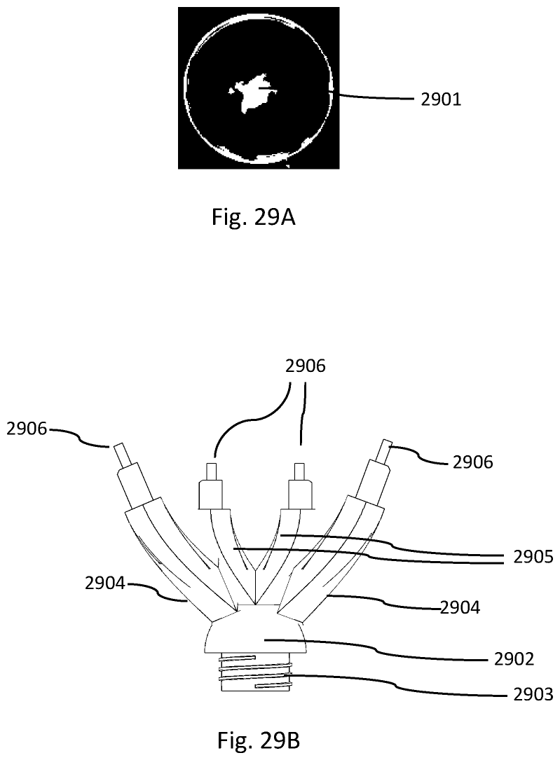

FIG. 29 shows an illustrative image of organogel based water soluble shaving cream (2901) in a Petry dish as described in this invention. It also shows a sketch of razor head with two shaving cartridges and two spare cartridges. FIG. 29B shows sketch of a razor head with 4 shaving cartridges. Part 2902 shows a head section of the razor and 2903 show attachment point of head section to razor handle. The head section has two terminal shaving cartridges (2404) that are used for normal shaving and two spare shaving spare cartridges (2905) between terminal cartridges. The arrangement of 2904 and 2905 is such that 2905 will not interfere/obstruct while shaving using 2904 cartridges. 2906 is an attachment point for shaving cartridges (preferably with 1-7 blades) to the razor head 2902.

### DESCRIPTION OF PREFERRED EMBODIMENTS

FIGS. 1A-1C show partial schematic representations of 3 blade wet shaving disposable cartridge wherein main parts of the cartridge are identified. FIGS. 1A, B and C show front view, side view and back view respectively 101 shows the cartridge body to which the lubricating strip (102) and three cutting blades (103, 104 and 105) are attached. The blades 103, 104 and 105 have length L1, L2 and L3 respectively and the length of all blades are equal. Blade 103 at the bottom of the cartridge is referred to as the first blade with length L1 similarly bade 2 with Length L2 and blade 3 with length 3. 106 shows the gap between blades. 107 shows the attachment site on 101 body wherein a removable razor handle is attached to the cartridge. The remaining two blades (104 and 105) do the secondary cutting function not completed by the first blade. In one aspect of this invention, this invention provides a razor with multiple cartridges with 2 or more cartridges per razor, preferably 3 to 12 cartridges per razor.

FIGS. 3A-3D show a partial schematic representation of a wet shaving razor wherein the razor has two or more total cartridges. FIG. 3A shows a shaving razor with 3 cartridges (301, 302 and 303) wherein one cartridge (303) is on the distal end and the other two cartridges (301, 302) are on the proximal end of the razor handle (304). The cartridges 301 and 302 have no direct connection/contact except at the base of the handle where they are joined. The alignment of cartridges on the proximal end (301 and 302) is preferably parallel or substantially parallel. The alignment of cartridges between the proximal end (301,302) and the distal end (303A) is preferably parallel or substantially parallel (FIG. 3A). The same alignment could also be perpendicular or substantially perpendicular such as shown in FIG. 3B. FIG. 3C shows exploded view of razor 1A wherein removable cartridges are firmly attached to the razor handle (304) via attachment point (305) and with optional blade/cartridge protecting cover (306). FIG. 1D shows a 4 cartridges razor configuration wherein the cartridges 307 and 308 are attached on the proximal end of the razor handle (311) and are parallel to each other. Cartridges 309 and 310 are attached on the distal end of the razor and are also parallel to each other. Top cartridges (307, 308) and bottom cartridges (309, 310) may be parallel or perpendicular to each other. In the multi cartridge razor configurations such as shown in FIG. 3A, 3B, 3C or 3D and others described in this invention may have an identifier on the razor, or on the cartridge or on the protective cover so that each cartridge in the razor may be easily identified preferably visually identified during usage. The preferred method of identification is a visual method wherein an aided or unaided human eye may easily distinguish between each cartridge on the razor. In one illustrative embodiment, the 4 cartridge casings shown in FIG. 3D have different colors. In FIG. 3D, cartridge casings are yellow (308), blue (307), red (309) and green (310) respectively. Alternatively, identification numbers like 1,2,3,4 or other letters/signs/symbols preferably with font size greater than 8 could be embossed or printed on each cartridge part starting with 307-310 respectively and used as an identification feature. 312 shows printed letter 2 on cartridge 308. The presence or absence of protective cover 306 may also be used as a visual identifier. If the user wants to use only one cartridge multiple times without using other cartridges on the razor, then a visual identifier may enable the user to use the same cartridge multiple times. Other methods of identification, preferably visual identification methods known in the art or yet to be developed may also be used. When a razor such as shown in FIG. 3D is used in wet shaving application, either one of four blades (307) may be used. As the shave progresses, foam/gel and cut hairs accumulate on the used cartridge. When sufficient foam is accumulated, the handle is rotated around 180 degrees and the shaving is continued with the other (308) blade. The blade 308 has a new cutting surface available for the shave. If needed, blades 309 and 310 may be used for shaving by inverting the razor and then rotating to use all 4 cartridges. One, two, three or all four cartridges are washed at the end of the shave and cartridges are reused for the next shave. Since all 4 cartridges may be used for shaving and each cartridge has some capacity to retain attached shaving foam/debris, a complete or almost complete shave may be achieved without washing the blade/cartridge to remove debris and thus saving water. In single cartridge razor use cases, as the foam is accumulated, it is removed by washing with water and the same cartridge is used for the rest of the shave. In this invention, it may be possible to almost complete the entire shave without washing (between the shave) by the use of two or more cartridges (up to 4 cartridges in this case) thus saving water used in cleaning the cartridges. It may also save time because the time required to wash the cartridges is reduced or substantially/completely eliminated. Example 10 illustrates the reduced water usage when a single cartridge and three cartridges razor were used by the same subject. The use of three cartridges in the example is for illustration only. Two, three, four and more cartridges razors described in this invention may also reduce the water usage. Another advantage of this invention is that each cartridge has a first blade that performs a significant hair cutting function. The razor shown in FIG. 3D has four first cutting blades. Based on our observation, typical length of the blade in the commercially available cartridge is generally found around 32-38 mm (average around 35 mm) at this time. The first blade cutting length (L1) in the inventive razor (FIG. 3D) is 35 multiplied by 4 which is equal to 140 mm. The razor described in FIG. 3D has four cartridges and is used for illustration purposes only. The inventive razor may have two or more cartridges, preferably up to 10 cartridges, even more preferably 2-10 cartridges, most preferably 2 or more cartridges per razor. Either one or both ends of the razor handle may be used to attach one or more cartridges. 1-5 cartridges may be attached to either end of the razor handle. Use of 2-5 cartridges per end is most preferred. The preferred shape of the 3 cartridges is triangular, four cartridges shape is rectangular/square and five cartridges is pentagonal. If only 2 cartridges are used on either end, the parallel arrangement (FIG. 3D) or substantially parallel arrangement between the two cartridges is preferred. The two cartridges may be separate from each other (FIG. 3D) and the distance between two cartridges (307 and 308 as an example) may be 0.1 mm to 100 mm, preferably 0.2 mm to 40 mm. If desired, the two cartridges may be connected/bridged with a flexible/elastomeric material to impart some rigidity as well as flexibility to the razor. In a three cartridge configuration, two parallel cartridges may be attached on one end and one cartridge is attached on the remaining end (FIG. 3A). The cartridges on both ends may be parallel or substantially parallel (FIG. 3A) or perpendicular or substantially perpendicular (FIG. 3B) with respect to each other. In a four cartridge configuration, two on each side is a preferred configuration. In another configuration, three cartridges on one side in a triangular shape and one on the other side is also preferred. Alternatively, four cartridges on one side preferably in a rectangular shape and none on the other side also may be used. In a five cartridge configuration, four on one side, one on the other side; three on one side and two on the other side are preferred. In six cartridge configuration, four on one side and two on the other side; three on each side is most preferred. In the inventive multi-cartridge configuration described above, each razor may have 1 to 8 blades. Two and more blades may be configured as described in FIG. 1. Preferably each cartridge may have two to seven blades, most preferably 3 to seven blades. The number of blades in each cartridge may be the same or different. The number of blades in each cartridge may be an even number or odd number. Some configurations have at least one cartridge with only one blade, designed to be used for hair trimming function or to access an area/s on the body/face that is difficult to access using the multi-blade cartridge. Preferred number of cutting blades (blade 103 as an example) per razor may vary from 6, 7, 8, 9, 10, 11, 12 up to 36. Total length of cutting blades per razor may vary from 205 mm or higher, preferably between 205 mm and 1260 mm A preferred number of cartridges, blades and other data is given in Table 1:

TABLE 1
PREFERRED CONFIGURATION OF BLADES IN THE RAZOR.

| | | TOTAL | TOTAL | | | |
|---|---|---|---|---|---|---|
| | | NUMBER | NUMBER | TOTAL | | |
| | | OF | OF FIRST | FIRST | MINIMUM | MAXIMUM |
| NUMBER OF | NUMBER OF | CUTTING | CUTTING | BLADE | LENGTH OF | LENGTH OF |
| CARTRIDGES | BLADES | BLADES | BLADES IN | CUTTING | BLADES IN | BLADES IN |
| IN THE | PER | PER | THE | LENGTH | CARTRIDGE | CARTRIDGE |
| RAZOR* | CARTRIDGE | RAZOR | RAZOR | (L1)** | (MM) | (MM) |
| 2 | 1 to 7 | 2 to 14 | 2 | 70 | 70 | 490 |
| 3 | 1 to 7 | 3 to 21 | 3 | 105 | 105 | 735 |
| 4 | 1 to 7 | 4 to 28 | 4 | 140 | 140 | 980 |
| 5 | 1 to 7 | 5 to 35 | 5 | 175 | 175 | 1225 |
| 6 | 1 to 7 | 6 to 42 | 6 | 210 | 210 | 1470 |
| 7 | 1 to 7 | 7 to 49 | 7 | 245 | 245 | 1715 |
| 8 | 1 to 7 | 8 to 56 | 8 | 280 | 280 | 1960 |

*The cartridges may be either on one end or on both ends.
**Assuming average 35 mm cutting blade length (L1).

The preferred total length of the razor including cartridge and handle may be 100 to 200 mm, even more preferably 120 to 180 mm. The preferred handle length may be 100 to 180 mm, most preferably 110 to 150 mm. The handle of the cartridge is shown as linear in most configurations. However, the handle may be non-linear with one, two or more curves/bends that help to increase length/volume and to access various contours of the facial area may also be used. The preferred handle has a texture that provides a firm hand grip during wet and soapy environments.

In the multi-cartridge razor described in this invention, cartridge arrangements wherein one cartridge does not interfere with other cartridges in accessing facial areas is preferred. Some cartridge arrangements such as T shaped or H shaped arrangements wherein one cartridge may interfere or obstruct in accessing the facial area of the skin are least preferred. FIG. 21 shows two illustrative multi-cartridge razor wherein at least one cartridge interferes or obstructs while shaving. FIG. 21A shows a sketch of a 3 cartridges (2101, 2102, 2103) razor where one cartridge interferes or obstructs while using other cartridges. Cartridge 2101 when used for shaving, is obstructed by either corner of 2102 or 2103 and prevents its full contact of blades with the face. FIG. 21B shows 4 cartridge configurations (2104, 2105, 2106 and 2107) wherein 2104 and 2106 blades cannot be used efficiently as corners of 2107 and 2105 interfere with full facial contact. Cartridge configuration shown in FIG. 21 is for illustration only. Cartridge configurations wherein at least one cartridge interferes or obstructs the use of other cartridges must be avoided or are least preferred. Non-limiting examples of illustrative configurations shown in (FIG. 3, 4, 5) wherein none of the cartridges interfere with other cartridges are most preferred.

In some embodiments, the cartridge holding arm (FIG. 3B, 310) may have a hinge that may be used to fold the cartridge to achieve a compact configuration or shape. FIG. 22 shows one illustrative multi-cartridge razor wherein at least one cartridge is able to fold or collapse during storage or use if needed. FIG. 22A shows an illustrative 2 cartridge razor with 2201 as a cartridge, 2202 as a handle and 2203 as a hinge between an arm connecting handle and cartridge. The hinge is able to provide a stable configuration in collapsed or un-collapsed configuration. FIG. 22A shows the non-collapsed form/configuration of the razor. FIG. 22B shows collapsed form/configuration of FIG. 22A wherein the hinge (2203) is used to bend the front half portion of the cartridge arm to fold and collapse on the 2202 handle. 2204 and 2205 show additional preferred areas where hinges or joints that may be added/provided on the razor to provide more control over collapsed/compact and expanded configurations. 2204 is added at the base or at the distal end of the arm. 2205 is added at the base of the cartridge or proximal end of the arm. In some embodiments, hinges may also be added in cartridge body such as 403 in FIG. 4A or 504 in FIG. 5B to provide more options to reduce bulk of the cartridge. The folding and unfolding of the handle arm enables it to reduce the size and bulk of the razor. In a typical use case, the user may keep only one arm/cartridge unfolded and the other cartridges in the razor will remain folded. If the user wants to use one cartridge during shaving, he may fold the other cartridge using a hinge and use. Hinge is used for illustration only; other methods of folding and unfolding may also be used to reduce the size/bulk of multi-cartridge razor. Methods and designs known and used in intravascular stent art also may be modified and used to design the folding and unfolding or compacted and expanded configurations of razor cartridges. The use of hinges is especially useful for cartridge arrangements or designs that interfere with each other (FIG. 21). Folding one or more cartridges that interfere may reduce or eliminate the interference. The foldable razor shown in FIG. 22 is for illustration only. Other multi-cartridge configurations with cartridges having 1 to 8 blades per cartridge per razor described in this invention also may use hinges to achieve a desired compact size. The razor shown in FIG. 22 may have two or more configurations. One configuration is a compact form (FIG. 22B) and the other configuration is an expanded form (FIG. 22A). The expanded form may have multiple configurations depending on the number of hinges, the location of the hinges and number of cartridges used. In the preferred embodiment, the razor may have at least one folded or compact configuration and at least one expanded or unfolded configuration.

In some embodiments, the cartridges used may be assembled by the user. This enables them to replace the blunted blades, preferably the first blade with the new blade. Alternatively, the user may also sharpen the blunted blade and reuse it. FIG. 2 shows a partial schematic representation of a shaving razor wherein the cartridge of the razor is assembled by the user before use. The blades may be removed, cleaned and optionally sharpened, reassembled in a cartridge and reused. FIG. 2A shows razor with removable cartridge (201) and handle (202). FIG. 2B shows an exploded view of razor FIG. 2A wherein each component of the razor is identified and labeled. Lubricant strip (203), top blade seat (204), three blade assembly (205), handle/cartridge body (206) and knurled nut (207) are used to assemble cartridges which are then attached to the handle. The blades 208, 209 and 210 and blade seat 211 and 212 are assembled (FIG. 2D) together to make a blade assembly (FIG. 2C, 205). Three blade assembly used in FIGS. 2C and 2D is for illustration only. It is understood that the two to 8 blades cartridge may be assembled using the modified version of the method and components as described above. The preferred angle of the razor when it touches the skin is around 10 to 50 degree, preferably 20 to 40 degree and most preferably 25 to 35 degree. In another embodiment, a commercial razor blade is used to assemble a razor with 4 blades with two on each side.

FIG. 17 shows a partial schematic representation of a wet shaving razor wherein the razor and blades are assembled by the user prior to use. FIG. 17A has a razor handle (1701) and shaving cartridge (1702) with 2 cutting blades (1703) on each side. FIG. 17B shows an exploded view of A showing different parts of the razor. 1701 is a razor handle with a hole on one end (1704) that is used to secure the blade assembly via a screw 1705. 1706 is a base plate on which a standard shaving blade (broken into two equal parts, 1703B) is placed. 1707 is a spacer plate between two blades that helps to maintain a desired gap and angle between the blades and may have microfluidic channels. 1703A is the second blade that is added on top of the spacer plate without breaking. Finally, the top plate 1702 with screw 1705 is applied on the 1703A blade. The top plate 1702 could be hollow with the ability to store and dispense liquids such as lubricant solution. The stored fluid may be delivered via spacer plate (1707) with microchannels that are fluidically connected with the storage chamber. The screw passes through all the layers in the assembly and is inserted in the 1704 hole and tightened. The reverse of this operation is used to dismantle the razor and blades. FIG. 17C shows a process by which a regular blade (1701) is converted to a blade with a microblade array (1707-3). Regular blade (1707) is used to stamp out about 1 mm semicircular sections (1707-2). The semicircular blade sections (1707-2) are then adhesively bonded on a new 1707 blade as an array to make a razor blade with a microblade array (1707-3). The new blade (1707-3) is used to make a razor as shown in FIG. 17A and FIG. 17B. The advantage of this design is that the blunt blade (typically 1703B) may be replaced with a new blade. This enables a more efficient way using shaving cartridge blades. In the preferred embodiment, the razor handle, cartridge body and other non-cutting parts of the razor holding parts may be made using biodegradable polymers such as polylactide, polycaprolactone and the like.

FIG. 4 shows a partial schematic representation of a shaving razor wherein the razor has two or more cartridges that are connected with each other via a solid body that provides a desirable angle and flexibility during shaving. FIG. 4A shows sketch of the razor with 2 cartridges (401, 402). The cartridges 401 and 402 are connected via solid body 403. Preferably 401 and 402 are parallel or substantially parallel to each other. FIG. 4B is similar to FIG. 4A except the cartridges 401 and 402A attached to the razor body 403 have a different number of blades (3 blades in 401 and 1 blade in 402A). FIG. 4C shows an exploded view of the razor shown in FIG. 4A wherein cartridges 401 and 402 are attached to the razor body via attachment point (407) on the solid body (403) and 405 on the cartridge. The razor handle 404 is attached to the solid body via a screw (406). The width of solid (403) between the cartridges may be small (2-5 mm), medium (6-15 mm) and large (16-50 mm). FIG. 23C and FIG. 23D shows the angle (2302) of cartridge blade/s plane with respect to razor handle axis. FIG. 23C shows a relatively wide angle around 55 degree and D shows a relatively narrow angle around 35 degree. The preferred angle 2302 wherein blade/s plane is parallel or substantially parallel to the razor handle axis. The preferred angle 2302 is 5 degree to 70 degree, most preferred angle is 10 to 60 degree. The solid body (403) is shaped in such a way that the blades of the cartridges touch the facial skin at an angle around 20 to 40 degree preferably around 30 degree. In the preferred configuration, the 403 is curved on both sides which enables desirable angle for the cartridges. The 403 body, (preferably middle top portion) may have curved shape or may be bent (FIG. 4A) which may help to achieve a desirable angle for cartridges during shaving. The 403 body may be solid or hollow with a capacity to store fluids/liquid/gels. If hollow, it may be used to store and dispense shaving aids such as lubricant or aftershave lotions. 408 shows a refill port and 409 shows a flow control knob which may be used to turn the liquid/fluid flow on or off. Gravity assisted flow from the 403 to the cartridge is preferred. Because 403 has a higher elevation than the cartridge, the fluids stored in 403 may flow to the cartridge under gravity force. The elevation of 403 relative to cartridge is adjusted in the cartridge configuration such that a sufficient flow is obtained during shaving. In one illustrative embodiment, the cavity in the 403 body is fluidically connected to the cartridge via 409 valve so that the user may push a button on the 403 body (409) and may release a small amount of lubricant (preferably 10 to 500 microliter of lubricant per push or per minute) around the cutting edge of the blade. The fluid may be dispensed via 1, or 2, 3, 4, 5, 6, 7, 8, 9, 10 or more multiple microfluidic channels or outlets for better distribution. The 403 storage may be fluidically connected to microchannels on blade, spacer between blades or to the lubricant strip. Lubricant deposition before the first blade cutting or around the first blade is preferred.

FIG. 5 shows a partial schematic representation of a wet shaving razor wherein the razor has three cartridges on one end of the razor. FIG. 5A shows three connected cartridges that provide a desired angle and flexibility during shaving. FIG. 5C shows a razor with 3 cartridges that are not directly connected with each other or are independent of each other or combination thereof in any proportion. In both A and C, a triangular arrangement of cartridges is preferred. FIG. 5B shows an exploded view of FIG. 5A wherein 3 cartridges (501, 502, 503) are connected to the cartridge solid body 504 via attachment site on the cartridge (505) and the solid body (506). The 504 body may be solid or hollow with an internal chamber to store shaving aids that may be fluidically connected to the cartridge. The handle (507) is connected to the body 504 via nut (508) and bolt (509) arrangement. Nut and bolt arrangement used herein is for illustration only and other attachment mechanisms known in the mechanical engineering art may also be used. FIG. 5C shows three razor configurations wherein all the razors are not connected and are in a triangular arrangement. FIG. 5D shows an exploded view of C wherein cartridges (510, 511 and 512) are attached to the razor handle 514 via attachment point 513. FIG. 5E shows six cartridges razor similar to shown in FIG. 5C wherein three cartridges are present on both ends of the razor handle. The razor wherein the cartridges are not connected with each other (FIG. 5C) is preferred. The gap between each cartridge may be 0.1 mm to 20 mm, preferably 0.5 mm to 10 mm. Maximum and minimum number of blades in this configuration range from 3 to 42 (7 blades per cartridge and total of 6 cartridges). The number of first cutting blades ranges from 3 to 6. The handle of the razor in many embodiments is textured which enables better grip during the shaving process. The texture is added during processing such as injection molding or 3D printing operation. Alternatively, texture may be added as a polymeric or other type of material coating after the handle has been made.

FIG. 10 shows a partial schematic representation of a wet shaving razor wherein the razor has four shaving cartridges arranged in a rectangular (square) shape. FIG. 10A shows sketch of a razor with four shaving cartridges (1001), a removable razor handle (1002). FIG. 10B shows another view of the razor shown in FIG. 10A wherein the handle 1002 is connected to the cartridge holding body (1003). C shows an exploded view of the razor shown in FIG. 10B wherein four cartridges (1001) are attached to the cartridge holding body (1003) via attachment point 1004. The cartridge holding body is attached to the razor handle by using a screw (1005). The 1003 body may be solid or hollow with a chamber that may store and dispense shaving aids. Eight cartridges (four on the distal and four on the proximal end of the handle) may be attached in this configuration. The number of first cutting blades in the razor range from 4 to 8. FIG. 10D is another 4 cartridges configuration wherein 4 cartridges are arranged in a rectangular configuration. The cartridges in FIG. 10D are not directly connected with each other except at the common joint with the razor handle. FIG. 10E shows an exploded view of the FIG. 10D wherein 4 cartridges (1007) are attached to the razor handle 1008 via attachment point 1009.

The functionality of the one or multi-cartridge razor disclosed in this invention is enhanced by storing and dispensing shaving aids include but not limited to: shave lotion, hair oil, shaving lubricant, shaving fluids/gels/creams/lotions/foams and the like stored in the handle or in the space between the cartridges. FIG. 12 shows a partial schematic representation of a wet shaving razor wherein the razor has two or more shaving cartridges on one end and with the capability to store and dispense shaving aids (liquids/gels) in the handle. FIG. 12A shows sketch of a razor with two shaving cartridges (1201), the handle (1202) with a chamber/void/cavity/compartment in the body of the handle and a removable cap (1203). FIG. 12B shows an exploded view of the FIG. 12A wherein different parts of the razor are identified and labeled. FIG. 12C shows a sectional view of FIG. 12B wherein the storage cavity (1204) inside the handle and other parts are shown. 1201 shows a removable shaving cartridge with 1 or more cutting blades. 1205 shows the slot/site where the cartridge is attached to the razor. The attachment is such that it provides a firm and flexible connection with the razor body during shaving without dislodging but also may be easily removed if desired. 1202 is the main handle body that is hollow with outer wall thickness (T1202). The proximal end of 1202 has two or more shaving cartridges and the distal end has one dispensing port (1207) and one refill port (1206) and both ports may be capped using 1208 and 1203 caps. 1203 cap has internal thread 1203A and distal end of handle has internal threads 1210A which may be used in attaching caps via external threads (1209 and 1210). Port 1207 is fluidically connected to the 1204 storage chamber. The handle has two caps at the distal end (1208 and 1203). Removing the outer cap (1203) exposes the shaving aid dispensing port (1207) from which the shaving aid is dispensed. The dispensing port may also be removed (unscrewed) to open up the refill port (1206) which may be used to refill the shaving aid. The shaving aid is preferably dispensed via 1207 port using gravity, manual shaking or squeezing the handle body 1202. If hand squeezing is used, it is preferred that the squeezing action and subsequent non-squeezing action on the razor handle provides an elastic response. The shape and size of the handle is completely (greater than 95 percent, preferably greater than 99 percent shape recovery) recovered (no plastic deformation) after squeezing and subsequent non-squeezing action. The handle material is chosen to have this elastic recovery property. In one illustrative example, an 3D-printable elastomeric material is used to make the razor handle and the shape of the handle is completely recovered upon hand squeezing. Many elastic or semi-elastic materials, preferably polymeric materials known in the art can be used for making razor handles. The screwing mechanism used to access the ports is for illustration only, other methods known in the mechanical engineering art may also be used without limitation.

The viscosity of the shaving aid stored in the handle may range from 2 to 90000 centipoise. The preferred shaving composition stored in the chamber is shaving gel/cream/lotion or aftershave lotion/cream/gel. FIG. 6 shows a partial schematic representation of a wet shaving razor wherein the razor has one or three shaving cartridges and the capability to store and dispense liquids/gels in the handle. FIG. 6A shows sketch a razor with one shaving cartridge (601), a handle (607) with a chamber/cavity (602) inside the body of the handle and a removable cap (603). FIG. 6B shows an exploded view of the FIG. 6A wherein different parts of the razor are identified and labeled. 601 shows a removable shaving cartridge with one or more cutting blades. 607 shows the main handle body that is hollow with outer wall thickness (T607). The cavity (602) inside the 607 is used for fluid storage with openings on the distal end (609) and the proximal end (608). The distal end of the 607 body may be capped using a cap (603) and threads (610) on the distal end. The proximal end opening (608) is used to refill the stored liquid in the 607 body. In the preferred embodiment, the refill port has a larger diameter than the dispensing port. Most preferably, the refill port has an average diameter greater than 2 mm than the dispensing port diameter. 604 connects the cartridge and 607 body via threads (606) on the distal end of 604. The proximal end of 604 is connected to the cartridge via the 605 attachment point. FIG. 6C a razor that is similar to FIG. 6A but with three cartridges. FIG. 6D shows an exploded view of C wherein three cartridges (611, 612 and 613) are connected to the main body 615 via three attachment points (614). 615 is used for fluid storage and disposal. The remaining parts of FIG. 6D storage and dispensing of fluids/liquids/gels are similar to as described in FIG. 6B. FIG. 7 shows a partial schematic representation of a wet shaving razor with multiple cartridges and capability to store and dispense at least two liquids/gels in the handle. FIG. 7 shows a schematic/sketch of a razor with three shaving cartridges (701), the handle with a dual chamber/cavity (702), a removable cap (703) and a body connecting three cartridges to the main body (704). FIG. 7B shows an exploded view of FIG. 7A wherein different parts of the razor are identified and labeled. 701 shows removable three shaving cartridges with 1 or more cutting blades. 702 shows the main handle body that is hollow with outer wall thickness (T702) and with two independent chambers 706 and 707 with the wall (708) between the chambers. The wall 708 with a thickness (T708) is parallel to the long axis of the handle 702. Wall 708 prevents fluidic communication between liquids stored in 706 and 707 chambers. The 704 body connects to the main handle body via threads (709) and to the three cartridges via attachment point 705. FIG. 7C shows the exploded view of the handle 702 and FIG. 7D shows a sectional view of the same body. The two chambers/cavities (706 and 707) inside the 702 body are used for the storage of two separate fluids with openings on the distal end (718 and 719) that are used for fluid dispensing. Both fluid dispensing nozzles may be capped by two caps 715 and 716 using threads on fluid dispensing parts. The proximal end of the 702 body is capped using a cap (712) that fits both the chambers. The proximal end opening on the 702 handle is used to refill the stored liquid in respective chambers. Alternatively, both liquids may be dispensed using a single but divided nozzle wherein each chamber is fluidically connected to a portion of the divided nozzle (not shown). Both fluid dispensing nozzles may be capped by two caps 715 and 716 using threads (713 and 714) on fluid dispensing parts. The proximal end of the 702 body may be capped using a cap (712) that fits on both the chambers and is capable of prohibiting fluid leakage. The proximal end opening (706 and 707) are used to refill the stored liquid in respective chambers. The cap 703 is attached to the 702 body via threads on the distal end of 702 (717). FIG. 8 shows a partial schematic representation of a wet shaving razor wherein the razor has shaving cartridges and with the capability to store and dispense two liquids/gels in the handle. The razor is similar to described in FIG. 7 except the arrangement of two chambers in the handle is different. FIG. 8A shows a sketch of razor with three shaving cartridges (801) and its handle with a dual chamber space (802). FIG. 8B shows an exploded view of the FIG. 8A wherein different parts of the razor are identified and labeled. FIG. 8B shows removable three shaving cartridges (801) with 1 or more cutting blades. 805 shows the section of the razor that connects handle (802) and cartridges (801) via cartridge attachment sites (804) on the proximal end and 806 threads on the distal end. 805 is also used as a cap for 802 body which may be attached using threads 806. The 802 body shows a fluid dispensing port (807) for the top chamber (818). FIG. 8C shows the exploded view of the handle body 802 and FIG. 8D shows the vertical sectional view of the FIG. 8C. 817 and 818 show the two chambers in the razor handle that are separated by a wall (819) which prevents fluidic communication between liquids in each chamber. 806 on the proximal end and 811 on the distal end show openings on the storage chambers that may be used for filling the chambers with fluids/liquids/gels. 810 and 806 show threads on the distal end and proximal end of each chamber which may be capped using 812 and 808 caps respectively. The caps 812 and 808 have threads (813 and 809) that are used for attachment to the razor handle body and they also have dispensing ports 807 and 814 for dispensing liquids from top and bottom chambers respectively. The razor handle caps 805 and 803 are removed to expose dispensing ports 807 and 814. The handle (802) is squeezed or gravity is used to dispense liquids stored in chambers 818 and 817. The two chambers design shown in FIGS. 7 and 8 may store two independent liquids without mixing. This enables it to store shaving gel, aftershave and other shaving aid compositions whose components/ingredients are incompatible (chemical or physical instability if stored together). In some embodiments, the two compositions may be dispensed from the dispensing port, mixed in situ and used as a cosmetic. The volume of each chamber in the handle may vary from 1 ml to 100 ml with the total volume of both chambers is around 100 ml or less. If desired, the combination of designs shown in FIGS. 7 and 8 may be used to make a 4 independent chamber handle (dividing the chamber along both axes).

This invention also discloses a razor with two or more cartridges with liquid storage capacity in the handle and a shaving brush attached on the distal end of the razor. FIG. 9 shows a partial schematic representation of a wet shaving razor wherein the razor has multiple shaving cartridges on one end and a shaving brush at the other end; optionally the razor also has a capacity to hold and dispense liquid stored in the handle. FIG. 9A shows sketch of a razor with three shaving cartridges (901), a removable body 902 that connects the razor handle (903) with cartridges and a shaving brush with cap (904 cap and 905 brush) at the distal end. FIG. 9B shows an exploded view of the FIG. 9A wherein different parts of the razor are identified and labeled. FIG. 9B shows removable three shaving cartridges (901) with 1 or more cutting blades. 902 shows the section of the razor that connects the handle (903) and cartridges (901) via attachment point (906). 902 also has an internal thread on the distal end that connects with the 903 body and it also acts as a cap for the 903 part which may be attached using threads (908). The 903 body has several parts wherein 909 is a storage container with terminal openings which is connected to the 902 body on the proximal end and shaving brush (905) on the distal end via threads on both ends (908 and 910). The 909 is a hollow body that may be used for the storage of fluids/liquid/gels. The stored liquid may be dispensed via opening via port 915 on the 910 body that is fluidically connected with the 909 internal cavity. The brush body (911) is connected at the distal end of 909 body using 910 threads. The terminal end of the razor is fitted with the shaving brush with bristles 905 and a protective cap (904) that is preferably transparent. Optionally the fluid from the 909 body may be dispensed at the bottom of the brush via a fluidic connection between the 909 body cavity and brush bottom surface with an opening. The brush is removed from the device by manually rotating and unscrewing the 911 cap and removing the 904 cap and then used for shaving. The shaving gel composition stored in the 909 handle is dispensed on the bristles of the brush via 915 port and is then applied to the face to make foam. One or more cartridges are used to complete the shave preferably without washing the cartridge. At the end of the complete shave, the cartridge/s and brush are washed and reassembled as shown in FIG. 9A and stored until future use.

In some embodiments, a simple dispensing mechanism is provided to dispense the shaving aid compositions stored in the handle. FIG. 11 shows a partial schematic representation of a wet shaving razor wherein the razor has multiple shaving cartridges and with the capability to store and dispense liquid stored in the handle. FIG. 11A shows sketch of a razor with two shaving cartridges (1101) and its handle with a chamber (1102) for fluid/gel storage and bridging part (1103) connecting 1101 and 1102. FIG. 11B shows an exploded view of the FIG. 11A wherein different parts of the razor are identified and labeled. FIG. 11B shows removable two shaving cartridges (1101) with 1 or more cutting blades. Cap (1104) on 1103 connects 1103 to 1102 via 1105 threads. Section of the razor that connects handle (1102) via threads to 1104 cap and threads on 1102 (1105). 1106 is a part of a dispensing mechanism which upon pressing one or more times, dispenses liquid stored in the 1102 hollow chamber via port 1107. FIG. 11C shows a sectional view of the A wherein the chamber (1116) is used for storing fluid to be dispensed. FIG. 11D shows the fluid dispenser used for dispensing fluids stored in the 1116 chamber. FIG. 11E shows an view of the dispensing part of the device. Tube 1108 is immersed in a liquid stored in chamber 1116. The tube is connected to the housing (1109) which houses part of 1108 tubing and bearing (1111) and spring (1112). 1113, 1114 and 1115 are part of the dispensing mechanism attached to the spring and tube via threads (1110). The surface of 1115 (1116) is pressed which compresses the spring which in turn pushes the liquid via tube and dispensed via port (1107). In using this device in a preferred mode, the user will unscrew and remove the cap (1104) which will show/expose the dispensing part of the device. The user will manually push the 1106 surface one or more times to dispense shaving aid composition stored in the 1102 bottle. Upon dispensing the composition, the user will reattach the cap and its cartridges and perform shaving using the two cartridges attached.

FIG. 23 shows a partial schematic representation of a wet shaving razor wherein the razor has multiple shaving cartridges and a protective cap. FIG. 23A shows a schematic of a razor with two three blade cartridges with a removable protective cap (2301). The cap covers both the cartridges. Razor 23B is the same as A except its cap (2301) is removed. The protective cap used herein for illustrative use only. Single cap for two cartridge designs such as shown in FIG. 23 is preferred. The cap used is preferably removable and reusable until the razor blades become blunt and become unusable.

In another embodiment, the handle of a shaving razor is used as storage space for additional cartridges. The design enables it to replace a new cartridge conveniently because of its close proximity to the replacement cartridge. FIG. 24 shows a partial schematic representation of a wet shaving razor wherein the razor has capability to store one or more shaving cartridges in the handle or in the space between cartridges. FIG. 24A shows sketch of a razor with two shaving cartridges (2401) that are used for shaving, a removable body 2402 that connects with the razor handle (2403) with additional shaving cartridges 2404-1 and 2404-2. The 2403 is preferably transparent or semi-transparent with volume and shape that may accommodate one or more shaving cartridges such as 2404-1 and 2404-2. 2404-1 and 2404-2 show two storage cartridges that are fitted inside the 2403 body cavity. 2405 is a removable cap that may be attached to the 2403 body via threads (2406). FIG. 24B shows an exploded view of A showing removable shaving cartridges 2401, handle 2403, two storage cartridges (2404-1 and 2404-2) that may be used in place of 2401 and may be stored inside 2403 body cavity. The stored cartridges may be locked inside the razor using the removable cap 2405. The stored cartridges may be removed by unscrewing the cap and removing the stored cartridge/s using them in place of 2401 cartridge. In the preferred mode, the handle may store one or more cartridges, preferably up to 8 cartridges, even more preferably up to 4 cartridges. 1 to 4 cartridges, preferably 2 to 4 cartridges stored in the handle are most preferred. Preferably the cartridges are stored with a blade protective cap. In the illustrative embodiment, the cartridges are loaded, stored and removed in the handle via a port with a removable cap on the distal end of the handle. Alternatively, the storage compartment may be opened and closed along the direction that is parallel to the axis of the handle. A rubber like spacer may be used between the cartridges to prevent movement of the cartridges while shaving or during transportation. In another aspect, the handle material used is transparent or semitransparent. The transparency visually indicates the presence of cartridges in the handle. In the typical use case scenario, the user discards the used cartridge/s, opens the storage compartment, removes new cartridges from the handle and attaches to the place of discarded cartridges. In another variation of above design, the cartridge storage space between the two cartridges of the razor is used to store spare cartridges. FIG. 24C shows a shaving razor with cartridges storage space in the head section of the razor. The space between the two shaving cartridges of the razor (2411 and 2412) is used for storage of spare cartridges. FIG. 24D shows exploded view of FIG. 24C. 2407 is a hollow storage body between the razor blades 2411 and 2412. 2408 is a removable cap on the 2407 body. The 2407 body is hollow with desired wall thickness and has a storage space (2409) that is sufficient for storage of one or two shaving cartridges (2410-1 and 2410-2). In the preferred embodiment, storage of one or two or more spare cartridges preferably with protective cap in the 2407 body is preferred. Additional cartridges preferably 1-4 (total up to 6) may also be stored provided storage 2409 is expanded and is large enough to accommodate additional cartridges. Some areas of the 2407 storage body (up to 10 to 90 percent) may be partially or completely transparent. The transparency helps to see the stored cartridges with the aided or unaided human eye. In FIG. 24C, the two cartridge design is used for illustration only. Other designs with 1 or more cartridges described in this invention may also be used to store spare cartridges. Preferably the spare cartridges used may have one to 7 blades. In another illustrative embodiment, spare cartridges are added in the head portion of the razor. FIG. 29B shows sketch of a razor head with 4 shaving cartridges with room for two spare cartridges. 2902 shows a head section of the razor and 2903 show attachment point of head section to razor handle. The head section has two terminal shaving cartridges (2404) that (one or two) may be used for normal shaving and remaining two spare shaving spare cartridges (2905) between terminal cartridges (2904). The arrangement of 2904 and 2905 is such that 2905 will not interfere/obstruct while shaving using 2904 cartridges. 2906 is an attachment point for removable cartridges to the razor head 2902. The height and angle of 2905 and 2904 is such that it will not interfere in normal shaving operation. The attachment 2906 is such that spare cartridges are easily removed from the 2905 branch and attached to the 2904 part. FIG. 29B shows only 4 cartridges but it is understood it can be modified to fit with 1-8, preferably 1-4 cartridges. Preferably spare cartridges (attached to 2905) have a removable protective cover. In the normal usage, the user will discard terminal cartridge/s and replace those with spare cartridge/s.

In another embodiment, a space between the cartridges and/or in the handle is used to store one or more cosmetic compositions such as shaving cream or gel, aftershave lotion or hair oil and the like. FIG. 25 shows a partial schematic representation of a wet shaving razor wherein the razor has capability to store and dispense two or more fluids/liquid compositions. FIG. 25A shows a sketch of a razor with three shaving cartridges and has capability to store and/or dispense two or more cosmetic compositions. FIG. 25B shows an exploded view of FIG. 25A wherein major parts of FIG. 25A are depicted. FIG. 25B has three main sections. The top portion comprises three cartridge head (2501) that may be attached to the handle (2502) and cap (2503). The head portion 2501 has three cartridges (2504) and the space in between the cartridges is occupied by a hollow chamber (2505-1) with space/volume for storage of cosmetic composition. The 2505-1 is fluidically connected to a dispensing port 2506 and a removable cap 2507. The handle 2502 may be a hollow body with space 2502-2 that may be occupied by a cosmetic composition. FIG. 25A1 shows a sectional view of FIG. 25A which shows a hollow storage space in the razor head (2505-1) and handle (2502-2). Shaving cream and aftershave lotion are the most commonly used cosmetic compositions during wet shaving usage. It will be highly desirable if a wet shave razor is designed with the ability to store and dispense these two compositions. In one illustrative embodiment, the space between two or more cartridges, preferably between 2-6 and most preferably between 2-3 cartridges is used to store and dispense a desired cosmetic composition such as aftershave lotion or hair oil/lubricant. The space in the razor handle is used to store other cosmetic compositions such as shaving gel or cream. FIG. 25A shows an illustrative razor wherein a space between 3 cartridges is hollow (2505-1) and is filled using a cosmetic composition such as after shaving lotion. The space in the handle (2502-2) also may be used to store and dispense a cosmetic composition such as shaving cream. Both the storage spaces have ports and removable caps of desired size to dispense cosmetic composition. The non-limiting volume of 2505-1 and 2502-2 may vary from 1 to 50 ml, preferably between 2 to 20 ml and most preferably between 3 to 15 ml. The preferred composition stored in 2505-1 space is after shave lotion or hair oil or lubricant and the preferred composition stored in the 2502-2 space is shaving cream, foam or gel or after shave lotion.

In another embodiment, this invention discloses wet shaving razor with ability to store and dispense shaving lubricant which is believed to improve the shaving experience. In commercial products, a lubricant strip that is loaded with shaving lubricant is added on top of the razor blades. The strip has a very small amount of storage space and may run out of lubricant after using it multiple times. In this invention, the space between two cartridges is used to store and dispense shaving lubricant. FIG. 26 shows a partial schematic representation of a wet shaving razor wherein the razor has capability to dispense lubricant during wet shaving. FIG. 26A shows a sketch a razor with two shaving cartridges and space between the cartridges is used to store a shaving lubricant that is delivered to the lubricant strip on the cartridges via gravitational force. FIG. 26A shows the sketch the razor of wherein has two main parts comprising the head portion (2601) that comprises two cartridges and the handle (2602). The head portion comprises two cartridges (2603) with lubricant strip (2604). The lubricant strip preferably has microfluidic channels (2604-1) that assist in distribution of the lubricant. The space between the cartridges is occupied by a hollow body (2605) that may store and dispense liquids such as shaving lubricant. The hollow body (2605) also has a port with a removable cap (2606) that may be used for refilling the liquid or lubricant if desired. FIG. 26A1 shows a sectional view of head part (2601) that shows three holes (2607) that are fluidically connected to the lubricant storage container and deliver the lubricant to the lubricant strip (2604) preferably via gravity assisted mechanism. The stored lubricant in the headspace of the razor is fluidically connected to the dispensing ports 2607 which is in close contact with the lubricant strip (2604). Preferably, the lubricant strip has microfluidic channels of desirable size and pattern to distribute the lubricant The stored illustrative lubricant such as 0.1 to 1 percent hyaluronic acid salt/derivative such as sodium hyaluronic acid in buffered aqueous solution is stored in the 2605 space and is then dispensed via 2607 holes/channels on top of the lubricant strip. The dispensed lubricant is then preferably distributed via microfluidic channels in the strip to the skin during wet shaving. The flow of the lubricant is preferably controlled by a mechanical valve (on the 2605 body, not shown) that may control the flow rate of the lubricant. The mechanical, electrical or other type of valve also acts as a switch that may turn on and off the lubricant flow to the lubricant strip. This switch enables the availability of lubricant during shaving only and not otherwise. In another modification of the above concept, the lubricant is delivered at the bottom of the shaving cartridge/s. FIG. 27 shows a partial schematic representation of a wet shaving razor wherein the razor has capability to dispense lubricant at the bottom portion of cartridge during wet shaving. FIG. 27A shows sketch of a razor with two shaving cartridges and space between the cartridges that is used to store a shaving lubricant. The stored lubricant is delivered to the lubricant strip at the bottom of cartridges via gravitational force and through the fluidically connected tubes (2706). The razor in FIG. 27A has two main parts comprising the head portion (2701 and the handle (2702). The head portion comprises two cartridges (2703). The space between the cartridges is occupied by a hollow body (2704) that may store and dispense liquids such as lubricant. The hollow body (2704) also has a port with a removable cap (2705) that may be used for refilling the liquid or lubricant if desired. FIG. 27B shows sketch of the head portion without cartridges. The empty space without the cartridge (2708) is connected by a tube (2706) that carries the lubricant from the lubricant storage part to the bottom portion of the tube (2706). The bottom portion of the tube is perforated so that the lubricants may come out of the perforated holes and deliver to the lubricant strip (2707). Preferably the lubricant strip has microfluidic channels which help to distribute the lubricant to the skin surface. FIG. 27B1 shows a sectional view of part in FIG. 27B wherein the section is taken parallel to the handle. The 2704-1 shows the storage space for the lubricant inside 2704. FIG. 27B2 shows another sectional view of part B parallel to the handle. It shows the 2706 tubes on both sides. This design enables it to carry the stored lubricant stored in 2704-1 space to the lubricant strip 2707 via hollow tubes/pipes (2706). The delivery and application of the lubricant before the shaving may offer a better shaving experience.

This invention also discloses a razor blade fitted with an array of microblades for a better shaving experience. In the preferred embodiment, the surface of the conventional blade used in the 1-7 blade cartridge is filled with an array of 3 or more blades, preferably several blades that cut the hair. The microblade array is attached on the entire surface of the razor blade or attached to some part of the surface covering 1 to 99 percent of the blade surface, preferably 5 to 90 percent of the blade surface. FIG. 13 shows a partial schematic representation of wet shaving razor surface wherein the several mini or micro cutting blades/elements are arranged to make an array of shaving blades referred to as microblade array. The use of microblades result in increased cutting length of the razor blade while using the same length/area of a blade. FIG. 13A shows an illustrative micro cutting element (1301) that is repeated several times on the cutting surface of the razor device. In this specific non-limiting example, micro cutting elements or microblades have three cutting lengths (1302) which are used in cutting the skin hair. By design, cutting elements 1301 are arranged such that several cutting elements may cut the facial hair simultaneously. The gap (1303) between cutting elements (1301) and within the cutting elements (1304) helps to carry the cut hair and shaving foam components to the edges of a razor blade. FIG. 13B shows a hexagonal cutting element pattern where each side of the hexagon has cutting edges. FIG. 13C shows a triangular shaped cutting element wherein each side of the triangle has a cutting edge and space between the triangular cutting element is designed to move cut hair and wet shaving gel/cream away from the blade surface. The gap between micro blades (1303) is preferably slightly greater than the average human hair diameter (about 100 microns). The gap 1303 may range from 10 microns to 5 mm, preferably from 100 microns to 4 mm and even more preferably from 110 microns to 3 mm. Due to the presence of multiple cutting elements and cutting surfaces, some hairs are cut by two cutting elements simultaneously which increases cutting efficiency. The average size/length/diameter of a microblade is preferably 10 microns to 5 mm, 20 microns to 3 mm, even more preferably 110 micron to 2 mm. The total number of micro cutting blades per unit area of the blade may range from 2 per square centimeter to 5000, preferably 3 to 4000 and even more preferably 5 to 3000. The cutting blades occupy 100 percent of the blade surface or may occupy 0.1 to 99.9 percent of the blade surface, preferably 1 to 99 percent of the blade surface. Three or more micro cutting blades are arranged to make a micro blade array. The arrangement of micro blades in the array is symmetric or non-symmetric or random. Symmetric arrangement is preferred. The microblade arrangement that repeats 2 or more times is also preferred. The two and three dimensional shape of the microblade is symmetric or not symmetric. Preferred shapes of microblades in the array may include but not limited to: circular, semicircular, triangular, rectangular, pentagonal, hexagonal, heptagonal, octagonal, diamond, straight line and the like and combination in any proportion. FIG. 18 shows a partial schematic representation of a wet shaving razor with micro cutting blades made just above the cutting edge of the razor blade. FIG. 18A shows sketch of a razor blade with 1801 as its top surface/body. The 1802 shows the cutting edge of the blade with micro cutting blades just above the standard cutting edge of the razor blade. FIG. 18B shows an amplified view of some portion of the 1801 surface (FIG. 18AB1). 1803 shows the normal cutting edge of the razor. FIG. 18B also shows an array of equilateral triangle shaped microblades that are arranged in a symmetrical pattern. 1804 is a triangular shaped cutting element with the edge (1805) and gap between the cutting element (1806). The edges of the micro blades are sufficiently sharp and have the capability to cut the hair during normal shaving operation. FIG. 18C shows a razor cartridge made using the cutting blade shown in FIG. 18A with cartridge holding body 1807. At least one of the blades, preferably the first blade in the cartridge has a microblade array (1802). FIG. 18D shows a razor blade with the hexagonal shaped microblade array. FIG. 18De shows expanded view of one area of the blade FIG. 18D. FIG. 18E shows blade with semicircular cutting blade array and FIG. 18Ee shows expanded view of one area of the blade FIG. 18E. In one illustrative embodiment, several standard razor shaving blades are used to cut/stamped out semicircular microelements which are then used to make a blade with microblade array. FIG. 17C shows a process wherein a regular blade (1707) is used to make a blade with a microblade array (1707-3). Regular blade (1707) is used to stamp out about 1 mm semicircular sections (1707-2). The semicircular blade sections (1707-2) are then adhesively bonded on a new 1707 blade as an array to make a razor blade with a microblade array (1707-3). The new blade (1707-3) is used to make a razor as shown in FIGS. 17A and B. FIG. 15 shows a partial schematic representation of one of the methods for making a microblade array. 1502 shows a metal surface wherein the metal is generally used for conventional shaving blade manufacturing. 1502 shows the planar surface is coated with a photoresist preferably using spin coating method. The surface is then covered with a photomask (1503) which has the desired pattern of microblades wherein the light may only pass through in areas where cutting elements are not present. The photoresist is exposed to UV light to duplicate the pattern in the 1502 surface. The unexposed area of the resist is removed by using a developer solution provided by the photoresist manufacturer. The exposed metal surface produced by the removal of photoresist is removed by a controlled chemical etching process which affects only the area of the exposed metal surface. After the etching process, the photomask material is removed using a separate solution provided by the photoresist manufacturer. These steps may be repeated to produce more complex microblade patterns. The microarray of cutting elements thus produced (1506) is further polished with additional etching/polishing processes. Finally, the products and other blades are encapsulated in a plastic enclosure that converts them to a razor cartridge. Alternatively, the microblade array is produced by a UV or infrared laser based carving tool used on the martensitic stainless chromium steel sheet. The desired pattern is programmed in the laser engraving tool and the laser beam is scanned to engrave a microblade array. Variables like laser diameter, laser power, laser residence time, laser light wavelength, laser frequency (femtosecond to nanosecond pulsed laser) and the like are varied to create the desired array. UV, visible light and infrared light lasers are preferred. The total laser power used may range from a few hundred milliwatts to several Watts. The laser-engraved pattern surface may be further treated with metal etching solutions to remove burrs and other imperfections introduced during the laser engraving process. CNC-based tools also may be used to make the desired pattern but this tool is preferred for 0.5 mm or larger patterns. The microblade array elements preferably with sizes larger than 0.5 mm may also be made separately, arranged in a desired pattern and then adhesively bonded, welded/soldered, or mechanically fastened and the like or combinations thereof in any proportion to make a microblade array. Alternatively, the entire blade also may be made using newly developed metal based 3D printing techniques wherein fine metal powder particles (few nanometers to micron-size metal particles) are fused using a laser to make a blade with desired micropattern. Newer metal manufacturing methods wherein metals are deposited via vapor or plasma or electrochemically deposited from salt solutions may also be used to make microblade array. Metal-based materials are preferred but other materials such as ceramics, glass or composites of materials with plastics may also be used. Metal and metal alloys that are hard and tough such as martensitic stainless chromium steel are most preferred.

Typical shaving blades in the commercially available shaving cartridges have a straight cutting edge. The cutting length of the razor blade is an important variable for achieving a better shave and shaving experience. In this invention, the cutting edge shape of the blade is modified so that the overall length of the cutting edge is increased while keeping the same length of the blade/cartridge. FIG. 14 shows a partial schematic representation of the shaving razor cutting blade shape designed to increase the overall cutting length of the shaving blade. FIG. 14A shows a semicircular pattern of cutting edge blade. FIG. 14B shows a combination of triangular and straight edge cutting elements. FIG. 14C and FIG. 14G show a combination of non-straight edge and straight edge cutting blade patterns. FIG. 14C1 shows a combination of straight edge and semicircular pattern. FIG. 14C2 shows the C1 like pattern (1407) created in a shaving blade. FIG. 14D shows schematics of a cutting action on a facial hair (1401) using straight cutting edge (1402). FIG. 14E shows cutting hair (1401) cut by two cutting edges (1403). FIG. 14F shows the hair (1401) being cut by hexagonal micro-cutting elements (1404) as the hair passes between two microblade array blade edges (1405) during shaving. FIG. 14G shows a cutting edge pattern with a pointed edge (1406) that is least preferred. FIG. 14A shows an exemplary cutting blade with a semicircular cutting edge. The circumference of the half-circle blade provides more cutting length to the blade than its straight blade counterpart. In one illustrative embodiment, a razor blade with a combination of the straight and semicircular cutting edge is made (FIG. 14 C2). The cutting edge length of this blade is compared with the cutting edge length of the blade made without any modification (FIG. 17C, 1707). The cutting length of the straight blade is 35 mm. The calculated cutting length of the blade with a 1 mm diameter half circle and 1 mm distance between half-circle is 45.27 mm. This is a significant increase (29.34 percent increase relative to 35 mm length) due to use of non-straight cutting edges. This increased length is the result of the use of non-straight cutting edge patterns. The cutting edge shape that gives 2 percent more cutting length, preferably 5 percent more cutting length and even most preferably 10 percent or higher more cutting length relative to straight length cutting blade are preferred. Some illustrative patterns are given in FIG. 14. The diameter of a curved surface such as the half-circle used in the cutting edge may range from 10 microns to 4 mm, preferably 50 microns to 3 mm and most preferably 100 microns to 2 mm. FIG. 14B shows the combination of triangular and straight cutting edge and FIG. 14C shows a combination of straight and half circle shape. The non-straight cutting edge features (circular, triangular, half-hexagonal and the like) in the blade may vary from 2 to 1000 preferably 3 to 500 and most preferably 5 to 300. The distance between non-straight cutting edge features is 0.1 mm to 10 mm, preferably 0.5 mm to 5 mm, most preferably the distance is around 1 mm to 3 mm which is similar to the distance between each hair on human skin/face. One advantage of using an inventive cutting edge design and the microblade cutting array is that two or more cutting surfaces may be used simultaneously to cut the hair at the same time. This is schematically shown in FIGS. 14D, E and F. FIG. 14D shows a hair (1401) being cut by a single cutting edge (1402). FIG. 14E shows the hair (1401) that is cut by a blade with a pattern shown in FIG. 14B. Cutting edges of the triangular pattern (1403) cut the hair from both sides of the hair simultaneously. FIG. 14F shows the hair (1401) being cut by two hexagonal micro-cutting blades/elements (1405) as the hair passes between two micro-cutting elements. Cutting edge patterns shown in FIG. 14 are for illustration purposes only and other cutting edge patterns may be used without any limitation. Cutting edges with pointed tip (1404) such as shown in FIG. 14G are least preferred because pointed tips may have more propensity to penetrate/poking face/body skin surface and causing an injury. Cutting edges with smoothed curves without pointed edges (FIG. 14C as an example) that cause no skin injury/harm are most preferred. Many methods known in mechanical engineering art may be used to create edge shape patterns. In one illustrative embodiment, cutting edges are made by using a laser cutting tool that uses ultraviolet, visible light or infrared laser, preferably UV and infrared laser. Variable Laser power, laser beam diameter, laser pulse (nanosecond to femtosecond laser) may be used to achieve a desirable cutting edge pattern. The laser-cut parts may be further treated with metal etching solutions or other chemical or physical treatments to remove imperfections and to obtain a smooth cutting edge surface. The edges may also be polished, coated with anticorrosive coatings and the like which help to improve the shaving experience. Alternatively, patterns of desired dimensions may be embossed or stamped using a die and then polished to make a sharp edge. Many other methods are known in the art or yet to be discovered may be used to achieve a desirable curved cutting surface. The blades as described above may also be heat treated to improve mechanical properties of the blade or blade material or to relieve thermal stresses created during manufacturing processes. In some embodiments, the desired pattern is first created as described above in the standard blade manufacturing process prior to beveling process. The pattern is then beveled and polished to create the desired cutting blade.

Further, the present disclosure describes the use of microfluidic channels on the surface or in the bulk of a cartridge/razor or its components to deliver washing fluids to dislodge shaving debris or to deliver lubricants and other shaving aids for a smooth shaving experience. FIG. 16 shows partial schematic representation of a razor cutting blade with microfluidic channels for fluid/lubricant distribution during or after shaving. FIG. 16A shows drawing of the shaving blade surface with microchannels carved into the blade surface or body. The 1601 shows the blade surface/body and 1602 shows the cutting edge of the blade. 1603 shows microfluidic channels carved into the 1601 surface/body. 1604 shows inlet of the fluid channel and 1605 shows one or more preferably several multiple outlets which deliver the fluid just above the cutting surface. The direction of fluid flow from the inlet to outlet is shown in 1607. The black arrows (1607) show some of the fluid paths starting from inlet to outlet. FIG. 16B is the same as FIG. 16A except the surface with the microfluidic channels is coated with the coating (1606) to embed the channels between the metal and the coating. The surface or substrate described in FIG. 16A could also be a lubricant strip (203) or spacer between the blades (211 and 212) or frame of the cartridge or some part of the razor. The microfluidic channel width may range from 5 microns to 5 mm, preferably 10 microns to 4 mm and most preferably 20 microns to 2 mm. The channel's depth may range from 10 microns to 2 mm, preferably 20 microns to 1 mm. The thickness of the blade will generally limit the channel depth which may range from 70 percent to 10 percent of the blade thickness or lubricant strip thickness. The channels may be carved using mechanical tools such as CNC machines, laser based carving tools or maybe etched using photolithography methods and the like. Microfluidic device fabrication methods known in the art of chemical engineering may also be used. Channels may be made using laser carving or mechanical carving tools as described before. The channel surface may be modified with coatings or other surface treatments so that the surface is compatible with the fluid that is being transported. The channel surface may be hydrophobic or hydrophilic or a combination thereof in any proportion. The flow of the liquid may start at one point (FIG. 16A2, 1604) and end in multiple points (1605, one to many relationships). In the preferred mode, one to 2 or more, most preferably 1 to 4 or more relationships is preferred. The flow direction of fluid is shown as a white arrow in FIG. 16A1. The inlet of the microfluidic channel (1604) may be fluidically connected to a fluid storage place in the razor or cartridge body via flexible or rigid tubing. Inlet port (1604) may be fluidically connected to the fluid reservoir such as shown in FIG. 4 (403) or in FIG. 5 (504) or FIG. 10 (1003) or FIG. 25 (2506). Micropump or other methods may be used to assist and control the flow of liquid. The fluid may be delivered at one microliter per second to a few milliliters per minute or may deliver 0.02 ml to 2 ml based on user input. The lubricant strip (FIG. 2B, 203) used in many configurations or spacer between the blades (211 and 212) may be modified to create fluidic microchannels as described above and the channels are then fluidically connected to the lubricant reservoir. The lubricant strip or spacer may deliver lubricant during shaving via lubricant reservoir.

Further, in some embodiments, the present disclosure discloses newer designs and methods to make 2 or more blade cartridges. In the preferred method, the blade portion of the multi-blade shaving cartridge is made using a single block of metal. Preferably the metal is martensitic stainless steel (Sandvik 13C26) or Titanium 64 (Ti-6Al-4V) or other metal, ceramic or polymeric materials suitable for shaving blade manufacturing. FIG. 19 shows a partial schematic representation of a wet shaving razor made from a single metal block. The block is converted into a one or several blades using mechanical carving, laser carving, electrochemical deposition, casting/3D printing methods or a combination thereof in any proportion. FIG. 19A shows sketch of a razor blade with a 1904 body and its top surface. FIG. 19A shows a front view of the single unibody metal blade with three cutting blades (1901, 1902 and 1903) attached to a single metal body (1904). Holes (1905) are used for cartridge assembly. One side of the 1904 body has window/s or inlets that are fluidically connected with the gaps between blades (1906) which is used to flow water and clean the trapped debris generated during wet shaving operation. FIG. 19B shows the side view of A1 wherein blades (1901, 1902 and 1903) are separated by a gap (1906) which is fluidically connected with the back window (1906-1) of the 1904 body. FIG. 19C shows the backside of A wherein window/s or inlets (1906-1) are visible. FIG. 19D shows the shaving razor made using the cartridge (1907) and handle (1908). FIG. 19E shows the exploded view of the razor with identification and labeling parts of the razor. The handle has a base plate (1909) on which the three-blade assembly (FIG. 19A) is kept. The assembly and base plate are connected with the top plate (1910) and lubricant strip (1911). Upon arranging all parts, the top plate (1910) and its screws (1912) are inserted through the assembly via holes on the FIG. 19A (1905) and 1909 body. The screws (1912) and nuts (1913) are joined together to form a razor. In the illustrative example, 3 blade cartridge part (FIG. 19A) is shown but the cartridge could have 1 to 50 blades, preferably 3 to 20 blades, most preferably 1 to 7 blades. The distance/gap between each blade (1906) may vary from 20 microns to 3 mm, most preferably 110 microns to 2 mm. The preferred distance is 10 percent more than the average human hair diameter (100 micrometers). The length of the blade may range from 30 to 40 mm, preferably around 35 mm. The multi-blade unit as described above may also be made using a single metal piece of the desired dimension and then each blade or multiple blades may be etched out using the photolithographic process as described in this invention or other photolithographic methods known in the art. Metal powders of desired material may also be sintered to make part FIG. 19A as described above. Many methods are known to print 3D metal parts and such methods are commercially available. Such methods may be employed to 3D print the part as described above. Alternatively, laser-based or CNC machine-based tools or a combination thereof may be deployed to make the part as described above from a single piece of metal. Other methods of fabrication known in the art or yet to be discovered may also be used. Once the part is made, it may be used to assemble a razor for wet and dry shaving. FIG. 19 shows one of several illustrative ways of making the razor blade. Modifications to this method or other razor-making methods known in the art may be used to make razors for wet or dry shaving.

In this invention, a new method to make two blade cartridges is described wherein a commercially available shaving blade is used to make two blade shaving razor. FIG. 17 shows a partial schematic representation of a wet shaving razor wherein the razor and blades are assembled by the user before use. FIG. 17A shows sketch of the razor. FIG. 17A has a razor handle (1701) and shaving cartridge (1702) with 2 cutting blades (1703) on each side. FIG. 17B shows an exploded view of FIG. 17A showing different parts of the razor. 1701 is a razor handle with a hole on one end (1704) that is used to secure the blade assembly via a screw 1705. 1706 is a base plate on which a standard shaving blade (broken into two equal parts, 1703B) is placed. 1707 is a spacer plate between two blades that helps to maintain a desired gap and angle between the blades. 1703A is the second blade that is added on top of the spacer plate without breaking. Finally, the top plate 1702 with screw 1705 is applied on the 1703A blade. The screw passes through all the layers in the assembly and is lastly inserted in the 1704 hole and tightened. The reverse of this operation is used to dismantle the razor and blades. Optionally the top plate 1702 could be hollow with a compartment to store fluids. The stored fluid may be fluidically connected and delivered on the blade surface. Lubricants could be stored in 1702 and delivered using gravity on the blade edge surface.

Many wet shaving razor designs disclosed in this invention may be combined and sold as a wet shaving razor kit. In one embodiment, a multi-cartridge razor disclosed in this invention is packaged as a kit along with one or more spare cartridges. FIG. 28 shows a wet shaving kit wherein a multi-cartridge razor and two or more cartridges that are pre-assembled and packaged together as a kit. FIG. 28A shows a kit comprising a wet shaving razor (2801) with two removable cartridges (2802) packaged with two spare cartridges (2802). FIG. 28B shows a kit comprising a wet shaving razor (2804) with two additional removable head portion of the cartridges (2803). The head portion of the razor (2803) is removed from 2804 and replaced with the spare 2803 head portion provided in the kit. The head portion of the razor has preferably two or more cartridges. The above two examples of the kits are for illustration only and are not limited to these two kits as described above. Those skilled in the art know that other combinations of razor and its parts described in this invention may be assembled and packaged as a kit or kits.

This invention also discloses cosmetic compositions comprising hydrogel microspheres or microparticles. Preferably the microspheres are porous in nature with artificially created porosity. The average size of the microparticles may range from 0.1 microns to 2 mm, preferably 0.5 microns to 1.5 mm even more preferably 1 micron to 1 mm. The shape of the particle may be symmetrical or non-symmetrical. The preferred shape of the particle is spherical, semispherical, cylindrical or a combination thereof in any proportion. The hydrogel microspheres or microparticles preferably have uniform particle size. The mixture comprising microspheres of various sizes may also be used. Microparticles may be biostable or biodegradable. The preferred microspheres are porous in nature. The porosity may range from 5 percent of total available volume to 80 percent of total available volume, preferably 10 to 70 percent available volume. The pores in the porous microspheres may be interconnected or isolated from each other or combination in any proportion. Several methods are known in the art to make hydrogel microspheres. Some illustrative examples are given in Example 1. FIG. 20 shows a partial schematic representation of a process to make porous hydrogel microspheres. A crosslinkable composition comprising precursor/s such as macromonomer with photoinitiator and porogen is subjected to droplet formation and crosslinking process (microencapsulation process) wherein hydrogel microspheres (2001) with entrapped porogen (2002) are formed. The porogen is removed by dissolution, evaporation, sublimation and other processes to create an empty space or void created by the removal of porogen (porosity) in the microsphere body/surface (2003). The porosity thus created is then partially or completely filled with the desired amount of cosmetic ingredients (2004) such as oil, liquid/fluid fragrance, coloring composition and the like. Other methods known in the art to make porous microspheres, without limitation, may also be used. Solvent such as organic solvent or water may be used as porogens. Water, organic solvent are removal by air drying, vacuum drying, sublimation, lyophilization and the like. Other methods known in the porosity creation art or tissue engineering art such as salt leaching, polymer leaching and the like may also be used. Many methods are known in the art to make hydrogel microspheres. Exemplary microspheres are obtained by crosslinking of natural polymers or synthetic polymers. The preferred natural polymer is hyaluronic acid, cellulose derivatives such hydroxypropylcellulose or hydroxyethylcellulose, gelatin or collagen derivative, alginate, and the like. The synthetic polymers that are used to make crosslinked microspheres include but not limited to: polyethylene glycol or polyethylene oxide, polyvinyl alcohol, block or random copolymers of polyethylene oxide or polypropylene oxide and the like. The polymers used in making hydrogel microspheres may be linear, branched or dendramer. Crosslinked polymer microspheres obtained by polymerization and crosslinking of PEG based macromonomers or PEG based precursors are preferred. In some embodiments, crosslinked microspheres comprising hydrophobic and hydrophilic polymeric blocks are used. Such microspheres have the ability to encapsulate hydrophobic cosmetic components such as various oils, vitamins (vitamin E) and the like. In one illustrative example, a macromonomer is made from Pluronic surfactant (F127UA macromonomer, Pluronic F127 urethane diacrylate) is used. Pluronic polymers with terminal hydroxyl groups are covalently bonded with terminal polymerizable groups, preferably end groups such as acrylate or methacrylate groups. The macromonomer is then photopolymerized and crosslinked to make crosslinked composition in the form of microspheres. The crosslinked Pluronic polymers have hydrophobic blocks (polypropylene oxide) and hydrophilic blocks (polyethylene oxide) at ambient or body temperature. The crosslinked polymer made from block copolymers like Pluronic has the ability to encapsulate hydrophobic and hydrophilic components such as oils as well as water soluble components. The space in the porous structure of the microspheres may be filled/infused with a desirable amount of cosmetic compositions. The cosmetic composition used may be solid, semisolid, liquid, viscous liquid or gels. The preferred cosmetic composition includes but is not limited to the list of compounds: oils, lubricants, therapeutic cosmetic ingredients, perfumes, colorants and the like. In the preferred embodiment, a solvent based diffusion method is used to infuse desired cosmetic ingredients in the hydrogel microsphere at a desired concentration. The cosmetic ingredient such as oil (vitamin E) is dissolved in the organic solvent to make a homogeneous solution. The crosslinked microspheres are then incubated (without dissolution of the crosslinked microspheres) in the organic solution for the desired amount of time until a sufficient amount of cosmetic ingredient is infused in the microspheres surface and/or body. The microspheres are isolated and the solvent is removed trapping/encapsulating the cosmetic ingredient in the hydrogel microsphere. The cosmetic ingredients may be present in the crosslinked body of the microsphere or it may be present in the pores of the microspheres or combination of both in any proportion. PEG has the ability to dissolve in many organic solvents and also soluble in water based solutions and this property is especially useful for encapsulating many cosmetic ingredients. Crosslinked microspheres comprising 1 to 99 percent PEG (weight/weight), preferably 2 to 97 percent PEG and most preferably 5 to 95 percent PEG are most preferred. In some embodiments, a cosmetic composition is encapsulated during the microsphere manufacturing step. Briefly, PEG based macromonomer, cosmetic ingredient and photoinitiator are mixed in water. The solution is converted into droplets of the desired size and then the droplets are polymerized/crosslinked to make crosslinked microspheres. Upon polymerization and crosslinking, the cosmetic ingredient remains entrapped inside the crosslinked microspheres. In one illustrative example, hyaluronic acid is used as an illustrative cosmetic ingredient. PEG35KUA macromonomer and sodium hyaluronic acid salt are dissolved in 1 ml PBS and 10.0 μl ISS initiator stock solution is added. The mixture is then converted into droplets and photopolymerized to produce hydrogel microspheres with entrapped hyaluronic acid in the crosslinked polymer network. Using a similar procedure, the microsphere's hyaluronic acid is replaced with hydroxyethyl cellulose (HEC) to produce HEC encapsulated microspheres.

One illustrative embodiment uses aloe vera based composition comprising crosslinked hyaluronic acid hydrogel microspheres as one of the main ingredients. Dry crosslinked hyaluronic acid microspheres and water are added in aloe vera gel until the desired viscosity is achieved. The pH of the composition is adjusted to 5.5 to 7 and the cosmetic is used as a shaving gel composition. Other cosmetic ingredients such as color, perfume and the like may be added to this combination if desired.

Also disclosed are organic solvent based or organogel cosmetic compositions, especially shaving solution/gel composition that does not use water or aqueous medium or use substantially less amount of water relative to amount of organic solvent used (less than 10 percent of total weight of organic solvent used). In one exemplary embodiment (Example 7C), polyethylene glycol 600 is used as an illustrative organic solvent, Tween 80 is used as an illustrative lubricant, polyethylene glycol with molecular weight 20000 g/mole as a thickening agent and optionally glycerine as an organic solvent and/or humectant. FIG. 29 shows an illustrative image of organogel based water soluble shaving cream (2901) in a Petry dish as described in this invention.

In addition, other chemical ingredients used in typical cosmetic composition like fragrance and coloring agent and the like may also be added if desired. After mixing the desired components in a desired proportion, the mixture is warmed to 60 degree C. and stirred until all ingredients are dissolved/dispersed uniformly to provide a desired viscosity or consistency. The viscosity of the final mixture may also be adjusted using additional PEG 20000 and PEG 600/glycerine solvent amount until desired cosmetic cream-like consistency. The organic solvent base of this inventive composition is PEG 600, a polymeric ether based liquid organic polymeric solvent. The entire composition is made from water soluble ingredients and therefore can be easily washed with water after its intended use. PEG 600 is used herein as an example only. Other organic solvents that may be used but not limited to: polyethylene glycol 400, polyethylene glycol dimethyl ether, propylene glycol, ethanol, glycerol, n-methyl pyrrolidinone, dimethyl sulfoxide and the like and mixtures in any proportion. In some embodiments water also may be used as a minor ingredient. Solvents that have boiling point above 60 degree C., preferably above 100 degree C., most preferably above 110 degree C. are preferred. Water soluble solvents that have water solubility greater than 1 g/100 water are preferred. In this invention, polyethylene glycol 20000 g/mole is used as a viscosity modified agent. Polyethylene glycol 20000 or polyethylene oxide (PEO) of molecular weight 2000 to 5 million g/mole may also be used. The preferred molecular weight range is 10000 to 500000 g/mole. The PEO is soluble in water as well as in many organic solvents and therefore is the preferred viscosity modifier. Other cosmetic ingredients such as various oils, perfumes, colorants, lubricants, therapeutic agents and the like may also be added/used.

### Materials and Methods

Eosin Y, ethyl eosin, acrylic acid n-hydroxysuccinimide ester, polyethylene glycol, polyethylene oxide and polypropylene oxide block copolymers, 2-Hydroxy-1-[4-(2-hydroxyethoxy)phenyl]-2-methyl-1-propanone (Irgacure 2959), n-hydroxysuccinimide, were purchased from Sigma-Aldrich. Multifunctional hydroxyl and amine-terminated polyethylene glycols were purchased from Dow Chemicals, or BASF, or Huntsman, or Texaco, Creative PEG Works. Disuccinimidyl glutarate (DSG), sulfosuccinimidyl suberate (DSS) and N-hydroxysulfosuccinimide were purchased from Coached, LLC, Pierce or Sigma-Aldrich. PEG based monofunctional, difunctional, trifunctional, tetrafunctional and octafunctional NHS esters and other derivatives were sourced from commercial sources such as Creative PEG Works, Winston Salem, NC, USA; Jenkem Technology USA, Allen, TX, USA.; BOC Sciences, Shirley, NY USA; Laysan Bio, Inc. Arab, AL; NOF America, Corporation, White Plains NY USA and Sigma Aldrich, USA. They may also be synthesized by procedures described in illustrative embodiments reported in this invention or using methods known in the art. All other reagents, solvents may be purchased from commercial sources such as, by way of example, and not limitation, Polysciences, Fluka, ICN, Sigma-Aldrich. SYLGARD™ 184 Silicone Elastomer Kit was purchased from a local supplier to cast silicone rubber molds. Small laboratory equipments and medical supplies may be purchased from Fisher or Cole-Parmer.

Long UV light lamps (model UV-300, Wenzhou Aurora Technology Company Ltd., Wenzhou, China, 365 nm light with intensity around 26,500 μW/cm² when held 1 inch above the surface) or Black-Ray UV lamp, (360 nm light filter, about 10000 mW/cm2 intensity when held about 1 inch above the surface) may be used.

The size, shape and distribution of microparticles or microspheres may be assessed by laboratory microscope with varying magnification power or with a scanning electron microscope. The distribution of various sizes in a mixture is assessed by a particle size analyzer.

Molecular weight is determined by gel permeation chromatography (GPC); or NMR (proton) or mass spectrophotometry.

Biocompatibility may be assessed by several USP tests recommended by the US FDA.

Chemical analysis such as, by way of example, and not limitation, structure determination is done using nuclear magnetic resonance (proton and carbon-13), Raman spectroscopy, x-ray diffraction and infrared spectroscopy.

Thermal characterization such as, by way of example, and not limitation, melting point, shrink temperature and glass transition temperature are done by differential scanning calorimetric analysis. The aqueous solution properties such as, by way of example, and not limitation, self assembly, micelle formation and gel formation are determined by fluorescence spectroscopy, UV-visible spectroscopy and laser light scattering instruments.

Cosmetic ingredient release studies are conducted in PBS under sink conditions at 37 degrees C. and the ingredient elution is monitored by HPLC or UV-VIS spectrophotometer.

### Example 1

### Preparation of Hydrogel Microparticles.

### Preparation of Biodegradable Hydrogel Microparticles.

### Example 1A

### Preparation of Uncrosslinked Gelatin Microspheres Using Oil-In Water Method

In a 15 ml glass vial, 100 mg of Gelatin (type B, 300 Bloom strength) is dissolved in 0.9 ml hot water (60 degree C.). A 500 ml beaker is transferred on a hot plate, which is fitted with a mechanical stirrer. 200 ml cottonseed oil and 2 g Span 80 surfactant are added to the beaker and the temperature of the oil is increased to 60 degree C. while stirring. The hot gelatin solution is added dropwise to the hot oil solution while being vigorously stirred. The solution is cooled in an ice bath or in the freezer while stirring. The solution is poured in 500 ml ice cold ether where oil is dissolved and gelatin microspheres are collected by decantation/filtration. The gelatin microspheres are washed with cold water, 100 ml acetone two times and vacuum dried. The dried microspheres are kept at −20 degree C. under nitrogen. Gelatin hydrogel microspheres thus prepared are not chemically crosslinked but physically crosslinked. The microspheres may remain in gel form up to 37 degree C.

### Example 1B

### Preparation of Chemically Crosslinked Gelatin Microspheres Using Oil-In Water Method

About 0.1 g portion of microspheres prepared as above incubated in cold 0.2 percent glutaraldehyde solution in PBS (pH 7.4) and filtered. The filtered microspheres are crosslinked with glutaraldehyde and cannot be dissolved in hot water upon warming to 60 degree C. The microspheres are lyophilized around 4 degree C. Water removal from the crosslinked gelatin microspheres via lyophilization produces porous microspheres wherein porosity is created by removal of water by lyophilization.

### Example 1C

### Preparation of Porous Microspheres Using Oil-In Water Method

In another modification of the above procedure, 100 mg of Gelatin is dissolved in 0.9 ml hot water and 30 mg of calcium carbonate powder (average size 50 nm) or magnesium carbonate (average size 10 nm) is added as a porogen and microspheres are prepared as above and crosslinked. After preparing microspheres, the microspheres are crosslinked using glutaraldehyde by incubating in 0.2 percent solution for 24 h at zero degree C. or at room temperature (25 degree C.). The calcium carbonate entrapped in the microspheres is removed by dilute hydrochloric acid treatment for one hour and washed with distilled water. The removal of calcium carbonate produces porosity in the microspheres. The amount and size of porosity are varied by changing particle size and its weight percentage of the porogen. In another embodiment, carbonate salt is replaced with 10 mg of poly(ethyl methacrylate) spherical beads (from Polysciences, Particle size 140-220 microns) and the prepared microspheres are incubated with methanol to remove poly(ethyl methacrylate) microsphere and to prepare porosity. Since beads are spherical, a spherically shaped cavity is created in the microspheres.

### Example 1 D

Macromonomer with polymerizable groups attached to side groups of linear polymers.

Crosslinked networks that degrade via enzymatic degradation mechanisms.

### Example 1 D-A

Gelatin Modification with Methacrylate Polymerizable Group.

5.04 g gelatin is dissolved in 25.0 ml of carbonate/bicarbonate buffer, pH 9.0. To this solution, 0.5 ml methacrylic anhydride (0.1 ml per gram gelatin) is added dropwise with constant stirring. The reaction mixture is kept at 40 degree C. The reaction product is checked after one hour for its gelation. 500 μl of product is taken out in a vial and 2 μl of photo-initiator solution (300 mg Irgacure 2959 is dissolved in 700 mg of n-vinyl pyrrolidone, ISS solution) is added to it. About 100 μl solution is filled into a silicone mold cavity (diameter 3 mm and depth 1 mm) and exposed to UV light. It is noticed that the gel forms within 30 seconds of UV light exposure. The reaction is cooled to room temperature. The product is precipitated by the addition of acetone to the reaction mixture and is washed and separated using acetone and dried under vacuum. In some cases, the gelatin methacrylate product is purified by dialysis with 10000 molecular weight cutoff membranes. The dialyzed solution is lyophilized to recover the product.

### Example 1 D-B

### Crosslinking of Gelatin Methacrylate

1 g of gelatin macromonomer as above is dissolved in 9 ml PBS. Separately 300 mg Irgacure 2959 is dissolved in 700 mg of n-vinyl pyrrolidone to produce an initiator stock solution (ISS). 3 μl of above solution (ISS) is added to 1 ml of gelatin solution and the solution is filled in silicone rubber mold with cylindrical cavities (50 microns diameter, 50 microns height) and exposed to 360 nm Long UV light (Black-Ray UV lamp, 360 nm light, 10000 mW/cm2 intensity) for 5 minutes. The crosslinked gelatin microcylinders are removed from the mold and stored until use.

### Example 2

### Glucosamine Crosslinked Gels

### Example 2A

### Preparation of Crosslinked Hyaluronic Acid Microspheres

In a 15 ml glass vial, 0.2 g sodium hyaluronate powder and 8 ml distilled water are mixed to form a solution. Ethylene glycol diglycidyl ether (100 mg) and 10 microliter triethylamine dissolved in 2 ml acetone water mixture (80:20) is added to HA solution and mixed. The solution is loaded in an atomizer or syringe and the droplets are collected in 200 ml sesame seed oil and 2 g Span 80 mixture maintained at 35 degree C. The mixture is vigorously stirred for 12 h and the oil is separated using large excess ether. The crosslinked hyaluronic acid droplets are collected and washed with acetone and distilled water. In another variation of this method, Ethylene glycol diglycidyl ether is replaced by polyethylene glycol diglycidyl ether (molecular weight 2000, 150 mg) and the solvent is replaced with distilled water.

### Example 2B-1

Hyaluronic acid modification with methacrylate polymerizable group.

1 g of sodium hyaluronate is dissolved in PBS pH 7.4. 10 ml of this solution is added with 0.5 ml glycidyl methacrylate, 0.5 ml triethylamine and 0.1 g tetrabutylamine hydrobromide. The reaction is carried for 48 hours at room temperature with gentle stirring. The methacrylate modified derivative is precipitated in 100 times excess cold methanol. The precipitated polymer is dried, filtered and then under vacuum for 24 hours.

### Example 2B-1

### Crosslinking of Hyaluronic Acid Methacrylate

One ml 2 percent of the modified hyaluronic acid methacrylate ester solution is mixed with 6 μl of Irgacure solution in N-vinyl pyrrolidone (ISS) and photopolymerized in silicone rubber cylindrical cavities using 360 nm light for 10 minutes. The resultant gel microcylinders are removed, washed with PBS, lyophilized and stored until use. Alternatively, a droplet-making apparatus is used to make 100-500 microns size droplets and the droplets are exposed to UV light to polymerize and crosslink.

Using a similar procedure as above, 1 gram of hydroxypropyl methylcellulose (Hypromellose, 220890SH-100SR) is modified to obtain methacrylate ester derivative and crosslinked.

For additional examples of macromonomers, biodegradable crosslinked compositions and free radical polymerization initiating systems please refer to U.S. Pat. Nos. 5,410,016, 5,573,934, 6,201,065, 6,566,406, 9,023,379, 6,387,977, 9,789,073, and cited art therein; cited herein for reference only.

### Example 3

### Preparation of Ionically Crosslinked Microspheres.

### Preparation of Alginate Microspheres.

In a 250 beaker with a magnetic stirrer, 2 g sodium alginate (Sigma-Aldrich suitable for immobilization of microorganisms) and 100 ml calcium ion free HEPES buffer (pH 7.2) is added. The solution is heated to 45 degree C. and stirred until complete dissolution. The alginate solution is transferred in a 10 ml syringe with 31 G needle. The solution is pushed out manually and liquid droplets are collected in 300 ml calcium chloride (100 mM) and sodium chloride (145 mM). The droplets are converted into calcium alginate gel particles. The alginate particles are separated and lyophilized and stored in the refrigerator until use. If needed the alginate microspheres may be further incubated in polyallylamine solution to make them resistant against dissolution when calcium is depleted.

### Example 4

PEG based hydrogel microspheres.

### Synthesis of Free Radical Polymerizable Macromonomer

### Synthesis of Macromonomer Comprising PEG

### Example 4A-1

Synthesis of PEG urethane acrylate as a free radically polymerizable precursor or macromonomer.

In a 250 ml flask, 5.0 g of polyethylene glycol 35000 (PEG 35000 Daltons molecular weight) is dissolved in 140 ml of toluene from which 20-30 ml of toluene is distilled out. The solution is cooled and is equipped with a stirrer and nitrogen inlet. While stirring 80 μl of hexamethylene diisocyanate was added followed by one drop of dibutyltin dilaurate in the reaction flask and the solution was refluxed for 2 hours under a nitrogen atmosphere. The reaction mixture was cooled to room temperature and 58 μl of 2-hydroxyethyl acrylate was added. The reaction mixture is refluxed for 2 hours, cooled at room temperature. The solution is then poured in 150 ml of cold hexane for precipitation of the product. The product, PEG35000-urethane diacrylate (PEG35KUA) is filtered and is washed with 50 ml of cold hexane and dried under vacuum and stored in a dark-colored bottle in the refrigerator until use.

Using a similar procedure as above, PEG 2000 Daltons, PEG 3000 Daltons, PEG 6000 Daltons, PEG 10000 Daltons, PEG 20000 Daltons, PEG 100000 Daltons, Pluronic F127, Tetronic 908 and Reverse Pluronic 25R2 were used to make PEG 2000 urethane diacrylate (PEG2KUA), PEG 3000 urethane diacrylate (PEG3KUA), PEG 6000 urethane diacrylate (PEG6KUA), PEG 10000 urethane diacrylate (PEG10KUA), PEG 20000 urethane acrylate (PEG20KUA), PEG 100000 urethane diacrylate (PEG100KUA), Pluronic F127 urethane diacrylate (F127UA), Tetronic 908 urethane tetraacrylate (T908UA), Pluronic 25R2 urethane diacrylate (25R2UA) macromonomers respectively. In all cases, similar molar concentrations as described in the above example were used to make acrylate/methacrylate derivatives.

### Example 4A-2

### Effective Photopolymerization of PEG35KUA in Aqueous Solution.

Polymerization and effective crosslinking in aqueous solution, PBS (pH 7.4).

100 mg of PEG35KUA macromonomer is dissolved in 1 ml PBS and 10.0 μl ISS is added. After mixing, 50 microliters of the above solution is poured into a circular mold cavity and exposed to long UV light (Black-Ray UV lamp, 360 nm light, 10000 mW/cm2 intensity). A soft gel is formed under 3 minutes of exposure indicating effective polymerization and crosslinking. Using a similar procedure as above, 300 mg of PEG100KUA macromonomer is dissolved in 2.7 ml dimethyl sulfoxide (an illustrative organic solvent) and 30.0 μl ISS is added. After mixing, the solution is filled into a 2 mm diameter transparent glass tube, 2 cm solution length and then exposed to UV light for 10 minutes. The polymerized organogel is removed from the tube. The organogel is able to stretch 1.2 to 5 cm by hand without braking and plastic deformation indicating highly elastomeric nature of the organogel.

In a 25 ml glass flask, about 0.5 ml of PEG35KUA macromonomer and photoinitiator solution is added into 10 ml mineral oil and vigorously stirred to make a suspension. The suspension is exposed to long UV (high intensity 360 nm light for 30 minutes while stirring until effective polymerization of solution in the droplets form. The solution is diluted with hexane and the polymerized droplets/hydrogel microspheres are removed by filtration or decantation, washed with hexane and dried under vacuum or lyophilized.

100 mg of PEG35KUA, 10 mg sodium hyaluronic acid are dissolved in 1 ml PBS and 10.0 μl ISS is added. The mixture is converted in droplets and polymerized as above to produce hydrogel microspheres with entrapped hyaluronic acid in the crosslinked network. Using a similar procedure, hyaluronic acid is replaced with hydroxyethyl cellulose (HEC) to produce microspheres with trapped HEC inside PEG based crosslinked microspheres.

100 mg of F127UA macromonomer (Pluronic F127 urethane diacrylate) and 100 mg of coconut oil are dissolved in 0.8 ml THF and 10.0 μl ISS-1 is added. After mixing, 50 microliters of the above solution is poured into a circular silicone mold cavity and exposed to long UV light (Black-Ray UV lamp, 360 nm light, 10000 mW/cm2 intensity). A soft gel is formed under 3 minutes of exposure indicating effective polymerization and crosslinking. The solvent is removed producing crosslinked F127KU with entrapped coconut oil inside the crosslinked gel particles. Pluronic F127 being a surfactant with hydrophobic and hydrophilic blocks, retains a substantial amount of oil in the particle.

100 mg of PEG35KUA, 10 mg sodium hyaluronic acid are dissolved in 1 ml PBS. To this solution, 0.1 ml Aloe Vera extract, 20 microliters of rosewater extract and 10.0 μl ISS-1 photoinitiator solution is added. The mixture is converted into droplets and polymerized as above to produce hydrogel microspheres with entrapped hyaluronic acid and aloe vera extract and rose water fragrance in the gel. The microspheres are lyophilized and stored until use.

### Example 4B

Example of crosslinked polymer hydrogel microspheres made by condensation polymerization.

102.1 mg of glycerol ethoxylate (Molecular weight 1000), 0.2 ml of Toluene, 19 μl of glutaryl chloride and 42.0 μl of Triethylamine are mixed well and filled in cylindrical micro mold cavities (500 microns diameter, 500 microns height). After 30 minutes, sticky organic solvent gels are observed in the mold cavities. In another example, 37.5 mg of glycerol ethoxylate, 0.1 ml of Toluene, 9 μl of glutaryl chloride are mixed and this mixture is poured into the mold cavity and then 33 μl of triethylamine is added and mixed. The delayed addition of triethylamine helps to delay the gelation which helps to give sufficient work-up time to fill the cavities in the mold before crosslinking and gelation. The gel is removed from the mold and washed with water to remove triethylamine hydrochloride and other unreacted products.

### Example 5

Infusion of desirable ingredients in the hydrogel microspheres via solvent diffusion.

75 g THF, 10 g coconut oil, 0.5 g turmeric, 10 g vitamin E, 50 microliters of sandalwood extract are mixed in a beaker. 1 g of lyophilized crosslinked PEG35KUA macromonomer microspheres/microparticles are added in the solution. The microspheres are incubated for 30 minutes and then removed by filtration/decantation. The THF swollen microspheres are then air-dried followed by vacuum drying. The oils, vitamins and sandalwood fragrance remain entrapped in the microspheres. These microspheres are used in shaving lotion/cream/gel composition. The hydrogel microspheres used could be porous or non-porous. The crosslinked density/molecular permeability of the microspheres are chosen such that the ingredient used may be diffused inside the crosslinked matrix. Preferred molecular permeability of crosslinked hydrogel matrix is 500 g/mole to 100000 g/mole. The molecular permeability is controlled by choosing the molecular weight of PEG in the macromonomer and number of polymerizable groups per macromonomer. The pores of the hydrogel microspheres may be filled with desired type and amount of desirable ingredients.

Alternatively, the desirable ingredients are added before the polymerization and crosslinking stage as described before and then polymerized to entrap the ingredients.

### Example 6

### Aloe Vera Based Composition Comprising Hydrogel Microspheres

Preparation of shaving gel comprising natural hydrogel or aqueous and viscous polymer solution.

10 grams of natural aloe vera hydrogel is freshly extracted from the leaf of the plant. Dry hydrogel microspheres prepared as per Example 1 are added in the aloe vera gel and mixed and incubated for 24 hours. PBS solution (pH 5.5 to 7) and dry microspheres are added to adjust the final viscosity and consistency.

### Example 7

Non-aqueous shaving gel composition.

Shaving gel compositions without surfactant or pH adjustments.

Organic solvent based shaving gel composition.

Organogel based shaving gel composition.

### Example 7A

In a 500 ml beaker, 10 g Tween 80 (lubricant), 10 grams of Polyethylene 20000 (thickening polymer additive), 79 g of polyethylene glycol 400 (water soluble organic solvent) are added. The mixture is warmed to 60 degree C. and stirred until all ingredients are dissolved/dispersed uniformly. The mixture may be sonicated if desired. The viscosity of the final mixture is adjusted using PEG 20000 and PEG 400 amount until viscosity is around 14000-20000 mPa-s (Brookfield RVT @20 rpm, 25° C. #6 spindle)

### Example 7B

In a 500 ml beaker, 2 g Pluronic F108 (lubricant), 5 g Tween 80 (lubricant), 15 grams of Polyethylene 20000 (thickening polymer additive), 73.4 g of polyethylene glycol 400 (water soluble organic solvent) are added. The mixture is warmed to 60 degree C. and stirred until all ingredients are dissolved. To this solution 2 g almond oil (oil based lubricant), 0.5 g vitamin E (oil based lubricant and stabilizer), 2 g fine silica powder (inorganic filler), 0.05 g sandalwood extract (fragrance), turmeric (an antimicrobial and anti-inflammatory agent) are added. The mixture is thoroughly mixed and homogenized. The mixture may be sonicated if desired. The viscosity of the final mixture is adjusted using PEG 20000 and PEG 400 amounts until viscosity is around 14000-20000 mPa-s (Brookfield RVT @20 rpm, 25° C. #6 spindle).

### Example 7C

In 150 ml glass beaker, 45 ml polyethylene glycol molecular weight 600 g/mole (PEG-600, as water soluble organic solvent), 6.098 g of polyethylene glycol molecular weight 20000 g/mole (PEG 20K, as viscosity modifier) and magnetic stirrer were added. The mixture was stirred and heated to 60 degrees C. After dissolving PEG20K in the PEG 600, Tween 80 (0.42 ml, lubricant/surfactant), 5 ml glycerol (humectant/organic solvent) and four drops of sandalwood essence (fragrance) were added. After cooling to room temperature, a cream/gel like material with smooth and soft texture was obtained (FIG. 29). This mixture was applied on subjects' hand and hairs on the hand were shaved using one cartridge commercial shaving razor. The excess gel was washed away using water without leaving any residue on the skin and smooth shave was observed. In another modification of the above example, ethyl eosin (0.1 percent relative to total weight) was added as an illustrative colorant in the gel as prepared above.

### Example 8A

Natural polymer based shaving cream.

Hyaluronic acid based shaving gel.

10 grams of sodium hyaluronic acid solution (1 percent in PBS, pH 5.5 to 7) and 5 drops of blue food color solution is transferred in a 100 ml beaker. To this solution, 1 g of dry PEG based crosslinked hydrogel beads/microspheres are added and incubated for 24 h. If needed, PBS solution (pH 5.5-7.0) and dry microspheres are added to adjust the final viscosity and consistency in a desirable range. Other ingredients such as fragrance, colorant, fillers, stabilizer, bioactive compounds and the like may also be added at this stage if desired.

### Example 8B

Hyaluronic acid based aqueous shaving gel.

In a 500 ml beaker, 10 grams of sodium hyaluronate solution (1.5 percent in PBS, pH 5.5-7.0), aloe vera gel (50 g) are added and mixed. To this solution, almond oil 15 g, glycerin 5 g, vitamin E 5 g, rose extract 0.05 g and F and D blue color 0.050 g are added. The mixture is homogenized using a standard laboratory mixture or sonicated.

### Example 9

Design and Printing of Razor and its components.

Many of the razor designs disclosed herein were conceptualized on paper and then rendered using commercially available engineering software like SketchUp, Fusion 360, FreeCAD and the like. The designed parts are printed using commercially available 3D printing services like Shapeways, Protolabs, Xometry and the like or printed using in-house 3D Printer. The printed parts are then assembled to make the razor. In some cases, the razor handles were specifically designed to fit commercially available wet shaving cartridges with 1 to 7 blades per cartridge.

### Example 10

Reduction of water usage during wet shaving.

A 3-cartridge razor with 3 blades per cartridge such as shown in FIG. 28D was used in wet shaving. Its water usage was compared in the standard single cartridge 3 blade razor. The cartridge used in 3-cartridge razor and single cartridge razor was identical in design and sourcing.

A shaving cream was applied on the subject's face until sufficient foam was created in the shaving area. A control razor (single cartridge) was used in the shaving. During shaving, the razor was washed three times under the tap water to remove accumulated foam on the cartridge. Approximately 200 ml water was used in each washing (total approximately 600 ml water was used) for removing the foam. Next day, the same subject used a similar amount of shaving cream to create the foam on the face and performed the wet shave using 3 cartridge razor. The subject completed the shave using all three sides of the razor. The subject did not need to wash the razor intermittently. When sufficient foam was accumulated on one cartridge, the razor was rotated and the second cartridge on the side was used for shaving. When the second cartridge was full with foam, the third side of the razor (with the third cartridge) was used for shaving. Thus, all three sides were sufficient to remove all the foam and facial hair without intermittent washing. At the end of shave, all three cartridges with foam were washed with around 150-200 ml water. When water usage was compared between the two-shaving operations, it was found that the three-cartridge shaving razor used less water as compared to control single cartridge razor.

Although the present invention has been particularly shown and described with reference to exemplary embodiments thereof, it will be understood by those of ordinary skill in the art that various changes in form and details may be made therein without departing from the spirit and scope of the present invention as defined by the appended claims. Therefore, the present embodiments are to be considered as illustrative and not restrictive and the invention is not to be limited to the written description.

References such as journal articles, patent applications, patents and the like are cited herein strictly for reference only for all purposes. If there is a conflict then the relevant specification controls the information.

### REFERENCES

1. Vintiloiu et. al., “Organogels and their use in drug delivery—A review” Journal of Controlled Release Volume 125 Page 179, 2008
2. U.S. Pat. No. 5,410,016,
3. U.S. Pat. No. 5,573,934
4. U.S. Pat. No. 6,201,065
5. U.S. Pat. No. 6,566,406
6. U.S. Pat. No. 9,023,379
7. U.S. Pat. No. 6,387,977
8. U.S. Pat. No. 9,789,073

1. A wet shaving razor comprising:
a shaving cartridge having at least one razor blade; and
a handle coupled with the shaving cartridge that is adapted as a shaving handle, wherein the handle has a handle cavity that is configured to store a fluid in an amount of about 1 mL to about 100 mL, wherein the handle includes at least one fluid dispensing port that is fluidly connected to the handle cavity, wherein the handle is configured to dispense a fluid stored in the handle cavity by gravity or a squeeze of the handle without substantial deformation of the handle.

2. The wet shaving razor of claim 1, wherein the shaving cartridge is removably attached to the handle, wherein the shaving cartridge can be detached from the handle.

3. The wet shaving razor of claim 1, wherein the shaving cartridge is fixedly mounted to the handle so as to be fixed and not removable.

4. The wet shaving razor of claim of claim 1, wherein the shaving cartridge has a lubricant strip.

5. The wet shaving razor of claim 1, wherein the handle includes at least one fill port adapted to fill the handle cavity with the fluid, wherein the at least one fill port is located at a shaving cartridge end or an opposite base end.

6. The wet shaving razor of claim 1, wherein the at least one dispensing port is located in the handle at a shaving cartridge end or an opposite base end.

7. The wet shaving razor of claim 1, comprising the fluid within the handle cavity, wherein the fluid is selected from a cream, gel, paste, liquid, or other fluid solution.

8. The wet shaving razor of claim 1, comprising the fluid within the handle cavity, wherein the fluid is selected from shaving cream, shaving gel, after shave solution, skin lotion, or hair oil.

9. The wet shaving razor of claim 5, wherein the at least one fluid dispensing port and/or the at least one fill port is covered by a removable cap.

10. The wet shaving razor of claim 1, wherein the shaving cartridge having the at least one razor blade is flexible so as to conform a shaving surface of the shaving cartridge to facial skin during shaving.

11. The wet shaving razor of claim 1, wherein the handle cavity has a volume from about 2 mL to about 50 mL.

12. The wet shaving razor of claim 1, wherein the handle includes a hollow handle body defining the handle cavity, wherein the hollow handle body is at least semi-transparent or transparent.

13. The wet shaving razor of claim 1, wherein the handle is configured for retaining at least one extra shaving cartridge, and for dispensing the at least one extra shaving cartridge.

14. A wet shaving razor comprising:
a shaving handle having a cartridge end and an opposite base end;
a first shaving cartridge having one or more first razor blades coupled with the shaving handle at one of the cartridge end or base end, wherein the first cartridge is configured for shaving with the shaving handle and first cartridge in a first shaving position; and
a second shaving cartridge having one or more second razor blades coupled with the shaving handle at one of the cartridge end or base end, wherein the second cartridge is configured for shaving with the shaving handle and second cartridge in a second shaving position, wherein the first shaving cartridge does not interfere with the second shaving position and the second shaving cartridge does not interfere with the first shaving position.

15. The wet shaving razor of claim 14, wherein the first cartridge and second cartridge are connected to each other by a connector body.

16. The wet shaving razor of claim 14, wherein the first cartridge and second cartridge are connected to different connections on the shaving handle.

17. The wet shaving razor of claim 14, wherein the one or more first razor blades have first razor blade edges that are parallel with second razor blade edges of the one or more second razor blades.

18. The wet shaving razor of claim 14, wherein the first cartridge is spaced apart from the second cartridge by about 2 mm to about 50 mm.

19. The wet shaving razor of claim 14, wherein the shaving handle is solid or hollow.

20. The wet shaving razor of claim 15, wherein the connector body is solid or hollow.

21. The wet shaving razor of claim 14, wherein the shaving handle is hollow and has at least one dispensing port.

22. The wet shaving razor of claim 21, wherein each dispensing port has a control valve.

23. The wet shaving razor of claim 14, wherein the shaving handle is textured for increased grip.

24. The wet shaving razor of claim 14, wherein the shaving handle has from 1 to 4 hollow chambers that are each configured to store a separate fluid.

25. The wet shaving razor of claim 14, wherein the first shaving cartridge has identifiable indicia that is distinguishable from the second shaving cartridge.

26. The wet shaving razor of claim 14, wherein the shaving handle is configured for retaining at least one extra shaving cartridge, and for dispensing the at least one extra shaving cartridge.

27. The wet shaving razor of claim 15, wherein the connector body is configured for retaining at least one extra shaving cartridge, and for dispensing the at least one extra shaving cartridge.

28. A wet shaving razor comprising:
a shaving handle having a cartridge end and an opposite base end;
a first shaving cartridge having one or more first razor blades coupled with the shaving handle at one of the cartridge end or base end;
a second shaving cartridge having one or more second razor blades coupled with the shaving handle at one of the cartridge end or base end; and
a third shaving cartridge having one or more third razor blades coupled with the shaving handle at one of the cartridge end or base end,
wherein the first shaving cartridge, second shaving cartridge, and third shaving cartridge are arranged:
to form a triangle shape; or
with the first shaving cartridge and second shaving cartridge on one side and the third shaving cartridge on an opposite side.
